(19) United States
(12) Patent Application Publication
(10) Pub. No.: US 2019/0188636 A1
(43) Pub. Date: Jun. 20, 2019

(54) INFORMATION PROCESSING DEVICE, INFORMATION PROCESSING METHOD, AND NON-TRANSITORY STORAGE MEDIUM STORING INFORMATION PROCESSING PROGRAM

(71) Applicant: TOYOTA JIDOSHA KABUSHIKI KAISHA, Toyota-shi (JP)

(72) Inventors: Masato ENDO, Nagakute-shi (JP); Yuichiro HARUNA, Oyama-shi (JP)

(73) Assignee: TOYOTA JIDOSHA KABUSHIKI KAISHA, Toyota-shi (JP)

(21) Appl. No.: 16/222,618

(22) Filed: Dec. 17, 2018

(30) Foreign Application Priority Data
Dec. 20, 2017 (JP) 2017-243619

(51) Int. Cl. G06Q 10/08; G06Q 10/02; G07C 9/00; G06Q 50/30

(52) U.S. Cl. CPC G06Q 10/0832; G06Q 50/30; G07C 9/00309; G06Q 10/02

(57) ABSTRACT

An information processing device includes: a target vehicle extracting unit configured to extract an available vehicle which is available as a delivery destination of luggage from a plurality of vehicles, the vehicles being rented as an accommodation place of an object, when a user of a delivery service in which an interior space including a trunk of the vehicles is able to be designated as the delivery destination of the luggage issues a delivery request of the luggage to a provider of the delivery service; and a target vehicle notifying unit configured to notify the user of the available vehicle.

### INCORPORATION BY REFERENCE

The disclosure of Japanese Patent Application No. 2017-243619 filed on Dec. 20, 2017 including the specification, drawings and abstract is incorporated herein by reference in its entirety.

### BACKGROUND

### 1. Technical Field

The disclosure relates to an information processing device, an information processing method, and a non-transitory storage medium storing an information processing program.

### 2. Description of Related Art

For example, a system for using an interior space of a vehicle such as a trunk as a delivery destination of luggage has been disclosed (see Japanese Unexamined Patent Application Publication No. 2006-206225 (JP 2006-206225 A)).

Specifically, authentication information (key information) for unlocking a vehicle is transmitted to a terminal of a delivery company (for example, a mobile terminal which is carried by a deliverer). Then, a predetermined transmission signal including key information is transmitted from the mobile terminal carried by the deliverer to the vehicle, and a door (for example, a trunk lid or a back door) for accessing a trunk of the vehicle is unlocked when authentication based on the key information included in the transmission signal has succeeded on the vehicle side. Accordingly, the deliverer can accommodate luggage in the trunk. Accordingly, the delivery company can provide clients with a delivery service in which an interior space of a vehicle such as a trunk can be designated as a delivery destination (hereinafter referred to as an “interior delivery service”).

### SUMMARY

However, there is a likelihood that a user who may not be able to use a vehicle which is owned by the user or a near relative will not be able to use the interior delivery service. For example, when a family member has gone out using a vehicle, there is a likelihood that a user of the vehicle will not be able to receive luggage with the interior space of the vehicle as a delivery destination in a time period in which the family member uses the vehicle, that is, in a time period in which the user cannot use the vehicle.

The disclosure provides an information processing device or the like that can allow a user, who may not be able to use a vehicle which is owned by the user or a near relative, to use a delivery service in which an interior space of a vehicle can be designated as a delivery destination of luggage.

A first aspect of the disclosure provides An information processing device. The information processing device includes: a target vehicle extracting unit configured to extract an available vehicle which is available as a delivery destination of luggage from a plurality of vehicles, the vehicles being rented as an accommodation place of an object, when a user of a delivery service in which an interior space including a trunk of the vehicles is able to be designated as the delivery destination of the luggage issues a delivery request of the luggage to a provider of the delivery service; and a target vehicle notifying unit configured to notify the user of the available vehicle.

According to this embodiment, when a user issues a delivery request of luggage, the information processing device can notify a user of a vehicle which is rented as an accommodation place of an object (hereinafter referred to as a “trunk-sharing vehicle” for the purpose of convenience) and which is usable as a delivery destination of luggage corresponding to the delivery request, for example, by push-transmission to a mobile terminal carried by the user. Accordingly, the user can rent a trunk-sharing vehicle which is available as a delivery destination of luggage and designate the interior space of the trunk-sharing vehicle as a delivery destination of luggage by performing a reservation procedure for renting a vehicle as an accommodation place of an object via a predetermined web site or the like. Accordingly, the information processing device can allow a user who may not be able to use a vehicle owned by the user, a near relative, or the like to use an interior delivery service.

In the first aspect, the target vehicle extracting unit may be configured to extract, from the vehicles, the available vehicle of which a parking place when the available vehicle is rented as the accommodation place of the object is within a predetermined range from a current position of the user or a designated position designated by the user, when the user issues the delivery request of the luggage to the provider.

According to this configuration, the information processing device can notify a user of only trunk-sharing vehicles of which a parking place at the time of rental as an accommodation place of an object is within a predetermined range from a position of a user or a designated position. Accordingly, a user can easily detect a trunk-sharing vehicle near a current location of the user or a designated position such as a home or a work place, that is, a trunk-sharing vehicle of which actual use is desired by the user. Since trunk-sharing vehicles disclosed to the user are limited to a predetermined range, it is possible to prevent information on provided trunk-sharing vehicles which are owned by individual persons from being unnecessarily open to users and to consider the privacy of owners of the trunk-sharing vehicles or the like. Accordingly, the information processing device can notify a user of trunk-sharing vehicles which are available as a delivery destination of luggage while considering convenience for users and the privacy of owners of the provided trunk-sharing vehicles or the like.

In the first aspect, the target vehicle extracting unit may be configured to extract the available vehicle from the vehicles when the user issues the delivery request of the luggage to the provider, the available vehicle being a vehicle for which a designated delivery date and time, the designated date and time being designated by the delivery request, is included in a period in which the available vehicle is able to be rented as the accommodation place of the object.

According to this configuration, the information processing device can notify a user of only trunk-sharing vehicles in which a designated delivery date and time designated by a user is included in a rentable period, that is, which is available at the designated delivery date and time thereof. Accordingly, a user can easily detect trunk-sharing vehicles which are available at the designated delivery date and time. Since the trunk-sharing vehicles which are disclosed to a user are limited to target vehicles which are available at the designated delivery date and time, it is possible to prevent information on provided trunk-sharing vehicles which are owned by individual persons from being unnecessarily open to users and to consider the privacy of owners of the trunk-sharing vehicles or the like. Accordingly, the information processing device can notify a user of trunk-sharing vehicles which are available as a delivery destination of luggage while considering convenience for users and the privacy of owners of the provided trunk-sharing vehicles or the like.

In the first aspect, the target vehicle notifying unit may be configured to display, when the delivery request of the luggage is transmitted through a terminal carried by the user, the available vehicle, on a display device of the terminal.

According to this configuration, the information processing device can notify a user of trunk-sharing vehicles which are available as a delivery destination of luggage by displaying the available trunk-sharing vehicles on a display device of a terminal used for a delivery request by the user (for example, a front display of a mobile terminal such as a smartphone), for example, using a predetermined application programming interface (API).

In the first aspect, the target vehicle notifying unit may be configured to display the available vehicle on a predetermined web page of a web site corresponding to the delivery service or a window corresponding to an application program installed in the terminal to cooperate with the web site, when the user issues the delivery request of the luggage from the terminal by using the web site or the application program.

According to this configuration, for example, when a user accesses a web site corresponding to an interior delivery service using a predetermined browser of a terminal used by the user and issues a delivery request, the information processing device can display trunk-sharing vehicles which are available as a delivery destination of luggage on a predetermined web page of the web site. For example, when a user starts an application cooperating with the web site and installed in a terminal used by the user and issues a delivery request, the information processing device can display trunk-sharing vehicles which are available as a delivery destination of luggage on a predetermined window of the application (which includes a screen of the application displayed on a display of a mobile terminal such as a smartphone to occupy the display).

In the first aspect, the target vehicle notifying unit may be configured to display a map image on the display device, and display a vehicle image corresponding to the available vehicle at a position on the map image, the position corresponding to a parking place when the available vehicle is rented as the accommodation place of the object, such that the vehicle image overlaps the map image at the position.

According to this configuration, the information processing device can display trunk-sharing vehicles which are available as a delivery destination of luggage such that the trunk-sharing vehicles are arranged at positions corresponding to parking places at the time of rental on a map image. Accordingly, a user can easily understand geometrical positions of the trunk-sharing vehicles which are available as a delivery destination of luggage. Accordingly, the information processing device can improve convenience for a user when detecting trunk-sharing vehicles which are available as a delivery destination of luggage.

In the first aspect, the information processing device may include a vehicle reserving unit configured to receive a reservation for the available vehicle, when the available vehicle is selected by a predetermined operation of the user in the terminal, as an accommodation place of the object, or make a request for the reservation to a predetermined external device.

According to this configuration, the information processing device can allow a user to select a trunk-sharing vehicle which will be used as a delivery destination of luggage from trunk-sharing vehicles which are available as a delivery destination of luggage and which are displayed on a terminal used for a delivery request by the user and to reserve the selected trunk-sharing vehicle. Accordingly, a user can also reserve a trunk-sharing vehicle at the time of a delivery request. Accordingly, the information processing device can improve convenience for a user when a delivery request of luggage with an interior space of a trunk-sharing vehicle designated as a delivery destination of luggage is issued.

In the first aspect, the information processing device may include a key information transmitting unit configured to transmit key information, the key information being used to unlock a door for accessing the interior space of the available vehicle rented to the user, to both the user and the provider of the delivery service.

According to this configuration, the information processing device can transmit key information for unlocking a door for accessing the interior space of a trunk-sharing vehicle which is rented to a user to a delivery company (for example, a mobile terminal of a deliverer) and allow the deliverer to deliver luggage to the trunk-sharing vehicle. The information processing device can transmit key information for unlocking the door for accessing the interior space of the trunk-sharing vehicle which is rented to a user to mobile terminal of a user or the like and allow the user to receive luggage delivered to the trunk-sharing vehicle. Accordingly, the information processing device can establish a system for an interior delivery service in which luggage is delivered to an interior space of a trunk-sharing vehicle and a renter of the trunk-sharing vehicle is able to receive the luggage.

In the first aspect, the information processing device may include a non-reception notifying unit configured to notify, when delivery of the luggage to the interior space of the available vehicle rented to the user has been completed, the user that reception of the luggage from the available vehicle has not been completed, when (i) a rental period in which the available vehicle is rented as the accommodation place of the object has expired or a time to expiration of the rental period is shorter than a predetermined time and (ii) the user has not received the luggage from the available vehicle.

According to this configuration, when a rental period of a trunk-sharing vehicle has expired or expiration of a rental period is impending but luggage delivered to the trunk-sharing vehicle has not been received, the information processing device can prompt a user to receive the luggage. Accordingly, when a usable period of a trunk-sharing vehicle as a delivery destination of luggage is limited, the information processing device can prevent a user from forgetting to receive luggage.

In the first aspect, the information processing device may include: a storage unit configured to store reward information corresponding to a predetermined reward, the predetermined reward being given to providers of the vehicles; and a reward giving unit configured to update the reward information corresponding to a provider of a rented vehicle to information including addition of a new reward when the rented vehicle included in the vehicles is rented as the delivery destination of the luggage.

According to this configuration, the information processing device can facilitate provision of vehicles owned by individual persons or corporations as trunk-sharing vehicles by giving a reward, that is, an incentive, to providers of the trunk-sharing vehicles (individual persons or corporations). Accordingly, the number of trunk-sharing vehicles which can be selected as a delivery destination can increase, and a user can more easily use the interior delivery service. Accordingly, the information processing device can allow a user who may not be able to use a vehicle owned by the user, a near relative, or the like to use the interior delivery service.

In the first aspect, the vehicles may be temporarily rented as the accommodation place of the object to the user through a predetermined vehicle rental service.

According to this configuration, the information processing device can cooperate with vehicle rental services such as a car-sharing service and a rental car service and implement an interior delivery service in which an interior space of a rented vehicle can be designated as an accommodation place of an object using the services.

The second aspect of the disclosure provides an information processing method which is performed by an information processing device. The information processing method includes: extracting available vehicle which is available as a delivery destination of luggage from a plurality of vehicles, the vehicles being temporarily rented as an accommodation place of an object, when a user of a delivery service in which an interior space including a trunk of the vehicles is able to be designated as the delivery destination of the luggage issues a delivery request of the luggage to a provider of the delivery service; and notifying the user of the available vehicle.

The third aspect of the disclosure provides a non-transitory storage medium storing an information processing program causing an information processing device to execute the information processing method.

According to the disclosure, it is possible to provide an information processing device, an information processing method, and a non-transitory storage medium having an information processing program stored therein that can allow a user, who may not be able to use a vehicle which is owned by the user or a near relative, to use a delivery service in which an interior space of a vehicle can be designated as a delivery destination of luggage.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of an entire configuration of an authentication key management system;

FIG. 2 is a diagram illustrating an example of a configuration for locking and unlocking a vehicle in the authentication key management system;

FIG. 3 is a diagram illustrating an example of a configuration for a key sharing service in the authentication key management system;

FIG. 4 is a diagram illustrating an example of a configuration for a trunk delivery service for a regular user in the authentication key management system;

FIG. 5 is a diagram illustrating an example of a configuration for a C2C carsharing service in the authentication key management system;

FIG. 6 is a diagram illustrating an example of a configuration for a B2C carsharing service in the authentication key management system;

FIG. 7 is a diagram illustrating an example of a configuration for a trunk delivery service for a renter user in the authentication key management system;

FIG. 8A is a sequence diagram illustrating an example of operations in the authentication key management system associated with a trunk delivery service for a renter user;

FIG. 8B is a sequence diagram illustrating an example of operations in the authentication key management system associated with a trunk delivery service for a renter user;

FIG. 8C is a sequence diagram illustrating an example of operations in the authentication key management system associated with a trunk delivery service for a renter user; and

FIG. 8D is a sequence diagram illustrating an example of operations in the authentication key management system associated with a trunk delivery service for a renter user.

### DETAILED DESCRIPTION OF EMBODIMENTS

Hereinafter, an embodiment of the disclosure will be described with reference to the accompanying drawings.

[Entire Configuration of Authentication Key Management System]

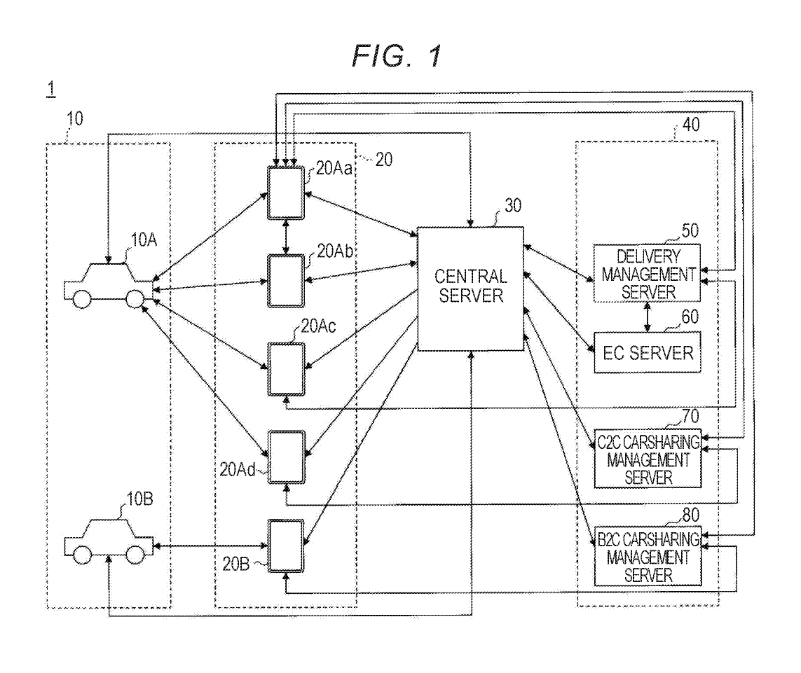

FIG. 1 is a diagram illustrating an example of the entire configuration of an authentication key management system 1 according to an embodiment.

The authentication key management system 1 includes a vehicle 10, a mobile terminal 20, a central server 30, and a service management server 40.

The vehicle 10 can perform radio communication over a relative short distance (a distance over which communication between the interior and the exterior of the vehicle is possible) (hereinafter referred to as “short-range communication”) with the mobile terminal 20. The vehicle 10 is a target in which locking and unlocking of a door thereof and starting (ignition-on) thereof are performed based on a transmission signal (an authentication request, a locking request, and an unlocking request which will be described later) from the mobile terminal 20. The doors of the vehicle 10 can include a boarding door and a cargo compartment door (for example, a trunk lid and a back door) for accessing a trunk (a cargo compartment). Ignition-on (IG-ON) of the vehicle 10 can include starting of an engine in a vehicle 10 having the engine as a main power source and power-on of an electric motor in a vehicle 10 having the electric motor as a main power source. In the following description, it is assumed that the vehicle 10 has an engine 117 which will be described later as a main power source, starting (IG-ON) of the vehicle 10 corresponds to starting of the engine 117, and stopping (IG-OFF) of the vehicle 10 corresponds to stopping of the engine 117 in this embodiment.

The vehicle 10 is communicatively connected to the central server 30 via a predetermined communication network (for example, a mobile phone network with a plurality of base stations as terminals or the internet). The vehicle 10 transmits vehicle information such as position information to the central server 30 as will be described later.

The vehicle 10 includes a vehicle 10A which is owned by an individual person and a vehicle 10B which is owned by a provider of a business-to-consumer (B2C) carsharing service.

The mobile terminal 20 is communicatively connected to the central server 30 via a predetermined communication network (for example, a mobile phone network with a plurality of base stations as terminals or the internet). The mobile terminal 20 can unlock or lock the vehicle 10 by acquiring authentication key information (which is an example of key information and which is hereinafter referred to as an “authentication key”) transmitted from the central server 30 and transmitting the acquired authentication key to the vehicle 10 by radio communication over a relatively short distance in response to a user's predetermined operation. The mobile terminal 20 may be, for example, a general-purpose mobile phone, a smartphone, or a tablet terminal, and the above-mentioned functions may be implemented by starting a predetermined application program (hereinafter referred to as a “key application”) installed in a processing device 23 incorporated therein. The mobile terminal 20 may be a portable dedicated terminal which acquires an authentication key from the central server 30 and which can perform unlocking of a door of the vehicle 10 and starting of the vehicle 10 using the acquired authentication key. The mobile terminal 20 includes mobile terminals 20Aa to 20Ad corresponding to the vehicle 10A and a mobile terminal 20B corresponding to the vehicle 10B.

The mobile phone 20Aa is a mobile terminal which is carried by an owner (an owner user) from regular users of the vehicle 10A (hereinafter referred to as “regular users”). The mobile terminal 20Aa may bidirectionally communicate with the mobile terminal 20Ab by radio communication over a relatively short distance.

The mobile terminal 20Ab includes is a mobile terminal which is carried by a regular user other than the owner user of the vehicle 10A (for example, including a family member of the owner user or a near relative of the owner user and hereinafter referred to as a “subsidiary user”).

The subsidiary user may include a user who does not drive the vehicle 10A or who cannot drive the vehicle 10A (for example, a child less than 18 years old of the owner user). For example, when only a trunk delivery service which will be described later is used, a regular user does not need to drive the vehicle 10A.

The mobile terminal 20Ac is carried by a deliverer of a provider of a trunk delivery service (hereinafter simply referred to as a “delivery company”) which will be described later. The mobile terminal 20Ac is communicatively connected to the central server 30 and a delivery management server 50 which will be described later via a predetermined communication network (for example, a mobile phone network with a plurality of base stations as terminals or the internet).

The mobile terminal 20Ad is a mobile terminal which is carried by a renter of the vehicle 10A in a consumer-to-consumer (C2C) carsharing service which will be described later. The mobile terminal 20Ad is communicatively connected to the central server 30 and a C2C carsharing management server 70 which will be described later via a predetermined communication network (for example, a mobile phone network with a plurality of base stations as terminals or the internet).

The mobile terminal 20B is a mobile terminal which is carried by a renter of the vehicle 10B in a business-to-consumer (B2C) carsharing service which will be described later. The mobile terminal 20B is communicatively connected to the central server 30 and a B2C carsharing management server 80 via a predetermined communication network (for example, a mobile phone network with a plurality of base stations as terminals or the internet).

The central server 30 is communicatively connected to the vehicle 10, the mobile terminal 20, and the service management server 40.

The central server 30 manages issuance of an authentication key for the vehicle 10. For example, the central server 30 issues an authentication key based on predetermined conditions and transmits the issued authentication key to the mobile terminal 20.

The central server 30 acquires position information from the vehicle 10. Accordingly, the central server 30 can ascertain the position of the vehicle 10.

The central server 30 operates a carsharing service in which the vehicle 10A is shared by a plurality of regular users including the owner user of the vehicle 10A. Specifically, the central server 30 operates a sharing service with an authentication key (a key sharing service) in which an authentication key for the vehicle 10A can be acquired by a plurality of regular users who are registered in advance and who include an owner user using the mobile terminals 20 (the mobile terminals 20Aa and 20Ab).

The central server 30 performs a registration process (a user registering process) for allowing a regular user of the vehicle 10A to use a service using the vehicle 10A (such as a key sharing service, a trunk delivery service, or a C2C carsharing service). Specifically, the central server 30 registers an authority to transmit an authentication key to a predetermined mobile terminal 20 (hereinafter referred to as an “authentication key provision authority”) by causing a key sharing managing unit 3207 which will be described later or the service management server 40 to transmit a request for provision of an authentication key which will be described later in order for a regular user of the vehicle 10A to use the service using the vehicle 10A.

The central server 30 manages a usage status of the vehicle 10A over a plurality of services (that is, a plurality of providers) such as a trunk delivery service and a C2C carsharing service.

The service management server 40 manages operation of various services which are provided using the vehicles 10. The service management server 40 includes a delivery management server 50 and an electronic commerce (EC) server 60 corresponding to a trunk delivery service, a C2C carsharing management server 70 corresponding to a C2C carsharing service, and a B2C carsharing management server 80 corresponding to a B2C car service.

The trunk delivery service can include a delivery service in which products ordered from an EC site which will be described later are used as delivery objects and a delivery service in which objects other than products ordered on an EC site are used as delivery objects. The latter trunk delivery service can include, for example, a service in which a trunk of the vehicle 10A can be designated as a delivery destination when a requester requests delivery of luggage to a regular user of the vehicle 10A. The latter trunk delivery service can include, for example, a service in which a vehicle 10A parked at a home parking lot of a regular user can be designated as a delivery destination when the regular user of the vehicle 10A wants to send luggage to the home from a trip destination or a business trip destination. The latter trunk delivery service can include, for example, a service in which a regular user can change a delivery destination to the trunk of the vehicle 10A when a notification indicating that luggage is scheduled to be delivered to the home has been transmitted from the delivery management server 50 to the regular user of the vehicle 10A via an e-mail, an account of a social networking service (SNS), or a specific application program started in the mobile terminal 20Aa or 20Ab. In the following description, the former trunk delivery service will be mainly described in this embodiment, but the operations of elements associated with the trunk delivery service which will be described later can be used as the operations of elements in the latter trunk delivery service.

The delivery management server 50 is communicatively connected to the mobile terminal 20Ac and the central server 30 via a predetermined communication network and performs operation and management of a physical distribution system associated with the trunk delivery service from receiving of luggage to delivery of luggage to the trunk of the vehicle 10A. The trunk delivery service which is operated and managed by the delivery management server 50 includes a service in which the trunk of the vehicle 10A can be designated as a delivery destination of luggage to a regular user of the vehicle 10A (for example, a product for home which is ordered on an EC site by a regular user, luggage which is sent to the home from a trip destination or a business trip destination by a regular user, or luggage which is sent to a regular user of the vehicle 10A from a requester). At this time, luggage to a regular user of the vehicle 10A may include, for example, a product for the home which has been ordered on an EC site by a regular user, luggage which is sent from a trip destination or a business trip destination to the home by a regular user, and luggage which is sent from a requester to a regular user of the vehicle 10A. The trunk delivery service of which operation and management are performed by the delivery management server 50 includes a service in which the trunk of the vehicle 10A or the vehicle 10B can be designated as a delivery destination of luggage to a renter of the vehicle 10A or the vehicle 10B which is rented with only a trunk as an accommodation place of an object as will be described later via the C2C carsharing management server 70 or the B2C carsharing management server 80. Hereinafter, the former trunk delivery service is referred to as a “regular-user trunk delivery service” for the purpose of convenience and the latter trunk delivery service is referred to as a “renter-user trunk delivery service” for the purpose of convenience.

A delivery company which operates the delivery management server 50 may provide regular users of the vehicle 10A with a delivery service in which an interior space other than the trunk of the vehicle 10A instead of or in addition to the trunk of the vehicle 10A can be designated as a delivery destination. In the following description, a delivery service in which the interior space including the trunk of a vehicle 10A (that is, the inside of the vehicle 10A) can be designated as a delivery destination is referred to as an “interior delivery service.” A delivery company that operates the delivery management server 50 may provide regular users of a vehicle 10A with a pickup service in which an interior space including a trunk can be designated as an origin of luggage pickup (hereinafter referred to as an “interior pickup service”) in addition to the interior delivery service. That is, the delivery management server 50 may perform operation and management of the interior pickup service instead of or in addition to the interior delivery service. In this case, luggage to be picked up may be a product (that is, a product purchased in the EC site) which is being returned to a provider of an EC site (or a shop opened for the EC site) corresponding to the EC server 60 or may be delivery luggage not associated with an EC site. The interior pickup service may be implemented as a pickup service in a case in which a provider of a service (for example, a cleaning provider for clothes) in which an article from a client is temporarily kept keeps luggage of a regular user of the vehicle 10A. In this case, similarly to the delivery management server 50, a pickup management server that performs operation and management of the interior pickup service and that can be included in the service management server 40 may be provided by the cleaning provider. That is, instead of or in addition to the delivery management server 50, the pickup management server may be provided. A provider of a service (for example, a waste recovery dealer or a secondhand article purchase dealer) in which a predetermined article (an article such as a waste article or a secondhand book to be purchased) is recovered from a client may provide a regular user of the vehicle 10A with a recovery service (hereinafter referred to as an “interior recovery service”) in which an interior space of a vehicle 10A can be designated as an origin of recovery of an article to be recovered. In this case, similarly to the delivery management server 50, a recovery management server that performs operation and management of a trunk recovery service and that can be included in the service management server 40 may be provided by a waste recovery dealer or the like. That is, instead of or in addition to the delivery management server 50, the recovery management server may be provided.

The EC server 60 is communicatively connected to the central server 30 and the delivery management server 50 via a predetermined communication network and operates a predetermined web site (an EC site) for selling a product or a service. For example, the EC server 60 may display a trunk of a vehicle 10A as an option for a delivery destination on a web page for inputting information on an order for products (hereinafter referred to as an “order input page”) on an EC site which is accessed via a browser started in a terminal carried by a user (for example, mobile terminals 20Aa and 20Ab) by a regular user of the vehicle 10A and a predetermined delivery company (a deliver company corresponding to the delivery management server 50 in this embodiment) which are registered in advance. Accordingly, even when the regular user of the vehicle 10A is absent from the user's home, the regular user can receive a purchased product in a trunk of the vehicle 10A which is parked in a parking lot close to the home or which is used for commuting and is parked in a parking lot of a work place. For example, the EC server 60 may display a rented vehicle 10 as an option for a delivery destination in an order input page on an EC site which is accessed via a browser started in a terminal carried by a user (for example, mobile terminal 20Ad) by a renter of the vehicle 10 (the vehicle 10A or the vehicle 10B) rented in a C2C carsharing service or a B2C carsharing service and a predetermined delivery company registered in advance. Accordingly, similarly, even when the renter of the vehicle 10A rented in the C2C carsharing or B2C carsharing is absent from the renter's home, the renter can receive a purchased product in the trunk of the vehicle 10A which is parked in a parking lot close to the home or which is used for commuting and is parked in a parking lot of a work place.

The C2C carsharing management server 70 is communicatively connected to the mobile terminal 20Ad and the central server 30 and performs operation and management of a C2C carsharing service that supports rental of a vehicle 10A (carsharing) between individual persons. Examples of a type of renting a vehicle 10A in the C2C carsharing service include a normal rental type in which a vehicle 10A is rented as moving means and a rental type in which only an interior part such as a trunk of a vehicle 10A is rented as an accommodation place of an object. In the following description, the former rental type is referred to as a “normal rental type” for the purpose of convenience and the latter rental type is referred to as a “trunk-sharing rental type.” For example, the C2C carsharing management server 70 performs operation and management of the C2C carsharing service such as reception of registration of a rentable date and time and a rental type of a vehicle 10A by an owner user, reception of a reservation for use from a person who wants to rent a vehicle 10A (a renter), and provision of an authentication key of the vehicle 10A.

The B2C carsharing management server 80 is communicatively connected to the mobile terminal 20B and the central server 30 and performs operation and management of a B2C carsharing service in which a vehicle 10B which is owned by a predetermined provider (for example, a provider of a B2C carsharing service) is rented to be commonly used (shared) by a plurality of general users. Examples of the rental type of a vehicle 10B in the B2C carsharing service include the same normal rental type as in the above-mentioned C2C carsharing service and a trunk-sharing rental type. For example, the B2C carsharing management server 80 performs operation and management of a B2C carsharing service such as receiving of a reservation for use of a vehicle 10B, a parking lot of the vehicle 10B, and provision of an authentication key of the vehicle 10B.

Instead of or in addition to the B2C carsharing management server 80, the service management server 40 may include a company car use management server that operates a carsharing service (a company car use management service) in which a vehicle 10 which is a company car of a company is a target for reservation for use and employees of the company are renters. At this time, when there is an idle time period for a vehicle 10 which is a company car, the C2C carsharing management server 70 may operate a C2C carsharing service in which the vehicle 10 which is a company car is rented. The delivery management server 50 and the EC server 60 may operate a trunk delivery service in which a trunk of a vehicle 10 which is a company car of a company can be designated as a delivery destination of luggage which is delivered to the company. The B2C carsharing management server 80 may be replaced with a rental car management server that operates a rental car service for renting a vehicle 10B.

[Details of Configuration for Locking/Unlocking and Starting of Vehicle]

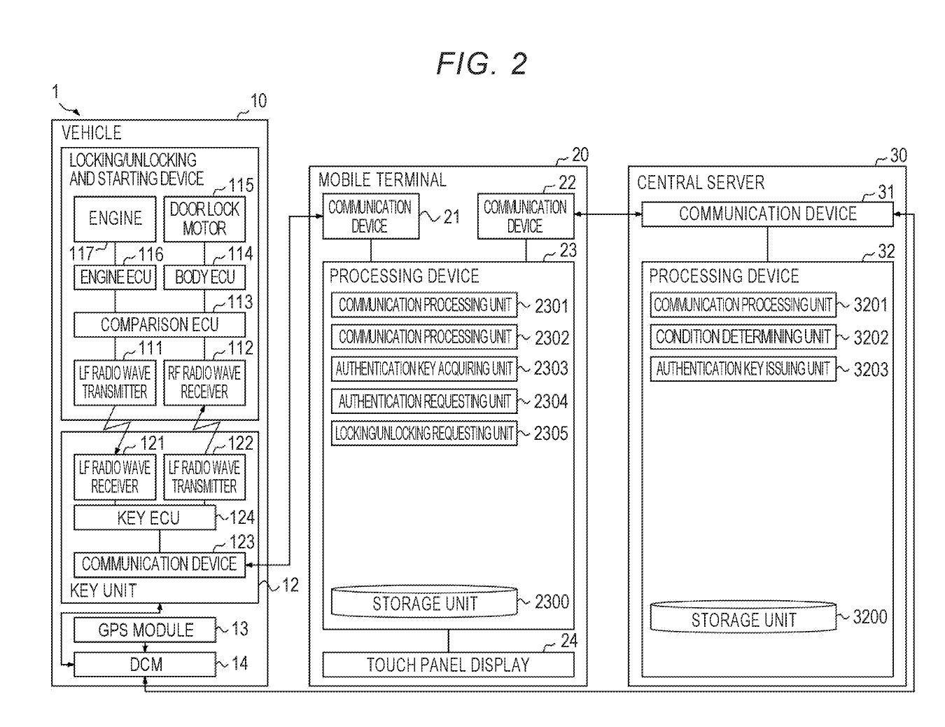

A configuration associated with locking/unlocking and starting of a vehicle 10 in the authentication key management system 1 will be described below with reference to FIG. 2.

FIG. 2 is a diagram illustrating an example of a configuration associated with locking/unlocking and starting of a vehicle 10 in the authentication key management system 1. The vehicle 10 includes a locking/unlocking and starting device 11, a key unit 12, a GPS module 13, and a data communication module (DCM) 14.

The locking/unlocking and starting device 11 is attached to the vehicle 10 and performs unlocking and locking of a door of the vehicle 10 in accordance with a locking signal and an unlocking signal which are transmitted as radio waves of a radio frequency (RF) band (for example, 300 MHz to 3 GHz) (hereinafter referred to as “RF radio waves”) from the key unit 12. The locking/unlocking and starting device 11 starts the vehicle 10 with exchange of radio waves of a low frequency (LF) band (for example, 30 Hz to 300 kHz) (hereinafter referred to as “LF radio waves”) with the key unit with an operation of pressing a start switch (not illustrated) disposed in the interior space of the vehicle 10 as a trigger. The locking/unlocking and starting device 11 includes an LF radio wave transmitter 111, an RF radio wave receiver 112, a comparison electronic control unit (ECU) 113, a body ECU 114, a door lock motor 115, an engine ECU 116, and an engine 117 which is a driving power source of the vehicle 10.

The locking/unlocking and starting device 11 operates with electric power which is supplied form an auxiliary machine battery (not illustrated) mounted in the vehicle 10.

The LF radio wave transmitter 111 is incorporated, for example, into a center console or a door handle in the interior space and transmits LF radio waves under the control of the comparison ECU 113.

The RF radio wave receiver 112 is incorporated, for example, into a trim of a cargo compartment of the vehicle 10 and receives RF radio waves under the control of the comparison ECU 113.

The comparison ECU 113 is an electronic control unit that controls locking/unlocking of a door of the vehicle 10 and starting of the vehicle 10 based on exchange of signals with the key unit 12. The comparison ECU 113 is embodied in hardware, in software, or in combination thereof. For example, the comparison ECU 113 may be constituted by a microcomputer including a central processing unit (CPU), a random access memory (RAM), a read only memory (ROM), an auxiliary storage device, a real time clock (RTC), and a communication interface. The comparison ECU 113 performs various control processes by causing the CPU to execute various programs stored in the ROM or the auxiliary storage device. In the following description, the same is true of the key ECU 124.

The comparison ECU 113 receives an unlocking signal and a locking signal which are transmitted as RF radio waves from the key unit 12 via the RF radio wave receiver 112.

When an unlocking signal or a locking signal has been received, the comparison ECU 113 authenticates a transmission source (the key unit 12) of the unlocking signal or the locking signal based on key information (hereinafter referred to as “internal key information”) included in the unlocking signal or the locking signal. The comparison ECU 113 determines that authentication has succeeded when internal key information registered in advance in an internal memory such as the auxiliary storage device coincides with the internal key information included in the unlocking signal or the locking signal, and determines that authentication has failed when the two pieces of internal key information do not coincide with each other.

For example, the comparison ECU 113 may transmit LF radio waves including a “challenge” which is provided using a predetermined method based on the internal key information in the internal memory from the LF radio wave transmitter 111 to the key unit 12, and may perform challenge response authentication based on a “response” returned from the key unit 12 and received by the RF radio wave receiver 112.

When the authentication has succeeded, the comparison ECU 113 transmits an unlocking command (when an unlocking signal has been received) or a locking command (when a locking signal has been received) to the body ECU 114 via an onboard network such as a controller area network (CAN).

When a response indicating that the door has been unlocked or locked normally (an unlocking response or a locking response) has been received from the body ECU 114 via the onboard network such as a CAN after the unlocking command or the locking command has been transmitted to the body ECU 114, the comparison ECU 113 transmits a notification indicating that the door has been unlocked or locked (an unlocking notification or a locking notification) to the key unit 12 via the LF radio wave transmitter 111.

As will be described later, only some of doors of the vehicle 10 may be designated as an unlocking target with the unlocking signal. In this case, the comparison ECU 113 designates a door to be unlocked with the unlocking command. Accordingly, the body ECU 114 can operate only the door lock motor 115 corresponding to a designated door and unlock only this door.

When the above-mentioned start switch has been pressed, the comparison ECU 113 authenticates the key unit 12 through exchange of a signal with the key unit 12 via the LF radio wave transmitter 111 and the RF radio wave receiver 112.

For example, the comparison ECU 113 transmits a request signal of an LF band for requesting return of the internal key information from the LF radio wave transmitter 111 to the key unit 12. When a response signal including the internal key information has been received from the key unit 12 by the RF radio wave receiver 112, the comparison ECU 113 determines whether authentication has succeeded or failed based on coincidence between the internal key information registered in advance in the internal memory and the internal key information included in the response signal similarly to the case in which the door is locked or unlocked.

For example, the comparison ECU 113 may perform challenge response authentication similarly to the case in which the door is locked or unlocked.

When the authentication has succeeded, the comparison ECU 113 transmits a starting command for the engine 117 to the engine ECU 116 via an onboard network such as a CAN.

The body ECU 114 is an electronic control unit that controls operation of the door lock motor 115 which is communicatively connected thereto by a one-to-one communication line. The body ECU 114 outputs a control command to cause the door lock motor 115 to perform an unlocking operation in accordance with an unlocking command from the comparison ECU 113. The body ECU 114 outputs a control command for causing the door lock motor 115 to perform a locking operation in accordance with a locking command from the comparison ECU 113. When the door is unlocked or locked normally by outputting the control command to the door lock motor 115, the body ECU 114 transmits an unlocking response or a locking response to the comparison ECU 113 via an onboard network such as a CAN.

The door lock motor 115 is an existing electric actuator that unlocks and locks the door of the vehicle 10 in accordance with a control command from the body ECU 114.

The engine ECU 116 is an electronic control unit that controls driving of the engine 117. Specifically, the engine ECU 116 controls driving of various actuators such as a starter and an injector which are mounted in the engine 117. When a starting command has been input from the comparison ECU 113, the engine ECU 116 outputs a control command to various actuators such as a starter and an injector of the engine 117 and starts the engine 117.

The key unit 12 is disposed in the interior space of the vehicle 10 and transmits an unlocking signal and a locking signal as RF radio waves to the locking/unlocking and starting device 11 in response to an unlocking request and a locking request transmitted from the mobile terminal 20. When a starting switch disposed in the interior space of the vehicle 10 has been pressed, the key unit 12 exchanges a signal with the locking/unlocking and starting device 11 in response to a signal of an LF band transmitted from the locking/unlocking and starting device 11. The key unit 12 includes an LF radio wave receiver 121, an RF radio wave transmitter 122, a communication device 123, and a key ECU 124.

The key unit 12 may be disposed at a position (for example, in the inside of a glove box or a center console) which is not easily visible to users sitting on seats of the vehicle 10. The key unit 12 may be fixed to the vehicle 10 or may not be fixed thereto. The key unit 12 may operate with a built-in button battery or may operate with electric power supplied from an auxiliary machine battery which is mounted in the vehicle 10.

The LF radio wave receiver 121 receives LF radio waves under the control of the key ECU 124.

The RF radio wave transmitter 122 transmits RF radio waves under the control of the key ECU 124.

The communication device 123 is an arbitrary device that performs short-range communication with a mobile terminal 20 under the control of the key ECU 124. The communication device 123 may be, for example, a BLE communication module that communicates with a mobile terminal 20 based on a Bluetooth (registered trademark) Low Energy (hereinafter referred to as BLE) communication standard. In the following description, it is assumed that the communication standard which is employed by the communication device 123 is based on BLE communication.

The communication device 123 may be a communication device based on a short-range communication standard of which a communication range is very short, for example, a near field communication (NFC) standard. In this case, the communication device 123 may be incorporated at a position (for example, the inside of a door handle) which is close to an outer body surface of the vehicle 10. Accordingly, even when the communication range of the communication device 123 is very short, the key unit 12 (the key ECU 124) can communicate with a mobile terminal 20 outside the vehicle.

The key ECU 124 is an electronic control unit that performs a control process of transmitting a locking signal and an unlocking signal to the locking/unlocking and starting device 11 in response to an unlocking request and a locking request received from a mobile terminal 20.

The key ECU 124 controls the communication device 123 such that a communicable state based on a predetermined communication standard, for example, the BLE communication standard, with the mobile terminal 20 is set up.

Specifically, the key ECU 124 periodically (for example, every several seconds) transmits an advertising packet including advertisement information which can reach a predetermined communication range from the communication device 123. The advertisement information includes a universally unique identifier (UUID) or a device identifier (ID) corresponding to the key unit 12. Accordingly, a mobile terminal 20 can receive the advertisement packet and specify the key unit 12 which is mounted in the target vehicle 10 by ascertaining the advertisement information.

When a connection request for requesting connection based on the BLE communication has been received from a mobile terminal 20 which is present within a communication range of the vehicle 10 (the key unit 12) having received the advertising packet, the key ECU 124 sets up a BLE communicable state between the mobile terminal 20 and the vehicle 10 (the key unit 12). At this time, the key ECU 124 transmits a connection response indicating that the BLE communicable state has been set up to the mobile terminal 20 via the communication device 123.

In a state in which the BLE communication has been set up, the key ECU 124 receives an authentication request including an authentication key correlated with the key unit 12 from the mobile terminal 20 via the communication device 123.

When an authentication request including an authentication key correlated with the key unit 12 has been received from the mobile terminal 20, the key ECU 124 authenticates the mobile terminal 20 based on the authentication key. When the authentication has succeeded, the key ECU 124 restores the internal key information stored in an internal memory such as an auxiliary storage device to an available state. The internal key information is stored in a state in which it cannot be used for authentication in the locking/unlocking and starting device 11 such as an inaccessible state or an encrypted state. Accordingly, when authentication of the mobile terminal 20 has succeeded, the key ECU 124 changes an access authority to the internal memory for change of the key information to an accessible state or decrypts the encrypted internal key information based on the authentication key. Accordingly, the key ECU 124 can access the internal key information which is normally inaccessible, and transmit an unlocking signal or a locking signal including the internal key information or an unlocking signal or a locking signal including decrypted internal key information to the locking/unlocking and starting device 11. Accordingly, the locking/unlocking and starting device 11 can perform appropriate authentication based on the internal key information included in the unlocking signal and the locking signal. Even when a situation in which a malicious third party illegally obtains the key unit 12 occurs, the internal key information in the key unit 12 is inaccessible or encrypted and thus it is possible to prevent theft of the vehicle 10.

In a state in which the BLE communication has been set up, the key ECU 124 receives an unlocking request and a locking request from the mobile terminal 20 via the communication device 123. When authentication of the mobile terminal 20 has succeeded (specifically, the state in which the BLE communication has been set up is maintained after authentication of the mobile terminal 20 has succeeded) and an unlocking request or a locking request has been received from the mobile terminal 20, the key ECU 124 transmits an unlocking signal or a locking signal including locking/unlocking key information to the locking/unlocking and starting device 11 via the RF radio wave transmitter 122.

Accordingly, unlocking or locking of the door of the vehicle 10 is implemented after an authentication process has been performed in the locking/unlocking and starting device 11.

When an unlocking notification has been received from the locking/unlocking and starting device 11 via the LF radio wave receiver 121 after the unlocking signal has been transmitted to the locking/unlocking and starting device 11, the key ECU 124 transmits an unlocking completion notification to the mobile terminal 20 in which the BLE communication has been set up, that is, the mobile terminal 20 which is a transmission source of the unlocking request, via the communication device 123. Similarly, when a locking notification has been received from the locking/unlocking and starting device 11 via the LF radio wave receiver 121 after the locking signal has been transmitted to the locking/unlocking and starting device 11, the key ECU 124 transmits a locking completion notification to the mobile terminal 20 in which the BLE communication has been set up via the communication device 123. Accordingly, the mobile terminal 20 which is a transmission source of the locking request or the unlocking request based on a user's predetermined operation can ascertain that locking or unlocking of the vehicle 10A has been completed normally.

When the starting switch disposed in the interior space of the vehicle 10 has been pressed as described above, the key ECU 124 exchanges a signal with the locking/unlocking and starting device 11 in response to a signal of an LF band transmitted from the locking/unlocking and starting device 11.

For example, when the request signal has been received from the locking/unlocking and starting device 11 by the LF radio wave receiver 121, the key ECU 124 transmits a response signal including the internal key information stored in the internal memory or the like to the locking/unlocking and starting device 11 via the RF radio wave transmitter 122.

For example, when LF radio waves including a “challenge” have been received from the locking/unlocking and starting device 11 by the LF radio wave receiver 121, the key ECU 124 generates a “response” based on the internal key information and transmits the generated response to the locking/unlocking and starting device 11 via the RF radio wave transmitter 122.

Accordingly, starting of the engine 117 is performed after the authentication process has been performed in the locking/unlocking and starting device 11.

In the authentication key, an authority for a function of locking/unlocking or starting a vehicle 10 which is given by the central server 30 can be defined.

For example, when the authentication key has only an authority to unlock some doors of the doors of the vehicle 10, the key ECU 124 transmits an unlocking signal including information designating the doors which may be unlocked to the key unit 12 via the RF radio wave transmitter 122. Accordingly, as described above, only some doors of the vehicle 10 can be unlocked.

For example, when the authentication key does not have an authority to start the engine 117, the key ECU 124 may not exchange a signal with the locking/unlocking and starting device 11 even if a signal of an LF band based on an operation of pressing the starting switch has been received from the locking/unlocking and starting device 11 by the LF radio wave receiver 121. Accordingly, it is possible to prohibit starting of the engine 117 in accordance with the authority of the authentication key.

The GPS module 13 receives GPS signals transmitted from three or more, preferably, four or more satellites over the vehicle 10 and measures the position of the vehicle 10. The GPS module 13 is communicatively connected to the DCM 14 via a one-to-one communication line or an onboard network such as a CAN, and the measured position information of the vehicle 10 is input to the DCM 14 or the like.

The DCM 14 is a communication device that performs bidirectional communication with the central server 30 via a predetermined communication network. The DCM 14 transmits current position information of the vehicle 10 input from the GPS module 13 to the central server 30 at a prescribed time, in response to a request from the central server 30, or the like. The DCM 14 transmits a variety of vehicle information (for example, information indicating that a door of the vehicle 10 has been unlocked or the vehicle 10 has been started based on the authentication key and being acquired from the key unit 12) which can be acquired via an onboard network such as a CAN to the central server 30 at a prescribed time, in response to a request from the central server 30, or the like.

The mobile terminal 20 includes a communication device 21, a communication device 22, a processing device 23, and a touch panel display (hereinafter simply referred to as a “display”) 24.

The communication device 21 is an arbitrary device that performs short-range communication with the mobile terminal 20 based on the same communication standard as the communication device 123. As described above, the communication device 21 is, for example, a BLE communication module in this embodiment.

The communication device 22 is an arbitrary device that communicates with the central server 30 and the service management server 40 via a predetermined communication network. The communication device 22 is, for example, a mobile communication module corresponding to a communication standard such as Long Term Evolution (LTE), 4th Generation (4G), or 5th Generation (5G).

The processing device 23 performs various control processes in the mobile terminal 20. The function of the processing device 23 may be implemented in hardware, in software, or in combination thereof, and the processing device 23 includes, for example, a CPU, a RAM, a ROM, an auxiliary storage device, an RTC, and various communication interfaces. The processing device 23 includes a communication processing unit 2301, a communication processing unit 2302, an authentication key acquiring unit 2303, an authentication requesting unit 2304, and a locking/unlocking requesting unit 2305 as functional units which are embodied by causing the CPU to execute, for example, one or more programs stored in the ROM or the auxiliary storage device. The processing device 23 includes, for example, a storage unit 2300 which is embodied as a storage area in the auxiliary storage device, and a process of accumulating (storing) various data in the storage unit 2300 is performed by a predetermined program which is stored in the ROM or the auxiliary storage device.

The communication processing unit 2301 performs bidirectional short-range communication with the key unit 12 using the communication device 21 and transmits and receives various signals.

The communication processing unit 2302 is connected to a predetermined communication network using the communication device 22 and transmits and receives various signals such as a data signal and a control signal to and from the central server 30 or the service management server 40.

The authentication key acquiring unit 2303 acquires an authentication key from the central server 30, for example, in response to a user's predetermined operation on a predetermined graphical user interface (GUI) which is displayed on the display 24 and stores the acquired authentication key in the storage unit 2300. In the following description, it is assumed that various operations on the mobile terminal 20 are performed as operations on a GUI which is displayed on the display 24 in cooperation with the operation of the key application.

For example, the authentication key acquiring unit 2303 of the mobile terminal 20Aa transmits a request for acquisition of an authentication key to the central server 30 via the communication processing unit 2302. Accordingly, the central server 30 receives the request for acquisition of an authentication key and issues an authentication key when it is a normal request for acquisition of an authentication key. Then, the authentication key acquiring unit 2303 acquires the authentication key transmitted from the central server 30 via the communication processing unit 2302.

For example, the authentication key acquiring unit 2303 of the mobile terminal 20Ab acquires an authentication key transmitted from the central server 30 to the mobile terminal 20Ab via the communication processing unit 2302 in response to a key sharing request (which will be described later) transmitted from the mobile terminal 20Aa to the central server 30.

The authentication key acquiring unit 2303 of the mobile terminal 20Ab may transmit a request for acquisition of an authentication key to the central server 30 via the communication processing unit 2302. In this case, when the request for acquisition of an authentication key has been received from the mobile terminal 20Ab, the central server 30 can inquire of the mobile terminal 20Aa of the owner user about whether transmission of an authentication key is permitted.

For example, the authentication key acquiring units 2303 of the mobile terminals 20Ac, 20Ad, and 20B transmit a request for acquisition of an authentication key for requesting acquisition of an authentication key to the delivery management server 50, the C2C carsharing management server 70, and the B2C carsharing management server 80.

Accordingly, the delivery management server 50, the C2C carsharing management server 70, and the B2C carsharing management server 80 transmit a request for provision of an authentication key to the central server 30 in response to reception of the request for acquisition of an authentication key, and the central server 30 issues an authentication key in response to the request for provision of an authentication key. Then, the authentication key acquiring unit 2303 acquires the authentication key transmitted from the central server 30 via the communication processing unit 2302.

The authentication key acquiring units 2303 of the mobile terminals 20Ac, 20Ad, and 20B may transmit a request for acquisition of an authentication key to the central server 30 via the communication processing unit 2302. In this case, the central server 30 may determine whether it is a normal request for acquisition of an authentication key by inquiring of the delivery management server 50, the C2C carsharing management server 70, and the B2C carsharing management server 80.

The authentication requesting unit 2304 transmits an authentication request for requesting authentication of the mobile terminal 20 which is a remote control unit for locking and unlocking the door of the vehicle 10 to the key unit 12 of the vehicle 10 via the communication processing unit 2301. For example, the authentication requesting unit 2304 may transmit the authentication request to the key unit 12 when a key unit corresponding to the authentication key has been found, specifically, when an advertising packet corresponding to the key unit 12 has been received by the communication processing unit 2301. For example, the authentication requesting unit 2304 may transmit the authentication request to the key unit 12 in response to a user's predetermined operation.

The locking/unlocking requesting unit 2305 transmits an unlocking request including an authentication key or a locking request including an authentication key to the key unit 12 via the communication processing unit 2301 in response to a user's predetermined operation. Accordingly, even when an unlocking request or a locking request has been transmitted to the key unit 12 before the authentication request has been transmitted from the authentication requesting unit 2304, locking and unlocking of the door of the vehicle 10 based on the authentication process in the key unit 12 can be realized. For example, an unlocking button for requesting unlocking of the vehicle 10 and a locking button for requesting locking of the vehicle 10 may be displayed on a GUI as an operation screen of the display 24, a locking request may be transmitted by touching the locking button, and an unlocking request may be transmitted by touching the unlocking button. The locking request and the unlocking request may be transmitted in response to an operation of a predetermined operation unit based on hardware disposed in the mobile terminal 20.

For example, the functions of the authentication key acquiring unit 2303, the authentication requesting unit 2304, the locking/unlocking requesting unit 2305 may be able to be used by a user by starting a predetermined application program installed in the ROM, the auxiliary storage device, or the like of the processing device 23. In the following description, it is assumed that the functions of the authentication key acquiring unit 2303, the authentication requesting unit 2304, and the locking/unlocking requesting unit 2305 of the processing device 23 is able to be used by a user by starting the key application installed in the processing device 23 (the auxiliary storage device or the ROM).

The display 24 is, for example, a liquid crystal display or an organic electroluminescence (EL) display and is a display device that is disposed on a front surface of the mobile terminal 20 and also serves as an existing touch panel type of operation unit.

The central server 30 includes a communication device 31 and a processing device 32.

The functions of the central server 30 may be distributed and implemented by a plurality of servers. Hereinafter, the same is true of the delivery management server 50, the EC server 60, the C2C carsharing management server 70, and the B2C carsharing management server 80.

The communication device 31 is an arbitrary device that performs bidirectional communication with the vehicle 10, the mobile terminal 20, and the service management server 40 via a predetermined communication network.

The processing device 32 performs various control processes in the central server 30. The functions of the processing device 32 may be embodied in hardware, in software, or in combination thereof, and the processing device 32 is constituted, for example, by one or more server computers including a CPU, a RAM, a ROM, an auxiliary storage device, an RTC, and a predetermined communication interface. Hereinafter, the same is true of processing devices 52, 62, 72, and 82 of the delivery management server 50, the EC server 60, the C2C carsharing management server 70, and the B2C carsharing management server 80 which will be described later. The processing device 32 includes a communication processing unit 3201, a condition determining unit 3202, and an authentication key issuing unit 3203 as functional units which are embodied by causing the CPU to execute, for example, one or more programs stored in the ROM or the auxiliary storage device. The processing device 32 may include, for example, a storage unit 3200 which is embodied as a storage area defined in an auxiliary storage device of a server computer or an external storage device connected to the server computer, and a process of accumulating (storing) various data in the storage unit 3200 is implemented by a program stored in the ROM or the auxiliary storage device. Hereinafter, the same is true of storage units 520, 620, 720, and 820 which will be described later.

The communication processing unit 3201 controls the communication device 31 and exchanges various signals such as a control signal and an information signal with the vehicle 10, the mobile terminal 20, and the service management server 40.

The condition determining unit 3202 determines whether it is a normal request for acquisition of an authentication key in response to reception of a request for acquisition of an authentication key from the mobile terminal 20 or a request for provision of an authentication key from the service management server 40 which is received by the communication processing unit 3201.

When the condition determining unit 3202 determines that the request for acquisition of an authentication key or the request for provision of an authentication key is normal, the authentication key issuing unit 3203 specifies specifications of an authentication key to be issued and issues an authentication key corresponding to the specified specifications. For example, the authentication key issuing unit 3203 specifies a vehicle 10 to be locked or unlocked using the authentication key or a key unit 12 or the like corresponding to the vehicle 10. For example, the authentication key issuing unit 3203 specifies an authority of the authentication key associated with a period in which the authentication key is valid (available) or an available frequency. For example, the authentication key issuing unit 3203 specifies an authority of the authentication key associated with unlocking or starting of the vehicle 10 such as a lockable or unlockable door or whether starting of the vehicle 10 is possible. For example, the authentication key issuing unit 3203 specifies an authority of the authentication key associated with temporary key sharing such as whether the authentication key is shared by another mobile terminal 20 in the temporary key sharing which will be described later and a period and a frequency in which the authentication key can be shared by the other mobile terminal 20. In the following description, the authority of the authentication key associated with the available period or frequency, the authority of the authentication key associated with unlocking or starting of the vehicle 10, and the authority of the authentication key associated with temporary key sharing are collectively simply referred to as “various authorities of an authentication key.” Then, the authentication key issuing unit 3203 transmits the issued authentication key to a target mobile terminal 20 via the communication processing unit 3201.

[Details of Configuration of Key Sharing Service]

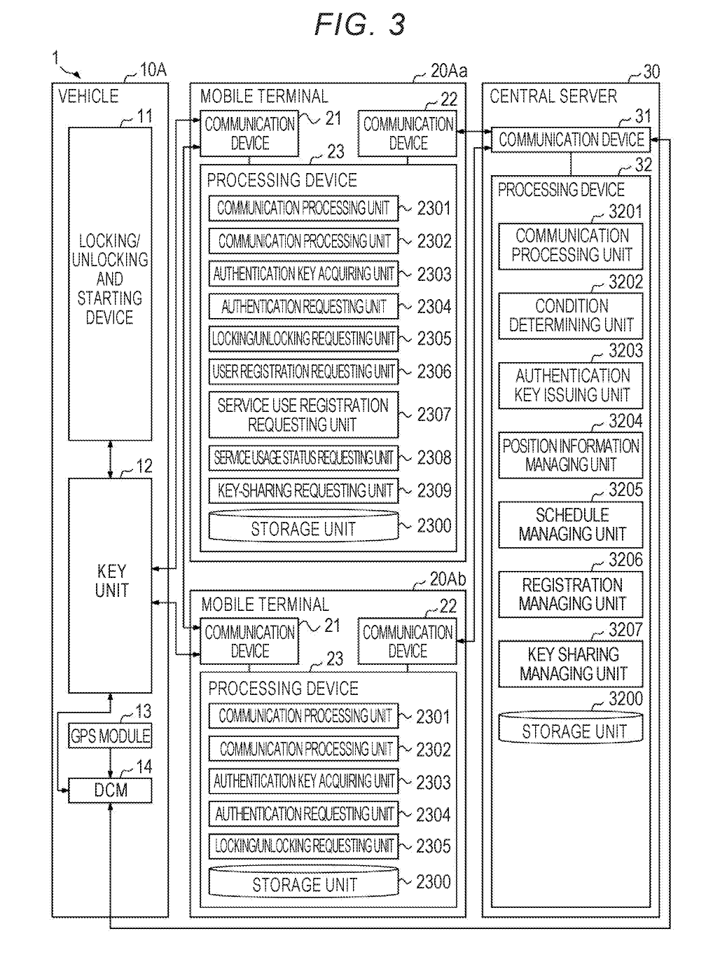

A configuration of a key sharing service in the authentication key management system 1 will be described below with reference to FIG. 3.

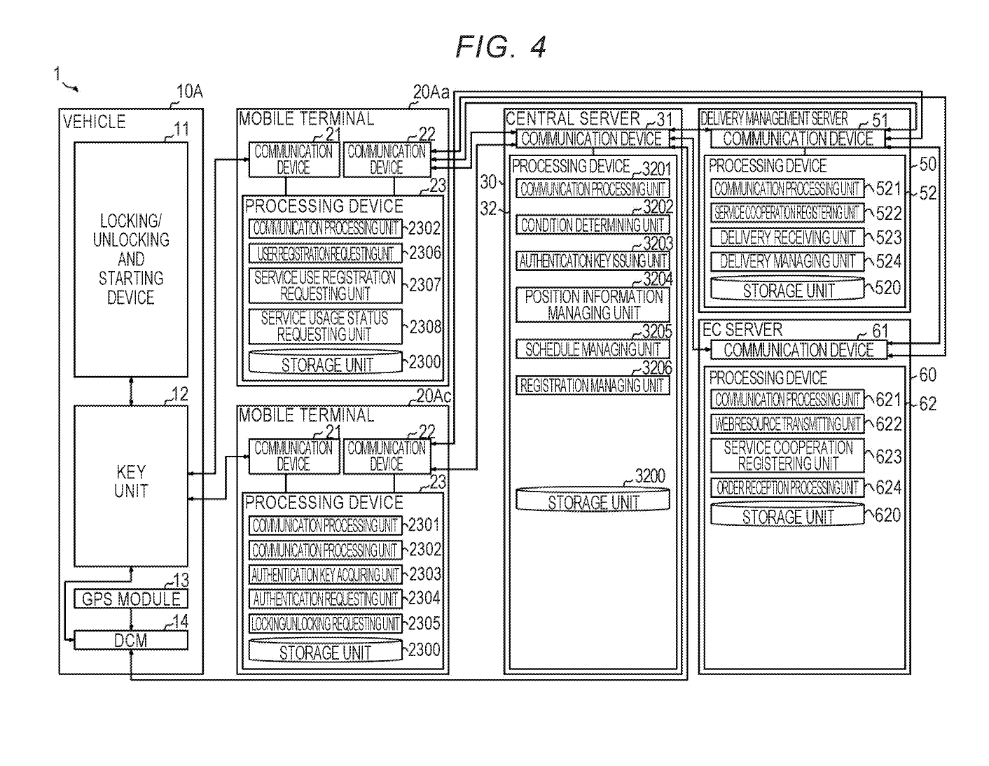

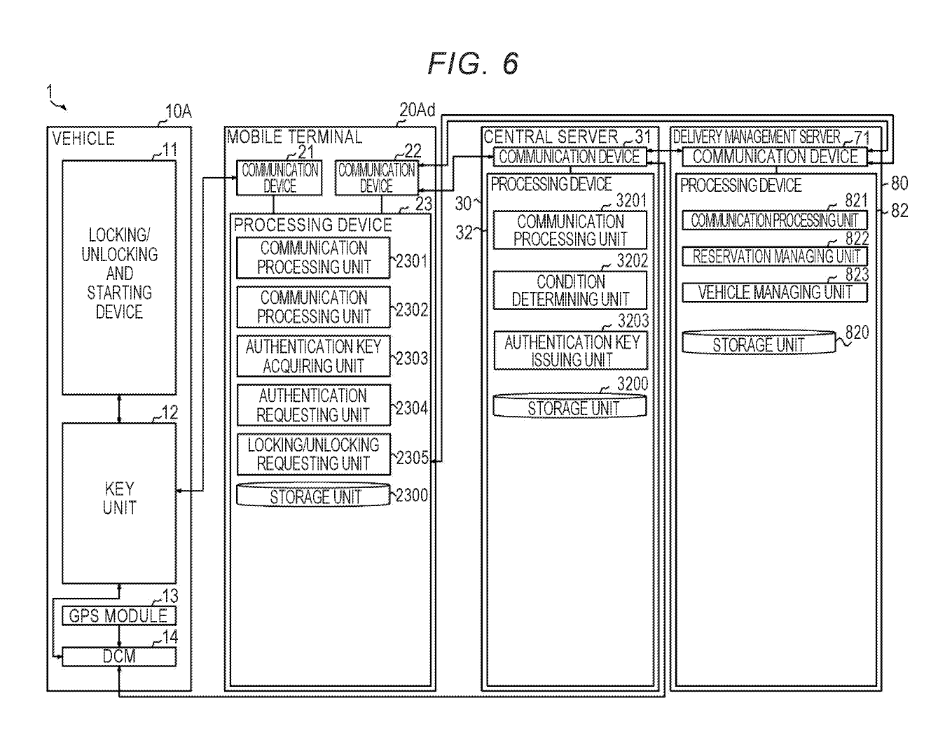

FIG. 3 is a diagram illustrating an example of a configuration of a key sharing service in the authentication key management system 1. In the following description, the configuration of the key sharing service in the authentication key management system 1 will be described with reference to FIG. 3, and description of a configuration overlapping the configuration on locking/unlocking and starting of the vehicle 10 will be minimized. The same is true of description with reference to FIGS. 4 and 6.

The processing device 23 of a mobile terminal 20Aa which is carried by an owner user of a vehicle 10A includes a communication processing unit 2301, a communication processing unit 2302, a authentication key acquiring unit 2303, a authentication requesting unit 2304, and a locking/unlocking requesting unit 2305 as described above. The processing device 23 of the mobile terminal 20Aa includes a user registration requesting unit 2306, a service use registration requesting unit 2307, a service usage status requesting unit 2308, and a key sharing requesting unit 2309 as functional units which are embodied by causing the CPU to execute, for example, one or more programs stored in the ROM or the auxiliary storage device.

In this embodiment, it is assumed that the functions of the user registration requesting unit 2306, the service use registration requesting unit 2307, the service usage status requesting unit 2308, and the key sharing requesting unit 2309 of the mobile terminal 20Aa can be used by the owner user when the key application is started and user authentication based on directional communication with the central server 30 has succeeded. It is assumed that the user authentication is performed by the central server 30 based on an ID defined in advance for the owner user (hereinafter referred to as an “owner user ID”) and a password corresponding to the owner user ID.

The user registration requesting unit 2306 requests the central server 30 to register a regular user of the vehicle 10A who uses various services (such as a key sharing service, a trunk delivery service, and a C2C carsharing service) using the vehicle 10A in response to a predetermined operation by the owner user. For example, the user registration requesting unit 2306 transmits a request for registration of a user including an owner user ID and a password and attribute information for specifying a subsidiary user to be registered (for example, name, age, and relationship with the owner user) to the central server 30 via the communication processing unit 2302.

When a notification indicating that registration of a subsidiary user has been completed (a user registration completion notification) has been received from the central server 30 by the communication processing unit 2302, the user registration requesting unit 2306 stores an ID of the subsidiary user (hereinafter referred to as a “subsidiary user ID”) and a password which are included in the user registration completion notification in the storage unit 2300. At this time, the user registration requesting unit 2306 may transmit the subsidiary user ID and the password to the mobile terminal 20Ab carried by the registered subsidiary user via the communication processing unit 2301 in response to a predetermined operation by the owner user.

The service use registration requesting unit 2307 requests the central server 30 to register use of various services using the vehicle 10A by a regular user of the vehicle 10A in response to a predetermined operation by the owner user. That is, the service use registration requesting unit 2307 requests registration of an authentication key provision authority of a key sharing managing unit 3207 or the service management server 40 corresponding to various services for use of various services by the regular user of the vehicle 10A as described above. For example, the service use registration requesting unit 2307 transmits a service user registration request including the owner user ID, the password thereof, information for specifying the vehicle 10A sued for various services, information for specifying a target service, and an ID of a regular user (an owner user ID or a subsidiary user ID) who uses the target service to the central server 30 via the communication processing unit 2302. In the following description, the owner user ID and the subsidiary user ID may be collectively referred to as a “regular user ID.” Accordingly, the service use registration requesting unit 2307 can register a subsidiary user who uses the key sharing service in the central server 30.

The service use registration requesting unit 2307 receives a notification indicating that registration of use of a service based on the service use registration request has been completed from at least one of the central server 30 and the service management server 40 via the communication processing unit 2302. Then, the service use registration requesting unit 2307 displays the notification indicating that registration of user of a specific service by a regular user of the vehicle 10A based on a predetermined operation of the owner user has been completed on the display 24. Accordingly, the owner user can ascertain that registration of use of a specific service by the regular user has been completed.

The service usage status requesting unit 2308 requests the central server 30 to transmit information on a usage status of various services (service usage status information) including the key sharing service by the regular user of the vehicle 10A of which use has been registered to correspond to the owner user ID in response to a predetermined operation by the owner user. For example, the service usage status requesting unit 2308 transmits a service usage status request including the owner user ID and the password thereof to the central server 30 via the communication processing unit 2302. Then, when the service user state information has been received from the central server 30 by the communication processing unit 2302, the service usage status requesting unit 2308 displays the service usage status information on the display 24. Accordingly, the owner user can unitarily ascertain information on usage statuses of various services by the regular users which are registered in the central server 30 in correlation with the owner user ID.

The key sharing requesting unit 2309 requests the central server 30 to transmit an authentication key for locking/unlocking or starting the vehicle 10A to a subsidiary user registered in the key sharing service in response to a predetermined operation by the owner user. For example, the key sharing requesting unit 2309 transmits a key sharing request including the owner user ID, the password thereof, information for specifying the vehicle 10A to be locked/unlocked using the authentication key, and information for specifying the subsidiary user to which the authentication key will be transmitted (shared) (for example, the subsidiary user ID) to the central server 30 via the communication processing unit 2302. At this time, the key sharing request may include a valid period information on a period in which the authentication key set and transmitted in response to a predetermined operation by the owner user is valid (for example, a use start date and time and a use end date and time). In addition, the key sharing request may include authority information on various authorities of the authentication key associated with a valid period or frequency, an authority of the authentication key associated with unlocking or starting f the vehicle, and an authority of the authentication key associated with temporary key sharing which will be described later. Accordingly, when an authentication key which is simultaneously available is shared by a plurality of mobile terminals 20 as will be described later, use of the vehicle 10A by a user other than the owner user can be limited by allowing the owner user to appropriately set the authority information. Accordingly, it is possible to improve security of the vehicle 10A.

The key sharing requesting unit 2309 may request the central server 30 to transmit an authentication key of which valid periods overlap to mobile terminals 20 of a plurality of regular users of the vehicle 10A (that is, at least one of the mobile terminals 20Aa and 20Ab) in response to a predetermined operation by the owner user. That is, in the key sharing request, a plurality of regular users to which the authentication key is to be transmitted may be designated and the owner user may be included therein. In the key sharing request, the valid periods of the authentication key for the designated plurality of regular users may overlap each other. Accordingly, the authentication key of the vehicle 10A which is simultaneously available can be shared by a plurality of regular users. Accordingly, when a plurality of users gets in the vehicle 10A together for trips or camping, each user can lock and unlock the vehicle 10A without borrowing the mobile terminal 20 storing the authentication key and thus it is possible to improve convenience for a user.

The key sharing requesting unit 2309 may share the already-received authentication key with another mobile terminal 20 (that is, a mobile terminal 20 in which a key application is installed) in response to a predetermined operation by the owner user (hereinafter this authentication key sharing type may be referred to as “temporary key sharing”). At this time, the other mobile terminal 20 may be a mobile terminal 20Ab of a subsidiary user or a mobile terminal 20 of a user other than the subsidiary user, that is, a user who temporarily uses the vehicle 10A.

For example, the key sharing requesting unit 2309 transmits an authentication key (specifically a copy of the authentication key) to the other mobile terminal 20 via the communication processing unit 2301. Accordingly, even when a plurality of users unexpectedly gets in the vehicle 10A for a trip or the like, the owner user of the vehicle 10A can share the authentication key with another user. The mobile terminal 20Aa can directly share the authentication key which is simultaneously available with the other terminal 20. Accordingly, for example, even when the mobile terminal 20Aa is located in a place in which communication conditions in a radio mobile communication network are poor or outside a communication range, the owner user of the vehicle 10A can share the authentication key with another user.

At this time, the key sharing requesting unit 2309 may transmit an authentication key, which is set based on a predetermined operation by the owner user or defined in advance and in which an authority associated with a valid period or frequency or an authority associated with unlocking or starting of the vehicle 10A is limited, to another mobile terminal 20 via the communication processing unit 2301. Specifically, an authentication key to which an authority to limit the valid period or frequency to 30 minutes or one time is given or an authentication key to which an authority limited to only locking/unlocking of a boarding door of the vehicle 10A or to prohibit starting of the vehicle 10A is given may be transmitted to another mobile terminal 20. In the following description, the same is true of temporary key sharing which is carried out by the central server 30. Accordingly, it is possible to improve security of the vehicle 10A based on the temporary key sharing.

When the temporary key sharing is performed, the key sharing requesting unit 2309 may transmit the authentication key from the central server 30 to another mobile terminal 20 as in the case of normal key sharing. At this time, the key sharing requesting unit 2309 may transmit the authentication key of the vehicle 10A from the central server 30 to another mobile terminal 20 by transmitting a temporary key sharing request including information for specifying the transmitted authentication key (for example, an issuance ID included in the authentication key) and information for designating another mobile terminal 20 to which the authentication key is to be transmitted via the communication processing unit 2302 to the central server 30.

For example, when the other mobile terminal 20 is a mobile terminal 20Ab of a subsidiary user, the key sharing requesting unit 2309 may transmit a temporary key sharing request including the subsidiary user ID to the central server 30 via the communication processing unit 2302.

For example, the key sharing requesting unit 2309 acquires predetermined identification information (for example, a QR code (registered trademark) corresponding to a user of the other mobile terminal 20 registered in the central server 30 as an installation user of the key application) from the other terminal 20 via the communication processing unit 2301. The key sharing requesting unit 2309 may transmit a temporary key sharing request for designating another mobile terminal 20 which is specified based on the identification information as a transmission destination to the central server 30.

The mobile terminal 20Aa may acquire the identification information using another method. For example, the mobile terminal 20Aa may acquire identification information corresponding to a user of another mobile terminal 20 by recognizing identification information displayed on the display 24 of the other mobile terminal 20 using a mounted camera function. For example, the mobile terminal 20Aa may acquire identification information transmitted to an e-mail address or an SNS account of the owner user from the user of another mobile terminal 20.

For example, the key sharing requesting unit 2309 transmits a candidate terminal information request for requesting candidate terminal information on candidate terminals which are candidates for another mobile terminal 20 located around the current position of the mobile terminal 20Aa to the central server 30 via the communication processing unit 2302 in response to a predetermined operation by the owner user. When candidate terminal information has been received from the central server 30 by the communication processing unit 2302, the key sharing requesting unit 2309 displays the received candidate terminal information on the display 24. At this time, the candidate terminal information transmitted from the central server 30 may include information for specifying a candidate terminal in which a specific operation is performed from a plurality of candidate terminals. Accordingly, by allowing a user of another mobile terminal 20 to be subjected to key sharing to perform a specific operation on the mobile terminal 20, the owner user of the vehicle 10A can specify another mobile terminal 20 from the candidate terminals displayed on the display 24 of the mobile terminal 20Aa. The key sharing requesting unit 2309 may transmit a temporary key sharing request with the specified other mobile terminal 20 designated as a transmission destination from the candidate terminals to the central server 30 in response to a predetermined operation by the owner user.

The key sharing requesting unit 2309 may start a key application in response to a predetermined operation by the owner user and transmit link information based on a uniform resource locator (URL) scheme (hereinafter simply referred to as “link information”) for allowing another mobile terminal 20 to acquire the authentication key from the central server 30 to an e-mail address or an SNS account of a user of the other mobile terminal 20 via the communication processing unit 2302. At this time, the key sharing requesting unit 2309 transmits a temporary key sharing request for designating the acquired authentication key to the central server 30 via the communication processing unit 2302 in response to a predetermined operation by the owner user and acquires link information which is returned from the central server 30 in response to the temporary key sharing request. Accordingly, key sharing requesting unit 2309 can cause the central server 30 to transmit the authentication key to the other mobile terminal 20.

The temporary key sharing may be carried out by the mobile terminal 20Ab of the subsidiary user to which an authentication key has been already transmitted. That is, the function associated with the temporary key sharing in the key sharing requesting unit 2309 may be included in the function of the key application which is installed in the processing device 23 of the mobile terminal 20Ab of the subsidiary user. Accordingly, even when a plurality of users not including the owner user gets in the vehicle 10A together, the mobile terminal 20Ab of the subsidiary user having acquired the authentication key does not need to be borrowed by the plurality of users and thus it is possible to further improve convenience for the subsidiary user of the vehicle 10A. In the following description, it is assumed that the temporary key sharing can be carried out by a mobile terminal 20Ab of a subsidiary user.

The processing device 32 of the central server 30 includes a communication processing unit 3201, a condition determining unit 3202, an authentication key issuing unit 3203, and a storage unit 3200 as described above. The processing device 32 of the central server 30 includes a position information managing unit 3204, a schedule managing unit 3205, a registration managing unit 3206, and a key sharing managing unit 3207 as functional units which are embodied by causing the CPU to execute, for example, one or more programs stored in the ROM or the auxiliary storage device.

When a request for acquisition of an authentication key has been received from the mobile terminals 20Aa and 20Ab by the communication processing unit 3201, the condition determining unit 3202 performs authentication based on a regular user ID and a password thereof included in the request for acquisition of an authentication key. For example, the condition determining unit 3202 compares the regular user ID and the password included in the request for acquisition of an authentication key with a regular user ID and a password thereof registered in the storage unit 3200 and determines that authentication has succeeded, that is, that it is a normal request for acquisition of an authentication key when the two pieces of information coincide with each other.

The condition determining unit 3202 determines whether a request for provision of an authentication key transmitted from the key sharing managing unit 3207 which will be described later is a normal request for provision of an authentication key. For example, when authentication has succeeded based on the authentication information (for example, the ID and the password) included in the request for provision of an authentication key from the key sharing managing unit 3207, the condition determining unit 3202 may determine that it is a normal request for provision of an authentication key.

When the condition determining unit 3202 determines that it is a normal request for acquisition of an authentication key or a normal request for provision of an authentication key, the authentication key issuing unit 3203 issues an authentication key and transmits the authentication key to the target mobile terminal 20 via the communication processing unit 3201.

The position information managing unit 3204 manages position information of a vehicle 10 (10A or 10B). Specifically, the position information managing unit 3204 transmits a position information request to the vehicle 10 via the communication processing unit 3201. Accordingly, the DCM 14 of the vehicle 10 returns position information of the vehicle 10 input from the GPS module 13 to the central server 30 in response to the position information request, and the position information managing unit 3204 can acquire the position information of the vehicle 10.

For example, the position information managing unit 3204 ascertains a movement state of the vehicle 10A by acquiring the position information from the vehicle 10A via the communication processing unit 3201 and monitoring the position information of the vehicle 10A in real time. Accordingly, the position information managing unit 3204 can notify the owner user of the position information of the vehicle 10A which is rented to the subsidiary user via the communication processing unit 3201. For example, the position information managing unit 3204 can notify the mobile terminal 20Ab of the subsidiary user of information on whether the vehicle 10A which is scheduled to be rented to the subsidiary user is moving to a designated position (the home or the like) or when the vehicle 10A moves back via the communication processing unit 3201.

The schedule managing unit 3205 manages a usage status of the vehicle 10A for each of various services. For example, the schedule managing unit 3205 may periodically acquire information on a user schedule of the vehicle 10 in the key sharing service, specifically, an available date and time of the authentication key transmitted in the key sharing service from the key sharing managing unit 3207. The schedule managing unit 3205 acquires use schedules of the vehicle 10A in the trunk delivery service and the C2C carsharing service from the delivery management server 50 and the C2C carsharing management server 70 via the communication processing unit 3201. Then, the schedule managing unit 3205 generates information on a user schedule of the vehicle 10A (vehicle use schedule information) over a plurality of services based on the acquired use schedules of the vehicle 10A in various services, and updates the old vehicle use schedule information stored in the storage unit 3200.

The registration managing unit 3206 registers a regular user (a subsidiary user) who uses various services in response to a user registration request which is received from the mobile terminal 20Aa of the owner user by the communication processing unit 3201. For example, the registration managing unit 3206 compares the owner user ID and the password included in the user registration request from the mobile terminal 20Aa with the owner user ID and the password stored in the storage unit 3200, and determines that it is a regular user registration request, that is, authentication has succeeded, when the two pieces of information coincide with each other. Then, the registration managing unit 3206 registers the subsidiary user ID included in the regular user registration request as a regular user who can use various services in a user and service registration information database (DB) in the storage unit 3200.

The registration managing unit 3206 registers use of various services by the regular user of the vehicle 10A in response to a service use registration request which is received from the mobile terminal 20Aa of the owner user by the communication processing unit 3201. That is, the registration managing unit 3206 registers an authentication key provision authority of the key sharing managing unit 3207 corresponding to various services for the user of the vehicle 10A to use various services or the service management server 40 in response to the service use registration request. For example, the registration managing unit 3206 performs the above-mentioned authentication process based on the owner user ID and the password included in the service user registration request from the mobile terminal 20Aa and determines whether it is a regular service use registration request. When it is a regular service use registration request, the registration managing unit 3206 determines whether the regular user ID included in the service use registration request is registered in the user and service registration information DB. When the regular user ID included in the service use registration request is already registered in the user and service registration information DB, the registration managing unit 3206 registers a target service specified by the service use registration request as a service which can be used by the regular user corresponding to the regular user ID in the user and service registration information DB in the storage unit 3200.

Specifically, the registration managing unit 3206 constructs a user and service registration information DB in which service-specific information for specifying a target service, vehicle-specific information for specifying the vehicle 10A, the regular user ID for specifying the regular user who uses the service, and service link information in which the vehicle-specific information and the regular user ID corresponding to the vehicle 10A are correlated with the target service are correlated with the owner user ID.

The service-specific information is, for example, a service ID which is defined for each service. Specifically, for example, a specific service ID is defined for each of a plurality of providers when there is a plurality of providers of a C2C carsharing service and, for example, a specific ID is defined for each of a plurality of services which is provided by the same provider when the same provider provides a plurality of C2C carsharing services. When a trunk delivery service is provided by combination of a plurality of delivery companies and a plurality of EC providers, the specific service ID may be defined for each combination of a delivery company and an EC provider or a target service may be specified by a combination of a specific service ID defined for each of a plurality of delivery companies and a specific service ID defined for each of a plurality of EC providers.

The vehicle-specific information may be any type of information as long as it can specify a vehicle 10A which is an object to be locked/unlocked or started using the authentication key. For example, the vehicle-specific information may be identification information such as a vehicle ID or a VIN which is defined for each vehicle 10A or may be identification information such as a key unit ID which is defined for each onboard unit associated with locking/unlocking of a door or starting based on the authentication key and mounted in the vehicle 10A such as a key unit 12. In the following description, it is assumed that the vehicle-specific information is a key unit ID.

The service link information is information required for requesting the authentication key issuing unit 3203 to issue an authentication key of a target vehicle 10A and to transmit the authentication key to a target mobile terminal 20 by allowing the key sharing managing unit 3207, the delivery management server 50, the EC server 60, and the C2C carsharing management server 70 that manage various services to transmit a request for provision of an authentication key. That is, when the request for provision of an authentication key including the service link information is received from the key sharing managing unit 3207, the delivery management server 50, the EC server 60, and the C2C carsharing management server 70, the authentication key issuing unit 3203 can specify the vehicle 10A which is locked/unlocked or started using the authentication key and issue an appropriate authentication key.

The service link information may be any type of information as long as it can correlate a target service and a vehicle 10A with a user who uses the service in the central server 30. For example, the service link information may be a login ID of a regular user in a web site for a user for various services (hereinafter referred to as a “service login ID” for the purpose of convenience) corresponding to the key sharing managing unit 3207, the delivery management server 50, the EC server 60, and the C2C carsharing management server 70. In this case, the service use registration requesting unit 2307 of the mobile terminal 20Aa transmits a service use registration request including a service login ID of a regular user as a registration target corresponding to various services to the central server 30 via the communication processing unit 2302. When a regular user as a registration target corresponding to various service has not acquired a service login ID, the processing device 23 of the mobile terminal 20Aa may start a predetermined browser and acquire a service login ID of a web site of various services. Accordingly, when a user (a regular user of a vehicle 10A) logs in for a web site at the time of requesting of a target service, the delivery management server 50 or the C2C carsharing management server 70 can ascertain the service login ID corresponding to the service link information and can easily provide an authentication key for providing a service. In the following description, the service link information associated with the trunk delivery service and the C2C carsharing service is the service login ID.

In a case of a regular user who normally uses a plurality of vehicles 10A, the central server 30 can specify the regular user but cannot specify the vehicle 10A using only the service login ID. Accordingly, the service link information includes information for indirectly specifying the vehicle 10A (for example, information obtained by encrypting vehicle-specific information using a predetermined algorithm) in addition to the service login ID.

When registration of use of various services has been completed, the registration managing unit 3206 transmits a notification indicating the completion to the mobile terminals 20Aa and 20Ab corresponding to the regular users to be registered via the communication processing unit 3201. When registration of use of various services has been completed, the registration managing unit 3206 transmits a service use registration completion notification including the service link information to the key sharing managing unit 3207 or the service management server 40 that performs operation and management of a service to be registered.

The notification indicating that registration of use of various services has been completed may be transmitted to the mobile terminals 20Aa and 20Ab by the service management server 40 having received the service use registration completion notification.

When a service usage status request has been received from the mobile terminal 20Aa by the communication processing unit 3201, the registration managing unit 3206 generates service usage status information based on vehicle use schedule information which is managed in the user and service registration information DB of the storage unit 3200 or by the schedule managing unit 3205, and transmits the generated service usage status information to the mobile terminal 20Aa via the communication processing unit 3201.

The key sharing managing unit 3207 performs operation and management of a key sharing service.

For example, the key sharing managing unit 3207 provides an authentication key to the mobile terminals 20Aa and 20Ab corresponding to the regular user IDs designated in a key sharing request in response to the key sharing request which is received from the mobile terminal 20Aa of the owner user by the communication processing unit 3201. Specifically, the key sharing managing unit 3207 compares the owner user ID and the password included in the key sharing request with the owner user ID and the password stored in the storage unit 3200 and determines that it is a regular key sharing request when the two pieces of information coincide with each other. The key sharing managing unit 3207 inquires of the schedule managing unit 3205 and determines whether there is a mismatch between valid period information and newest vehicle use schedule information included in the key sharing request, that is, whether use date and times associated with use of the vehicle 10A over a plurality of services and a plurality of regular users overlap each other. When there is no use date and time overlapping, the key sharing managing unit 3207 transmits a request for provision of an authentication key including information on regular users corresponding to the mobile terminals 20Aa and 20Ab to which an authentication key is to be transmitted and the vehicle 10A which is locked/unlocked or started using an authentication key which is specified by information included in the key sharing request and authority information such as a period and a frequency in which the mobile terminals 20Aa and 20Ab are valid, an unlockable door, and whether starting is to be performed to the authentication key issuing unit 3203. Accordingly, the authentication key issuing unit 3203 can specify the regular user IDs corresponding to the mobile terminals 20Aa and 20Ab to which the authentication key is to be transmitted and the vehicle 10A which is locked/unlocked or started using the authentication key and issue an appropriate authentication key.

The key sharing managing unit 3207 ascertains attribute information of the users of the mobile terminals 20Aa and 20Ab (for example, ages and driving licenses) to which the authentication key designated in the key sharing request is to be transmitted and which is stored in the storage unit 3200. When the user of the mobile terminal 20Aa or 20Ab (a regular user of the vehicle 10A) to which the authentication key is to be transmitted is a user who is determined not to drive the vehicle 10A, the key sharing managing unit 3207 issues an authentication key to which an authority not to start the vehicle 10A is given to the mobile terminals 20 of the user. Examples of the user who cannot drive the vehicle 10A include a user who does not reach an age at which a driving license can be acquired and a user who has not acquired a driving license. Specifically, the key sharing managing unit 3207 transmits a request for provision of an authentication key in which a notification for prohibiting starting of the vehicle 10A is included in the authority information corresponding to the mobile terminal 20Aa or 20Ab corresponding to the user determined not to drive the vehicle 10A to the authentication key issuing unit 3203. Accordingly, the authentication key issuing unit 3203 can transmit an authentication key to which an authority to prohibit starting of the vehicle 10A is given to the mobile terminal 20Aa or 20Ab of the user who cannot drive the vehicle 10A and thus it is possible to improve security of the vehicle 10A in the key sharing service.

For example, the key sharing managing unit 3207 transmits an authentication key of the vehicle 10A to another mobile terminal 20 designated in a temporary key sharing request based on the temporary key sharing request which is received from the mobile terminal 20Aa of the owner user by the communication processing unit 3201. Specifically, the key sharing managing unit 3207 specifies an ID of an installation user (hereinafter referred to as an “installation user ID”) corresponding to the other mobile terminal 20 as a transmission destination based on an installation user information DB of a key application stored in the storage unit 3200. Then, the key sharing managing unit 3207 transmits a request for provision of an authentication key including the specified installation user ID and information corresponding to the authentication key designated in the temporary key sharing request (for example, an issuance ID of an authentication key included in the temporary key sharing request) to the authentication key issuing unit 3203. Accordingly, the authentication key issuing unit 3203 can specify another mobile terminal 20 as a transmission destination based on the installation user ID and the authentication key issuance ID, and the like, and transmit the authentication key to the other mobile terminal 20 via the communication processing unit 3201.

The function of the key sharing managing unit 3207 may be transferred to a server (a key sharing management server) outside the central server 30 which can be included in the service management server 40, similarly to other services using a vehicle 10A.

A mobile terminal 20Ab which is carried by a subsidiary user includes a communication processing unit 2301, a communication processing unit 2302, an authentication key acquiring unit 2303, an authentication requesting unit 2304, a locking/unlocking requesting unit 2305, and a storage unit 2300 as described above.

In this embodiment, it is assumed that the function of the authentication key acquiring unit 2303 of the mobile terminal 20Ab can be used by a subsidiary user when the key application is started and user authentication based on bidirectional communication with the central server 30 has succeeded. It is assumed that the user authentication is performed by the central server 30 based on a subsidiary user ID and a password thereof. It is assumed that the function of the authentication requesting unit 2304 and the locking/unlocking requesting unit 2305 of the mobile terminal 20Ab can be used by a subsidiary user when the key application is started.

The authentication key acquiring unit 2303 acquires an authentication key which is transmitted from the central server 30 in response to a key sharing request transmitted from the mobile terminal 20Aa to the central server 30 via the communication processing unit 2302 as described above. Accordingly, the mobile terminal 20Ab can lock and unlock a door of the vehicle 10A or start the vehicle 10A based on the functions of the communication processing unit 2301, the authentication requesting unit 2304, and the locking/unlocking requesting unit 2305. That is, a subsidiary user carrying the mobile terminal 20Ab can directly use the vehicle 10A such as locking and unlocking the vehicle 10A or driving the vehicle 10A using the mobile terminal 20Ab without exchanging a key with the owner user in the key sharing service. Similarly, the owner user can lend the vehicle 10A to a subsidiary user without exchanging a key with the subsidiary user. Accordingly, with the key sharing service in the authentication key management system 1, it is possible to improve convenience in rental of a vehicle 10A between an owner user and a subsidiary user of the vehicle 10A.

The authentication key acquiring unit 2303 acquires an authentication key which is transmitted from the central server 30 in response to a temporary key sharing request transmitted from the mobile terminal 20Aa to the central server 30 via the communication processing unit 2302 as described above. The same is true in a case in which an authentication key is transmitted to a mobile terminal 20 other than the mobile terminal 20Ab of the subsidiary user in response to a temporary key sharing request. Accordingly, other mobile terminals 20 including the mobile terminal 20Ab can lock and unlock the door of the vehicle 10A or start the vehicle 10A based on the functions of the communication processing unit 2301, the authentication requesting unit 2304, and the locking/unlocking requesting unit 2305. That is, the subsidiary user carrying the mobile terminal 20Ab can directly use the vehicle 10A such as locking and unlocking the vehicle 10A or driving the vehicle 10A using the mobile terminal 20Ab without borrowing the mobile terminal 20Aa or 20Ab to which the authentication key has been transmitted, for example, even when a plurality of users including other regular users gets in the vehicle 10A for going out and the authentication key has not been acquired in advance. Similarly, the owner user does not need to lend the owner user's mobile terminal 20Aa to the subsidiary user even when an authentication key has not been acquired in advance by the mobile terminal 20Ab of the subsidiary user. Accordingly, with the temporary key sharing service in the authentication key management system 1, it is possible to improve convenience for users when a plurality of users including regular users of the vehicle 10A gets in and uses the vehicle 10A.

[Details of Configuration of Regular-User Trunk Delivery Service]

A configuration of a regular-user trunk delivery service in the authentication key management system 1 will be described below with reference to FIG. 4.

FIG. 4 is a diagram illustrating an example of a configuration of a regular-user trunk delivery service in the authentication key management system 1. In the following description, the configuration of the regular-user trunk delivery service in the authentication key management system 1 will be described with reference to FIG. 4, and description of a configuration overlapping the configuration associated with the key sharing service will be minimized.

The processing device 23 of a mobile terminal 20Aa which is carried by an owner user of a vehicle 10A includes a communication processing unit 2302, a user registration requesting unit 2306, a service use registration requesting unit 2307, and a service usage status requesting unit 2308 as described above.

The user registration requesting unit 2306 requests the central server 30 to register a regular user (a subsidiary user) of the vehicle 10A who uses various services including a trunk delivery service in response to a predetermined operation by the owner user as described above.

The service use registration requesting unit 2307 requests the central server 30 to register use of various services including the trunk delivery service for each registered regular user (the owner user or the subsidiary user) in response to a predetermined operation by the owner user as described above.

For example, the service use registration requesting unit 2307 transmits a service use registration request for using the trunk delivery service, which includes a service login ID for a web site (hereinafter, referred to as “delivery site”) for a user using a service of the delivery management server 50 and a service login ID of an EC site corresponding to the regular user of the vehicle 10A to be registered as service link information, to the central server 30.

The service usage status requesting unit 2308 requests the central server 30 to transmit information on usage statuses of various services (service usage status information) including the trunk delivery service used by the regular user of the vehicle 10A of which use has been registered in correlation with the owner user ID in response to a predetermined operation by the owner user as described above.

The delivery management server 50 that operates a regular-user trunk delivery service (an interior delivery service) includes a communication device 51 and a processing device 52.

The communication device 51 is an arbitrary device that performs bidirectional communication with a mobile terminal 20, the central server 30, and the EC server 60 via a predetermined communication network.

The processing device 52 includes, for example, a communication processing unit 521, a service cooperation registering unit 522, a delivery receiving unit 523, and a delivery managing unit 524 as functional units which are embodied by causing the CPU to execute, for example, one or more programs stored in the ROM or the auxiliary storage device. The processing device 52 includes a storage unit 520 which is embodied as a storage area of an auxiliary storage device of a server computer or the like.

The communication processing unit 521 controls the communication device 51 and transmits and receives various signals such as a control signal and an information signal to and from the mobile terminal 20, the central server 30, and the EC server 60.

The service cooperation registering unit 522 registers information for cooperation between the central server 30 and the delivery management server 50 in use of the trunk delivery service by a regular user of the vehicle 10A in response to a service use registration completion notification which is received from the central server 30 by the communication processing unit 521.

For example, the service cooperation registering unit 522 adds a flag indicating a use target of the regular-user trunk delivery service to the service login ID (a part of the service link information) for a delivery site which is included in the service use registration completion notification in the user management DB that manages users of the delivery site constructed in the storage unit 520. In addition, the service cooperation registering unit 522 performs registration such that the service login ID included in the service use registration completion notification in the user management DB of the storage unit 520 is correlated with information for specifying the vehicle 10A included in the service link information. Accordingly, when a user corresponding to the service login ID normally uses a plurality of vehicles 10A, the delivery management server 50 can transmit a request for provision of an authentication key for a vehicle 10A designated by the user to the central server 30. The delivery management server 50 can transmit an authentication key from the central server 30 to a mobile terminal 20Ac of a deliverer as will be described later by transmitting the request for provision of an authentication key including the service link information such as a specified service login ID for the delivery site or information for specifying the vehicle 10A corresponding to the vehicle 10A designated by the user to the central server 30.

The service cooperation registering unit 522 registers information for cooperation between the delivery management server 50 and the EC server 60 in use of the regular-user trunk delivery service in which a product ordered (purchased) in the EC site by a regular user of the vehicle 10A is a delivery object.

For example, the service cooperation registering unit 522 performs registration such that a service login ID for a web site corresponding to the EC server 60 (that is, an EC site) included in the service use registration completion notification is correlated with the service login ID for the delivery site included in the service use registration completion notification in the user management DB of the storage unit 520. Accordingly, when a delivery request based on reception of a product order including the service login ID for the EC site has been received from the EC server 60, the delivery management server 50 can specify the service login ID for the delivery site.

The delivery receiving unit 523 receives information on a delivery request for luggage (delivery request information) including the service login ID for the EC site corresponding to an orderer of the product in the EC site from the EC server 60 via the communication processing unit 521. The delivery request information which can be received from the EC server 60 includes information for specifying an orderer from users who are registered in advance in the storage unit 520 as a use target of the regular-user trunk delivery service (for example, a service login ID for the delivery site or the EC site). The delivery request information includes basic information such as a name, an address, and a phone number of an orderer as a delivery destination. The delivery request information includes information on a designated delivery destination (delivery destination information) and information on a designated delivery date and time (delivery date and time information). For example, when a trunk of a vehicle 10A which is normally used by a requester (a regular user) is designated as a delivery destination, the delivery destination information may include information indicating that a vehicle 10A corresponding to a delivery destination is a target which is normally used by a requester or information for specifying the vehicle 10A (for example, a vehicle ID).

The delivery managing unit 524 performs operation and management of all processes from request to delivery associated with a delivery request received by the delivery receiving unit 523.

For example, when a notification indicating that luggage has arrived at a business office has been received from the business office having jurisdiction over a parking position of the vehicle 10A designated in the delivery destination information of the delivery request via the communication processing unit 521, the delivery managing unit 524 determines a date and time at which delivery of luggage is started, a deliverer in charge of the delivery, or the like to correspond to the designated delivery date and time (a delivery date and a delivery time period).

Before delivery of luggage is started (for example, 10 minutes before), the delivery managing unit 524 inquires of the central server 30 about position information of the vehicle 10A via the communication processing unit 521. The delivery managing unit 524 acquires current position information of the vehicle 10A from the central server 30 via the communication processing unit 521 and determines whether the delivery is possible based on coincidence with the designated parking position of the vehicle 10A or a relationship with a jurisdictional area.

Whether the delivery is possible may be determined by the central server 30.

When it is determined that the delivery of luggage is possible, the delivery managing unit 524 transmits a notification indicating that the luggage can be delivered to a trunk of the vehicle 10A (a delivery possibility notification) to the mobile terminal 20Ac of the deliverer via the communication processing unit 521.

Subsequently, when a request for acquisition of an authentication key has been received from the mobile terminal 20Ac having received the delivery possibility notification by the communication processing unit 521, the delivery managing unit 524 determines whether it is a regular request for acquisition of an authentication key. Specifically, the delivery managing unit 524 may perform the determination by comparing information on luggage to be delivered (hereinafter referred to as “delivery luggage information”) such as a deliverer, a destination (for example, a name or a corporation name of a receiver), a luggage type, a delivery time period, and a delivery place which can be included in the request for acquisition of an authentication key with a variety of information on the luggage registered in the storage unit 520. When it is determined that it is a regular request for acquisition of an authentication key, the delivery managing unit 524 transmits a request for provision of an authentication key to the central server 30 via the communication processing unit 521. At this time, the request for provision of an authentication key includes information for specifying a mobile terminal 20Ac of a deliverer. The information for specifying a deliverer may be, for example, an authentication ID (hereinafter referred to as a “deliverer ID” for the purpose of convenience) which is used for user authentication in the central server 30 in order for the deliverer to use the function of the key application corresponding to the authentication key acquiring unit 2303 of the mobile terminal 20Ac. Accordingly, the mobile terminal 20Ac of the deliverer can acquire an authentication key from the central server 30. The request for provision of an authentication key includes information for specifying luggage to be delivered.

Subsequently, when an inquiry about a current position of a vehicle 10A has been received from the mobile terminal 20Ac of the deliverer who has gone out from the business office for delivery via the communication processing unit 521, the delivery managing unit 524 inquires of the central server 30 about current position information of the vehicle 10A. Then, the delivery managing unit 524 acquires the current position information of the vehicle 10A from the central server 30 via the communication processing unit 521 and transmits (transfers) the current position information of the vehicle 10A to the mobile terminal 20Ac of the deliverer. Accordingly, the deliverer at the destination can compare the current position information of the vehicle 10A with information on the parking position of the vehicle 10A designated in the delivery destination information and determine whether luggage is to be delivered or to be taken back.

Finally, when a delivery completion notification has been received from the mobile terminal 20Ac of the deliverer having completed delivery of the luggage via the communication processing unit 521, the delivery managing unit 524 transmits the delivery completion notification to the central server 30 via the communication processing unit 521 and basically ends the operation and management of the trunk delivery service for the luggage. At this time, the delivery managing unit 524 may notify the regular user of the vehicle 10A who is a requester (a purchaser of a product in the EC site) that the delivery has been completed via an e-mail, a predetermined SNS, or a predetermined application program which is installed in the mobile terminal 20Aa or 20Ab and which cooperates with the delivery site.

When a door for accessing the trunk of the vehicle 10A (such as a trunk lid) has been unlocked and then locked in response to an unlocking request and a locking request from the mobile terminal 20Ac of the deliverer as described above, the DCM 14 of the vehicle 10A may determine that delivery by the deliverer has been completed and transmit a notification indicating the fact to the central server 30. Accordingly, when the notification has been received, the central server 30 can transmit the delivery completion notification to the delivery management server 50. That is, the central server 30 may transmit the delivery completion notification to the delivery management server 50 in response to the notification indicating that delivery has been completed which is received from the vehicle 10A by the deliverer.

The EC server 60 includes a communication device 61 and a processing device 62.

The communication device 61 is an arbitrary device that performs bidirectional communication with a mobile terminal 20, the central server 30, and the delivery management server 50 via a predetermined communication network.

The processing device 62 includes, for example, a communication processing unit 621, a web resource transmitting unit 622, a service cooperation registering unit 623, and an order reception processing unit 624 as functional units which are embodied by causing the CPU to execute, for example, one or more programs stored in the ROM or the auxiliary storage device. The processing device 62 includes a storage unit 620 which is embodied as a storage area of an auxiliary storage device of a server computer or the like.

The communication processing unit 621 controls the communication device 61 and transmits and receives various signals such as a control signal and an information signal to and from the mobile terminal 20, the central server 30, and the delivery management server 50.

The web resource transmitting unit 622 transmits resources corresponding to a web page which is displayed on a browser of an arbitrary terminal of a user who browses an EC site including the mobile terminals 20Aa and 20Ab to the browser of the terminal using a predetermined method based on a variety of information as resources of the EC site which is stored in the storage unit 620. The web page which can be displayed in the EC site includes a top page of the EC site, web pages corresponding to individual products which are handled in the EC site, and an order input page which is used for a user to input a variety of information at the time of ordering an individual product. For example, the web resource transmitting unit 622 transmits a hypertext markup language (HTML) document corresponding to the web page and information subordinate to the HTML document such as an image or a video displayed on the web page together.

The service cooperation registering unit 623 registers information for cooperation between the central server 30 and the EC server 60 in use of the regular-user trunk delivery service by a regular user of the vehicle 10A in response to a service use registration completion notification which is received from the central server 30 by the communication processing unit 621.

For example, the service cooperation registering unit 623 adds a flag indicating a use target of the regular-user trunk delivery service to the service login ID for the EC site which is included in the service use registration completion notification in the user management DB that manages users of the EC site constructed in the storage unit 620.

In addition, the service cooperation registering unit 623 registers information for cooperation between the delivery management server 50 and the EC server 60 in use of the regular-user trunk delivery service in which a product ordered (purchased) in the EC site by the regular user of the vehicle 10A is a delivery object.

For example, the service cooperation registering unit 623 registers (stores) in the storage unit 620, the service login ID for the web site (that is, the delivery site) corresponding to the delivery management server 50 which is included in the service use registration completion notification in correlation with the service login ID included in the service use registration completion notification in the user management DB of the storage unit 620. Accordingly, for example, when an inquiry about an ordered product including the service login ID for the delivery site has been received from the delivery management server 50, the EC server 60 can specify the corresponding service login ID for the EC site.

The order reception processing unit 624 receives an order of a product from a user based on various operation inputs corresponding to the order of a product by a user in the EC site. At this time, when a trunk of a vehicle 10A is selected as a delivery destination in the order input page of the EC site, the order reception processing unit 624 inquires of the central server 30 about vehicle use schedule information via the communication processing unit 621. Accordingly, the order reception processing unit 624 can acquire newest vehicle use schedule information via the communication processing unit 621. Accordingly, for example, when a designated delivery date and time overlaps another schedule, it is possible to take measures such as requesting change of the delivery date and time.

As described above, a regular-user trunk delivery service for luggage other than an ordered product in the EC site can be assumed. In this case, similarly, the delivery management server 50 can acquire newest vehicle use schedule information from the central server 30. Accordingly, when a delivery date and time of luggage to a trunk of a vehicle 10A designated by a regular user of the vehicle 10A overlaps another schedule, the delivery management server 50 can take measures such as requesting change of a delivery date and time.

The processing device 32 of the central server 30 that supports operation of the trunk delivery service (the interior delivery service) includes a communication processing unit 3201, a condition determining unit 3202, an authentication key issuing unit 3203, a position information managing unit 3204, a schedule managing unit 3205, a registration managing unit 3206, and a storage unit 3200 as described above.

When a request for provision of an authentication key has been received from the delivery management server 50 via the communication processing unit 3201, the condition determining unit 3202 determines whether it is a normal request for provision of an authentication key. For example, the condition determining unit 3202 determines whether the received request is a normal request for provision of an authentication key based on service login information (such as a service login ID for a delivery site) included in the request for provision of an authentication key or predetermined authentication information (for example, an ID and a password) corresponding to the delivery management server 50.

When the condition determining unit 3202 determines that the received request is a normal request for provision of an authentication key, the authentication key issuing unit 3203 issues an authentication key corresponding to the request for provision of an authentication key and transmits the authentication key to the mobile terminal 20Ac of the deliverer.

Specifically, the authentication key issuing unit 3203 specifies a vehicle 10A corresponding to the request for provision of an authentication key based on the user and service registration information DB in the storage unit 3200. The authentication key issuing unit 3203 issues an authentication key with a limited authority in which a valid period is limited (for example, valid for a unit of several minutes to several tens of minutes after transmission), a use frequency is limited (for example, the use frequency is one time), and only a trunk lid can be locked or unlocked. Accordingly, it is possible to prevent use of a vehicle 10A by a deliverer without permission and to improve security. The authentication key issuing unit 3203 transmits the authentication key to the mobile terminal 20Ac of the deliverer which is specified in the request for provision of an authentication key via the communication processing unit 3201.

As a method of limiting a valid period or a use frequency of the authentication key or the like, for example, an arbitrary method such as an existing mathematical method or a method using bidirectional communication between the central server 30 and the vehicle 10 may be employed.

The position information managing unit 3204 acquires position information from the vehicle 10A via the communication processing unit 3201 and provides (transmits) the acquired position information to the delivery management server 50 via the communication processing unit 3201 as described above in response to an inquiry about the current position of the vehicle 10A from the delivery management server 50 which is received by the communication processing unit 3201.

The schedule managing unit 3205 returns newest vehicle use schedule information stored in the storage unit 3200 to the EC server 60 via the communication processing unit 3201, for example, in response to an inquiry which is received from the EC server 60 by the communication processing unit 3201.

The registration managing unit 3206 registers a regular user (a subsidiary user) who uses various services including the trunk delivery service in response to a user registration request which is received from the mobile terminal 20Aa of an owner user by the communication processing unit 3201 as described above. As described above, the registration managing unit 3206 registers use of the trunk delivery service by the regular user of the vehicle 10A in response to a service use registration request which is received from the mobile terminal 20Aa of the owner user by the communication processing unit 3201. When registration of use of various services including the trunk delivery service has been completed as described above, the registration managing unit 3206 notifies the mobile terminals 20Aa or 20Ab corresponding to the regular user to be registered of the notification via the communication processing unit 3201. When registration of use of the trunk delivery service has been completed, the registration managing unit 3206 transmits a service use registration completion notification including service link information to the delivery management server 50 and the EC server 60 that perform operation and management of a service to be registered via the communication processing unit 3201.

The processing device 23 of the mobile terminal 20Ac of a deliverer includes a communication processing unit 2301, a communication processing unit 2302, an authentication key acquiring unit 2303, an authentication requesting unit 2304, and a locking/unlocking requesting unit 2305 as described above.

In this embodiment, it is assumed that the functions of the authentication key acquiring unit 2303, the authentication requesting unit 2304, and the locking/unlocking requesting unit 2305 of the mobile terminal 20Ac can be used by a deliverer when the key application is started.

The authentication key acquiring unit 2303 transmits a request for acquisition of an authentication key to the delivery management server 50 via the communication processing unit 2302 in response to a predetermined operation by the deliverer. At this time, the request for acquisition of an authentication key includes the above-mentioned delivery luggage information stored in advance in the storage unit 2300. Accordingly, the delivery management server 50 transmits a request for provision of an authentication key to the central server 30 in response to the request for acquisition of an authentication key, the central server 30 transmits an authentication key to the mobile terminal 20Ac in response to the request for provision of an authentication key, and the mobile terminal 20Ac can acquire the authentication key. Accordingly, the mobile terminal 20Ac can lock and unlock the trunk lid of the vehicle 10A based on the functions of the communication processing unit 2301, the authentication requesting unit 2304, and the locking/unlocking requesting unit 2305. Accordingly, the deliverer can deliver the requested luggage to the trunk of the vehicle 10A, lock the trunk of the vehicle 10A to the original state, and then go back.

[Details of Configuration of C2C Carsharing Service]

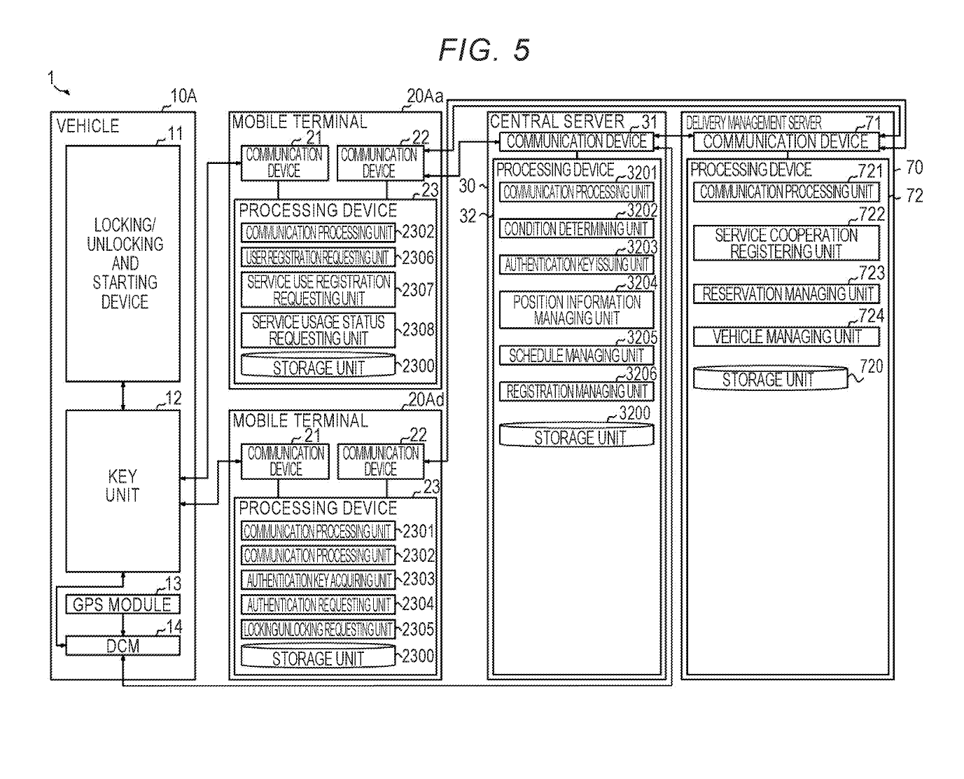

A configuration of a C2C carsharing service in the authentication key management system 1 will be described below with reference to FIG. 5.

FIG. 5 is a diagram illustrating an example of a configuration of a C2C carsharing service in the authentication key management system 1. In the following description, the configuration of the C2C carsharing service in the authentication key management system 1 will be described with reference to FIG. 5, and description of a configuration overlapping the configuration associated with the key sharing service will be minimized.

The processing device 23 of a mobile terminal 20Aa which is carried by an owner user of a vehicle 10A includes a communication processing unit 2302, a user registration requesting unit 2306, a service use registration requesting unit 2307, and a service usage status requesting unit 2308 as described above.

The user registration requesting unit 2306 requests the central server 30 to register a regular user (a subsidiary user) of the vehicle 10A who uses various services including a C2C carsharing service in response to a predetermined operation by the owner user as described above.

The service use registration requesting unit 2307 requests the central server 30 to register use of various services including the C2C carsharing service for each registered regular user (the owner user or the subsidiary user) in response to a predetermined operation by the owner user as described above.

For example, the service use registration requesting unit 2307 transmits a service use registration request for using the C2C carsharing service, which includes a service login ID for a web site (hereinafter, referred to as “C2C carsharing site”) for a user using the C2C carsharing service corresponding to the C2C carsharing management server 70 and corresponding to the regular user of the vehicle 10A to be registered as service link information, to the central server 30.

The service usage status requesting unit 2308 requests the central server 30 to transmit information on usage statuses of various services (service usage status information) including the C2C carsharing service used by the regular user of the vehicle 10A of which use has been registered in correlation with the owner user ID in response to a predetermined operation by the owner user as described above.

The C2C carsharing management server 70 includes a communication device 71 and a processing device 72.

The communication device 71 is an arbitrary device that performs bidirectional communication with a mobile terminal 20 and the central server 30 via a predetermined communication network.

The processing device 72 includes, for example, a communication processing unit 721, a service cooperation registering unit 722, a reservation managing unit 723, and a vehicle managing unit 724 as functional units which are embodied by causing the CPU to execute, for example, one or more programs stored in the ROM or the auxiliary storage device. The processing device 72 includes a storage unit 720 which is embodied as a storage area of an auxiliary storage device of a server computer or the like.

In the following description, it is assumed that information for specifying a vehicle 10A to be rented has been already stored (registered) in the storage unit 720 in correlation with a service login ID via a C2C carsharing site by a regular user (an owner user) of the vehicle 10A. The same is true of information on a rental type of a vehicle 10A to be lent.

The communication processing unit 721 controls the communication device 71 and transmits and receives various signals such as a control signal and an information signal to and from the mobile terminal 20 and the central server 30.

The service cooperation registering unit 722 registers information for cooperation between the central server 30 and the C2C carsharing management server 70 in use of the C2C carsharing service by a regular user of the vehicle 10A in response to a service use registration completion notification which is received from the central server 30 by the communication processing unit 721.

For example, the service cooperation registering unit 722 adds a flag indicating a lender of a vehicle 10A in the C2C carsharing service to the service login ID included in the service use registration completion notification in the user management DB that manages users of the C2C carsharing site constructed in the storage unit 720. Accordingly, by transmitting a request for provision of an authentication key including the service login ID corresponding to the regular user of the vehicle 10A who is a lender to the central server 30, the C2C carsharing management server 70 can transmit an authentication key from the central server 30 to a mobile terminal 20Ad of a renter as will be described later.

The reservation managing unit 723 manages a reservation of use of a vehicle 10A which is performed via the C2C carsharing site or the like.

For example, the reservation managing unit 723 receives registration of a rentable date and time and a rental type (specifically, a normal rental type, a trunk-sharing rental type, or both rental types) of a vehicle 10A from a regular user of the vehicle 10A via the C2C carsharing site, and stores (registers) the received rentable date and time and the received rental type of the vehicle 10A in the storage unit 720. At this time, the reservation managing unit 723 inquires of the central server 30 about vehicle use schedule information via the communication processing unit 721. Accordingly, the reservation managing unit 723 can acquire newest vehicle use schedule information via the communication processing unit 721. Accordingly, for example, when the rentable date and time received from the regular user of the vehicle 10A overlaps another schedule, the C2C carsharing management server 70 can take measures such as requesting change of the rentable date and time or registering the schedule in which the overlapping part is removed from the received rentable date and time as a rentable date and time.

For example, the reservation managing unit 723 receives a reservation for use of the vehicle 10A from a user as a renter (hereinafter referred to as a “renter user” for the purpose of convenience) within the range of the rental type and the rentable date and time of the vehicle 10A which are stored in the storage unit 720. When the reservation for use of the vehicle 10A has been received from the renter user via the C2C carsharing site, the reservation managing unit 723 updates information on the rental schedule of the vehicle 10A (rental schedule information) stored in the storage unit 720. At this time, the reservation managing unit 723 transmits the updated rental schedule information to the central server 30 via the communication processing unit 721 as described above. Accordingly, the central server 30 can update the vehicle use schedule information of the vehicle 10A which is rented in the C2C carsharing service to a newest state.

For example, when a request for acquisition of an authentication key has been received from a mobile terminal 20Ad of a renter of the vehicle 10A by the communication processing unit 721, the reservation managing unit 723 determines whether it is a normal request for acquisition of an authentication key. Specifically, the reservation managing unit 723 may perform the determination based on a service login ID and a password for the C2C carsharing site or a relationship with a reserved use date and time (for example, whether it is within a range of a reserved use date and time or whether a predetermined time remains to a start date and time) included in the request for acquisition of an authentication key. When it is a normal request for acquisition of an authentication key, the reservation managing unit 723 transmits a request for provision of an authentication key to the central server 30 via the communication processing unit 721. At this time, the request for provision of an authentication key includes information for specifying the mobile terminal 20Ad of the renter of the vehicle 10A. The information for specifying a renter of the vehicle 10A may be, for example, an authentication ID (hereinafter referred to as a “renter ID” for the purpose of convenience) which is used for user authentication in the central server 30 in order for the renter of the vehicle 10A to use the function of the authentication key acquiring unit 2303 of the mobile terminal 20Ad. Accordingly, the mobile terminal 20Ad of the renter of the vehicle 10A can acquire an authentication key from the central server 30. The request for provision of an authentication key includes information on a rental type of the vehicle 10A. Accordingly, the central server 30 can change an authority of the authentication key, which is transmitted to the mobile terminal 20Ad of the renter, for a function of locking/unlocking or starting the vehicle 10A to correspond to the rental type of the vehicle 10A.

The vehicle managing unit 724 manages vehicles 10A which are rented.

For example, the vehicle managing unit 724 inquires of the central server 30 about current position information of a vehicle 10A via the communication processing unit 721 before a reserved use date and time of the vehicle 10A (for example, several tens of minutes to immediately before). The vehicle managing unit 724 acquires the current position information of the vehicle 10A which is returned from the central server 30 in response to the inquiry via the communication processing unit 721. Accordingly, the vehicle managing unit 724 can determine whether the vehicle 10A is returned to a designated place before the scheduled rental date and time (the reserved use date and time) of the vehicle 10A. Accordingly, when the vehicle 10A is not returned to the designated place, the C2C carsharing management server 70 can take measures such as warning the regular user who is a renter of the vehicle 10A to return to the designated place via an e-mail or a predetermined application (for example, a key application) cooperating with the C2C carsharing site and installed in mobile terminals 20Aa and 20Ab.

The processing device 32 of the central server 30 includes a communication processing unit 3201, a condition determining unit 3202, an authentication key issuing unit 3203, a position information managing unit 3204, a schedule managing unit 3205, a registration managing unit 3206, and a storage unit 3200 as described above.

When a request for provision of an authentication key has been received from the C2C carsharing management server 70 by the communication processing unit 3201, the condition determining unit 3202 determines whether the received request is a normal request for provision of an authentication key. For example, the condition determining unit 3202 determines whether the received request is a normal request for provision of an authentication key based on service link information (such as a service login ID for the C2C carsharing site) included in the request for provision of an authentication key or predetermined authentication information (for example, an ID and a password) corresponding to the C2C carsharing management server 70.

When the condition determining unit 3202 determines that the received request is a normal request for provision of an authentication key, the authentication key issuing unit 3203 specifies a vehicle 10A corresponding to the request for provision of an authentication key based on the user and service registration information DB of the storage unit 3200. The authentication key issuing unit 3203 issues an authentication key which is temporary (for example, which is available at the reserved use date and time of the vehicle 10A included in the request for provision of an authentication key and in a buffer period before and after). The authentication key issuing unit 3203 issues an authentication key with an authority for locking/unlocking or starting of the vehicle 10A to correspond to the rental type of the vehicle 10A which is specified in the request for provision of an authentication key. That is, in the case of a normal rental type, for example, the authentication key issuing unit 3203 may issue an authentication key with an authority to lock/unlock all the doors of the vehicle 10A and to start the vehicle 10A. On the other hand, in the case of a trunk sharing rental type, for example, the authentication key issuing unit 3203 may issue an authentication key with an authority to lock/unlock only the door for accessing the trunk of the vehicle 10A. Then, the authentication key issuing unit 3203 transmits the issued authentication key to the mobile terminal 20Ad of the renter of the vehicle 10A which is specified in the request for provision of an authentication key via the communication processing unit 3201.

The interior space which is rented in the trunk sharing rental type may include only a passenger compartment in which a driver seat and a passenger seat are provided, not include the trunk of the vehicle 10A. In this case, the authentication key issuing unit 3203 issues an authentication key with an authority to lock/unlock only the boarding door of the vehicle 10A. The interior space which is rented in the trunk sharing rental type may be the whole interior space including both the trunk and the passenger compartment of the vehicle 10A. In this case, the authentication key issuing unit 3203 issues an authentication key with an authority to lock/unlock all the doors of the vehicle 10A (that is, both the boarding door and the door for accessing the trunk). In the following description, the same is true of an authentication key which is issued to use a vehicle 10B in the case of a trunk rental type of a B2C carsharing service.

The position information managing unit 3204 transmits a position information request to the vehicle 10A via the communication processing unit 3201 in response to an inquiry about a current position of a vehicle 10A which is received from the C2C carsharing management server 70 by the communication processing unit 3201. Accordingly, the position information managing unit 3204 can acquire the current position information from the vehicle 10A via the communication processing unit 3201. Then, the position information managing unit 3204 returns the current position information acquired from the vehicle 10A to the C2C carsharing management server 70 via the communication processing unit 3201.

The schedule managing unit 3205 transmits newest vehicle use schedule information to the vehicle 10A via the communication processing unit 3201 in response to the inquiry about the current position of the vehicle 10A which is received from the C2C carsharing management server 70 by the communication processing unit 3201.

The registration managing unit 3206 registers a regular user (a subsidiary user) who uses various services including the C2C carsharing service in response to a user registration request which is received from a mobile terminal 20Aa of an owner user by the communication processing unit 3201 as described above. As described above, the registration managing unit 3206 registers use of the C2C carsharing service by the regular user of the vehicle 10A in response to a service use registration request which is received from the mobile terminal 20Aa of the owner user by the communication processing unit 3201. When registration of use of various services including the C2C carsharing service has been completed as described above, the registration managing unit 3206 notifies the mobile terminal 20Aa or 20Ab corresponding to the regular user to be registered of the notification via the communication processing unit 3201. When registration of use of the C2C carsharing service has been completed, the registration managing unit 3206 transmits a service use registration completion notification including service link information to the delivery management server 50 that performs operation and management of a service to be registered.

The processing device 23 of the mobile terminal 20Ad of a renter of the vehicle 10A includes a communication processing unit 2301, a communication processing unit 2302, an authentication key acquiring unit 2303, an authentication requesting unit 2304, a locking/unlocking requesting unit 2305, and a storage unit 2300 as described above.

The authentication key acquiring unit 2303 transmits a request for acquisition of an authentication key to the C2C carsharing management server 70 via the communication processing unit 2302 in response to a predetermined operation by the renter of the vehicle 10A. At this time, the request for acquisition of an authentication key includes a service login ID for the C2C carsharing site corresponding to the renter of the vehicle 10A. Accordingly, the C2C carsharing management server 70 transmits a request for provision of an authentication key to the central server 30 in response to the request for acquisition of an authentication key, the central server 30 transmits an authentication key to the mobile terminal 20Ad in response to the request for provision of an authentication key, and the mobile terminal 20Ad can acquire the authentication key. Accordingly, the mobile terminal 20Ad of the renter can lock and unlock the door of the vehicle 10A (only the door for accessing the trunk in the case of the trunk sharing rental type) based on the functions of the communication processing unit 2301, the authentication requesting unit 2304, and the locking/unlocking requesting unit 2305 regardless of the rental type of the vehicle 10A. In the case of the normal rental type, the mobile terminal 20Ad of the renter can start the vehicle 10A based on the functions of the communication processing unit 2301, the authentication requesting unit 2304, and the locking/unlocking requesting unit 2305. That is, the renter of the vehicle 10A who carries the mobile terminal 20Ad can directly use the vehicle 10A such as locking and unlocking the vehicle 10A or driving the vehicle 10A using the mobile terminal 20Ad without transferring a key between regular users of the vehicle 10A by the C2C carsharing service. Similarly, a regular user of the vehicle 10A can rent the vehicle 10A to a person other than the regular user without transferring a key. Accordingly, with the C2C carsharing service in the authentication key management system 1, it is possible to improve convenience in rental of a vehicle 10A between a regular user of the vehicle 10A and a user other than the regular user.

[Details of Configuration of B2C Carsharing Service]

A configuration of a B2C carsharing service in the authentication key management system 1 will be described below with reference to FIG. 6.

FIG. 6 is a diagram illustrating an example of a configuration of a B2C carsharing service in the authentication key management system 1. In the following description, the configuration of the B2C carsharing service in the authentication key management system 1 will be described with reference to FIG. 6, and description of a configuration overlapping the configuration associated with the key sharing service will be minimized.

The B2C carsharing management server 80 includes a communication device 81 and a processing device 82.

The communication device 81 is an arbitrary device that performs bidirectional communication with a mobile terminal 20B and the central server 30 via a predetermined communication network.

The processing device 82 includes, for example, a communication processing unit 821, a reservation managing unit 822, and a vehicle managing unit 823 as functional units which are embodied by causing the CPU to execute, for example, one or more programs stored in the ROM or the auxiliary storage device. The processing device 82 includes a storage unit 820 which is embodied as a storage area of an auxiliary storage device of a server computer or the like.

The communication processing unit 821 controls the communication device 81 and transmits and receives various signals such as a control signal and an information signal with the mobile terminal 20B and the central server 30.

The reservation managing unit 822 manages a reservation for use of a vehicle 10B which is performed via a web site which is operated by a provider of the B2C carsharing management server 80 (hereinafter referred to as a “B2C carsharing site” for the purpose of convenience) or the like.

For example, the reservation managing unit 822 receives a reservation for use of the vehicle 10B from a user who wants to rent the vehicle 10B (hereinafter referred to as a “renter user” for the purpose of convenience) via the B2C carsharing site. Then, the reservation managing unit 822 stores information on the received reservation for use of the vehicle 10B (use reservation information) in the storage unit 820. At this time, the use reservation information includes information for specifying the vehicle 10B which is a target vehicle, information on a reserved use date and time (a start date and time and an end date and time), information on a rental type of the vehicle 10B (specifically, information of whether it is a normal rental type or a trunk sharing rental type), and a service login ID of the renter user in the B2C carsharing site.

For example, the reservation managing unit 822 updates information on a use schedule of a vehicle 10B (vehicle use schedule information) stored in the storage unit 820 whenever a reservation for use of a vehicle 10B is received. Accordingly, the B2C carsharing management server 80 can display a use schedule of the vehicle 10B in the B2C carsharing site and present a date and time at which use can be reserved to the renter user.

For example, when a request for acquisition of an authentication key has been received from a mobile terminal 20B by the communication processing unit 821, the reservation managing unit 822 determines whether it is a normal request for acquisition of an authentication key. Specifically, the reservation managing unit 822 may perform the determination based on a service login ID and a password for the B2C carsharing site corresponding to the renter user or a relationship with a reserved use date and time (for example, whether it is within a range of a reserved use date and time or whether a predetermined time remains to a start date and time) which is included in the request for acquisition of an authentication key. When it is a normal request for acquisition of an authentication key, the reservation managing unit 822 transmits a request for provision of an authentication key to the central server 30 via the communication processing unit 821. At this time, the request for provision of an authentication key includes information for specifying the mobile terminal 20B of the renter user who rents the vehicle 10B. The information for specifying a renter user who rents the vehicle 10B may be, for example, an authentication ID (hereinafter referred to as a “renter user ID” for the purpose of convenience) which is used for user authentication in the central server 30 in order for the renter user who rents the vehicle 10B to use the function of the key application corresponding to the authentication key acquiring unit 2303 of the mobile terminal 20B. Accordingly, the mobile terminal 20B of the renter user who rents the vehicle 10B can acquire an authentication key from the central server 30. The request for provision of an authentication key includes information on a rental type of the vehicle 10B. Accordingly, the central server 30 can change an authority of the authentication key, which is transmitted to the mobile terminal 20Ad of the renter, for a function of locking/unlocking or starting the vehicle 10B to correspond to the rental type of the vehicle 10B.

The vehicle managing unit 823 manages vehicles 10B which are rented.

For example, the vehicle managing unit 823 inquires of the central server 30 about a vehicle 10B which is parked around a place designated in the use reservation (for example, within several hundreds of meters) via the communication processing unit 821 before a reserved use date and time of the vehicle 10B of a certain renter user (for example, several tens of minutes). The vehicle managing unit 823 acquires position information of the vehicle 10B which is parked around the designated place and which is returned from the central server 30 in response to the inquiry via the communication processing unit 821. Accordingly, the vehicle managing unit 823 can specify one or more vehicles 10B parked around the designated place before the use start date and time of the vehicle 10B by the renter and determine which vehicle 10B is to be rented or the like.

For example, the vehicle managing unit 823 inquires of the central server 30 about position information of a vehicle 10B in a designated area via the communication processing unit 821 in response to a search request for a vehicle 10B in the area designated by a renter user in the B2C carsharing site. The vehicle managing unit 823 acquires position information of the vehicle 10B in the designated area which is returned from the central server 30 in response to the inquiry via the communication processing unit 821. Accordingly, the vehicle managing unit 823 can present the position information of a vehicle 10B to be rented to a renter user who wants to rent a vehicle 10B, for example, in the designated area in the B2C carsharing site.

The processing device 32 of the central server 30 includes a communication processing unit 3201, a condition determining unit 3202, an authentication key issuing unit 3203, and a storage unit 3200 as described above.

When a request for provision of an authentication key has been received from the B2C carsharing management server 80 by the communication processing unit 3201, the condition determining unit 3202 determines whether the received request is a normal request for provision of an authentication key. For example, the condition determining unit 3202 determines whether the received request is a normal request for provision of an authentication key based on information of whether the renter user ID included in the request for provision of an authentication key is an authentication ID registered in the storage unit 3200 or predetermined authentication information (for example, an ID and a password) corresponding to the B2C carsharing management server 80.

When the condition determining unit 3202 determines that the received request is a normal request for provision of an authentication key, the authentication key issuing unit 3203 issues an authentication key which is temporary (for example, which is available at the reserved use date and time of the vehicle 10B included in the request for provision of an authentication key and in a buffer period before and after). The authentication key issuing unit 3203 issues an authentication key with an authority for locking/unlocking or starting of the vehicle 10B to correspond to the rental type of the vehicle 10B which is specified in the request for provision of an authentication key. That is, in the case of a normal rental type, for example, the authentication key issuing unit 3203 may issue an authentication key with an authority to lock/unlock all the doors of the vehicle 10B and to start the vehicle 10B. On the other hand, in the case of a trunk sharing rental type, for example, the authentication key issuing unit 3203 may issue an authentication key with an authority to lock/unlock only the door for accessing the trunk of the vehicle 10B. Then, the authentication key issuing unit 3203 transmits the issued authentication key to the mobile terminal 20B of the renter user who rents the vehicle 10B specified in the request for provision of an authentication key via the communication processing unit 3201.

The processing device 23 of a mobile terminal 20B of a renter user who rents a vehicle 10B includes a communication processing unit 2301, a communication processing unit 2302, an authentication key acquiring unit 2303, an authentication requesting unit 2304, a locking/unlocking requesting unit 2305, and a storage unit 2300 as described above.

The authentication key acquiring unit 2303 transmits a request for acquisition of an authentication key to the B2C carsharing management server 80 via the communication processing unit 2302 in response to a predetermined operation by the renter user who rents the vehicle 10B. At this time, the request for acquisition of an authentication key includes a service login ID for the B2C carsharing site corresponding to the renter user who rents the vehicle 10B. Accordingly, the B2C carsharing management server 80 transmits a request for provision of an authentication key to the central server 30 in response to the request for acquisition of an authentication key, the central server 30 transmits an authentication key to the mobile terminal 20B in response to the request for provision of an authentication key, and the mobile terminal 20B can acquire the authentication key. Accordingly, the mobile terminal 20B of the renter can lock and unlock the door of the vehicle 10B (only the door for accessing the trunk in the case of the trunk sharing rental type) based on the functions of the communication processing unit 2301, the authentication requesting unit 2304, and the locking/unlocking requesting unit 2305 regardless of the rental type of the vehicle 10B. In the case of the normal rental type, the mobile terminal 20B of the renter can start the vehicle 10B based on the functions of the communication processing unit 2301, the authentication requesting unit 2304, and the locking/unlocking requesting unit 2305. That is, the renter user who rents the vehicle 10B and who carries the mobile terminal 20B can directly use the vehicle 10B such as locking and unlocking the vehicle 10B or driving the vehicle 10B using the mobile terminal 20B without exchanging a key with an owner user of the vehicle 10B by the B2C carsharing service. Accordingly, with the B2C carsharing service in the authentication key management system 1, it is possible to improve convenience for a renter user who rents a vehicle 10B.

[Details of Configuration of Renter-User Trunk Delivery Service]

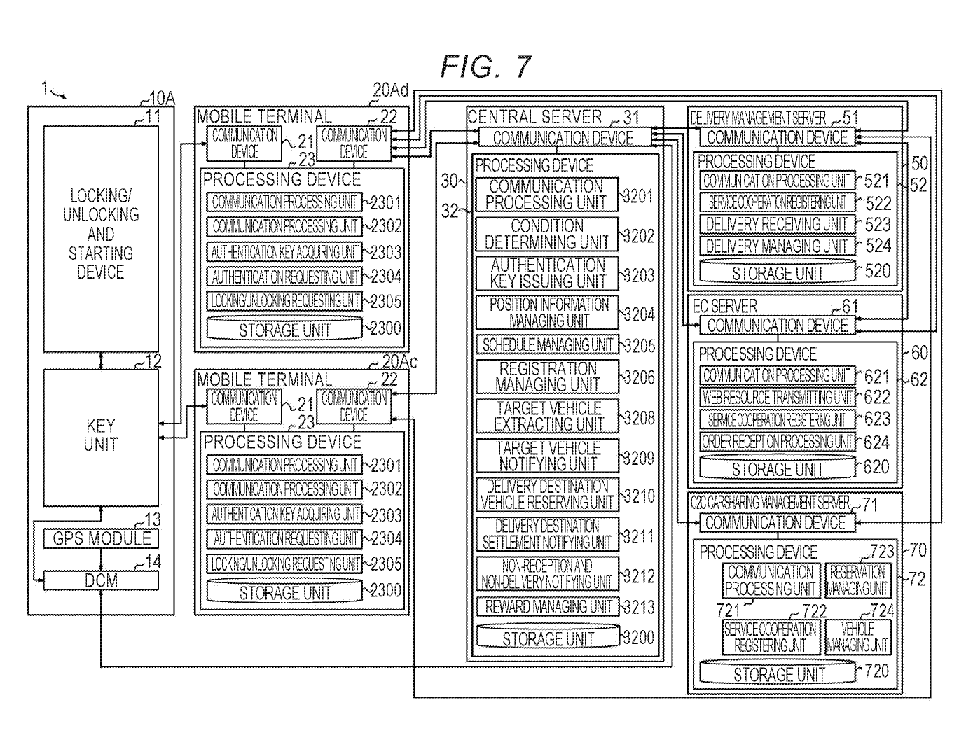

A configuration of a renter-user trunk delivery service in the authentication key management system 1 will be described below with reference to FIG. 7.

FIG. 7 is a diagram illustrating an example of a configuration of a renter-user trunk delivery service in the authentication key management system 1. Specifically, FIG. 7 is a diagram illustrating an example of a configuration associated with a renter-user trunk delivery service for a renter user who rents a vehicle 10A in the C2C carsharing service which is operated by the C2C carsharing management server 70. In the following description, the configuration of the trunk delivery service in the authentication key management system 1 will be described with reference to FIG. 7, and description of a configuration overlapping the configuration associated with the key sharing service will be minimized.

The configuration associated with the renter-user trunk delivery service for a renter user who rents a vehicle 10B which is rented in a trunk sharing rental type in the B2C carsharing service which is operated by the B2C carsharing management server 80 (an example of an information processing device) is embodied by replacing the vehicle 10A and the C2C carsharing management server 70 in FIG. 7 with a vehicle 10B and a B2C carsharing management server 80. The specific configurations of a vehicle 10B and the B2C carsharing management server 80 in the renter-user trunk delivery service for a renter user who rents the vehicle 10B are similar to the specific configurations of the vehicle 10A and the C2C carsharing management server 70 which will be described later and thus description thereof will not be repeated.

The delivery management server 50 that operates a renter-user trunk delivery service (an interior delivery service) includes a communication device 51 and a processing device 52 as described above.

The processing device 52 includes a communication processing unit 521, a service cooperation registering unit 522, a delivery receiving unit 523, a delivery managing unit 524 and a storage unit 520 as described above.

The service cooperation registering unit 522 registers information for cooperation between the delivery management server 50 and the EC server 60 associated with use of the renter-user trunk delivery service in which a product ordered (purchased) from the EC site by a renter user of a vehicle 10A which is rented in the C2C carsharing service is a delivery object.

For example, the service cooperation registering unit 522 registers (stores) a service login ID of a renter user for a delivery site which is registered in advance in the storage unit 520 in correlation with a service login ID for the EC site registered by the renter user via the delivery site. More specifically, the service cooperation registering unit 522 inquires of the EC server 60 about user confirmation via the communication processing unit 521 based on the service login ID and the password for the EC site registered by the renter user via the delivery site. Then, when an authentication success notification has been received from the EC server 60 by the communication processing unit 521, the service cooperation registering unit 522 registers (stores) in the storage unit 520, a service login ID for the delivery site in the storage unit 520 in correlation with the service login ID for the EC site registered by the renter user via the delivery site. Accordingly, when a delivery request based on reception of an order of a product including the service login ID for the EC site has been received from the EC server 60, the delivery management server 50 can specify the service login ID for the delivery site corresponding to a requester of the delivery request (an orderer of the product).

The service cooperation registering unit 522 registers information for cooperation between the delivery management server 50 and the C2C carsharing management server 70 associated with use of the renter-user trunk delivery service.

For example, the service cooperation registering unit 522 adds a flag indicating a use target of the renter-user trunk delivery service to the service login ID of a renter user for the delivery site which is registered in advance in the storage unit 520 based on the service login ID for the C2C carsharing site registered by the renter user via the delivery site. More specifically, the service cooperation registering unit 522 inquires of the C2C carsharing management server 70 about user confirmation via the communication processing unit 521 based on the service login ID and the password for the C2C site registered by the renter user via the delivery site. Then, when an authentication success notification has been received from the C2C carsharing management server 70 by the communication processing unit 521, the service cooperation registering unit 522 registers (stores) the service login ID for the delivery site in the storage unit 520 such that the service login ID is correlated with the service login ID for the C2C carsharing site registered by the renter user via the delivery site and a flag indicating a use target of the renter-user trunk delivery service is added thereto. Accordingly, for example, when information on a rental reservation of the vehicle 10A including the service login ID for the C2C carsharing site for specifying the renter user or the like has been received from the C2C carsharing management server 70, the delivery management server 50 can specify the service login ID for the delivery site corresponding to the renter of the vehicle 10A to be reserved for rental and ascertain whether the vehicle 10A is a use target of the renter-user trunk delivery service.

The delivery receiving unit 523 receives information on a delivery request for a product (luggage) ordered on the EC site (delivery request information) from the EC server 60 via the communication processing unit 521. The delivery request information which can be received from the EC server 60 includes information for specifying an orderer from users who are registered in advance in the storage unit 520 as a use target of the renter-user trunk delivery service (for example, a service login ID for the delivery site, the EC site, or the C2C carsharing site). The delivery request information includes basic information such as a name, an address, and a phone number of an orderer. The delivery request information includes information on a designated delivery destination (delivery destination information) and information on a designated delivery date and time (delivery date and time information). For example, when a trunk of a vehicle 10A which is rented in the trunk sharing rental type is designated as a delivery destination by the C2C carsharing service, the delivery destination information may include information indicating that a vehicle 10A corresponding to a delivery destination is rented in the trunk sharing rental type or information for specifying the vehicle 10A (for example, a vehicle ID).

The delivery managing unit 524 performs operation and management of all processes from request to delivery associated with a delivery request received by the delivery receiving unit 523. The specific operation of the delivery managing unit 524 in the renter-user trunk delivery service is the same as that in the regular-user trunk delivery service except that a destination of a delivery completion notification is changed from a regular user of the vehicle 10A to a renter of the vehicle 10A and thus description thereof will not be repeated.

The EC server 60 includes a communication device 61 and a processing device 62 as described above.

The processing device 62 includes a communication processing unit 621, a web resource transmitting unit 622, a service cooperation registering unit 623, an order reception processing unit 624, and a storage unit 620 as described above.

The service cooperation registering unit 623 registers information for cooperation between the delivery management server 50 and the EC server 60 associated with use of the renter-user trunk delivery service in which a product ordered (purchased) from the EC site by a renter user of a vehicle 10A which is rented in the C2C carsharing service is a delivery object.

For example, the service cooperation registering unit 623 registers (stores) a service login ID of a renter user for an EC site, which is registered in advance in the storage unit 620, in the storage unit 620 in correlation with a service login ID for a delivery site registered by the renter user via the EC site. More specifically, the service cooperation registering unit 623 inquires of the delivery management server 50 about user confirmation via the communication processing unit 621 based on the service login ID and the password for the EC site registered by the renter user via the EC site. Then, when an authentication success notification has been received from the delivery management server 50 by the communication processing unit 621, the service cooperation registering unit 623 registers (stores) a service login ID for the EC site in the storage unit 620 in correlation with the service login ID for the delivery site registered by the renter user via the EC site. Accordingly, for example, when an inquiry about an ordered product including the service login ID for the delivery site or the like has been received from the delivery management server 50, the EC server 60 can specify the corresponding service login ID for the EC site.

The service cooperation registering unit 623 registers information for cooperation between the EC server 60 and the C2C carsharing management server 70 associated with use of the renter-user trunk delivery service.

For example, the service cooperation registering unit 623 adds a flag indicating a use target of the renter-user trunk delivery service to the service login ID of a renter user for the EC site which is registered in advance in the storage unit 620 based on the service login ID for the C2C carsharing site registered by the renter user via the EC site. More specifically, the service cooperation registering unit 623 inquires of the C2C carsharing management server 70 about user confirmation via the communication processing unit 621 based on the service login ID and the password for the C2C site registered by the renter user via the EC site. Then, when an authentication success notification has been received from the C2C carsharing management server 70 by the communication processing unit 621, the service cooperation registering unit 623 registers (stores) the service login ID for the EC site in the storage unit 620 such that the service login ID is correlated with the service login ID for the C2C carsharing site registered by the renter user via the EC site and a flag indicating a use target of the renter-user trunk delivery service is added thereto. Accordingly, when a delivery request in which a trunk of a vehicle 10A rented in the C2C carsharing service is designated as a delivery destination by the renter user has been received, the EC server 60 can ascertain whether the renter user is a use target of the renter-user trunk delivery service based on the service login ID for the C2C carsharing site included in the delivery request.

The order reception processing unit 624 receives an order of a product from a user based on various operation inputs corresponding to the order of a product by a user in the EC site. At this time, when a trunk of a vehicle 10A which is rented in the C2C carsharing service is selected as a delivery destination in the order input page of the EC site, the order reception processing unit 624 acquires information of whether the vehicle 10A has been reserved and a reserved date and time from the central server 30 or the C2C carsharing management server 70 via the communication processing unit 621. Accordingly, the order reception processing unit 624 can determine whether the vehicle 10A corresponding to the delivery destination has been appropriately reserved and whether a designated delivery date and time is included in the reserved date and time. Accordingly, for example, when the designated vehicle 10A has not been appropriately reserved or when the designated delivery date and time is not included in the reserved date and time, the order reception processing unit 624 can take measures such as requesting the user for change of the delivery destination or change of the delivery date and time in the EC site.

As described above, a renter-user trunk delivery service for luggage other than an ordered product in the EC site can be assumed. In this case, similarly, the delivery management server 50 can acquire information of whether the vehicle 10A has been reserved and information on a reserved date and time from the central server 30 or the C2C carsharing management server 70. Accordingly, the delivery management server 50 can take the same measures as in the EC server 60 (the order reception processing unit 624).

The processing device 72 of the C2C carsharing management server 70 (an example of a carsharing operating device) that supports operation of the renter-user trunk delivery service includes a communication processing unit 721, a service cooperation registering unit 722, a reservation managing unit 723, a vehicle managing unit 724, and a storage unit 720 as described above.

The service cooperation registering unit 722 registers information for cooperation between the C2C carsharing management server 70 and the delivery management server 50 associated with use of the renter-user trunk delivery service.

For example, the service cooperation registering unit 722 registers (stores) a service login ID of a renter user for a C2C carsharing site, which is registered in advance in the storage unit 720, in the storage unit 720 in correlation with a service login ID for a delivery site which is registered by the renter user via the C2C carsharing site. More specifically, the service cooperation registering unit 722 inquires of the delivery management server 50 about user confirmation via the communication processing unit 721 based on the service login ID and the password for the delivery site which are registered by the renter user via the C2C carsharing site. Then, when an authentication success notification has been received from the delivery management server 50 by the communication processing unit 721, the service cooperation registering unit 722 registers (stores) a service login ID for the C2C carsharing site in the storage unit 720 such that the service login ID is correlated with the service login ID for the delivery site registered by the renter user via the C2C carsharing site and a flag indicating a use target of the renter-user trunk delivery service is added thereto. Accordingly, the C2C carsharing management server 70 can determine whether the renter user is a use target of the renter-user trunk delivery service based on the service login ID of the renter user. For example, when an inquiry including the service login ID of the renter user for the delivery site has been received from the delivery management server 50 by the communication processing unit 721, the C2C carsharing management server 70 can specify the service login ID of the corresponding renter user for the C2C carsharing site.

The service cooperation registering unit 722 registers information for cooperation between the C2C carsharing management server 70 and the EC server 60 associated with use of the renter-user trunk delivery service.

For example, the service cooperation registering unit 722 registers (stores) a service login ID of a renter user for a C2C carsharing site, which is registered in advance in the storage unit 720, in the storage unit 720 in correlation with a service login ID for an EC site which is registered by the renter user via the C2C carsharing site. More specifically, the service cooperation registering unit 722 inquires of the EC server 60 about user confirmation via the communication processing unit 721 based on the service login ID and the password for the C2C carsharing site which are registered by the renter user via the C2C carsharing site. Then, when an authentication success notification has been received from the EC server 60 by the communication processing unit 721, the service cooperation registering unit 722 registers (stores) a service login ID for the C2C carsharing site in the storage unit 720 in correlation with the service login ID for the EC site registered by the renter user via the C2C carsharing site. Accordingly, when an inquiry including the service login ID of the renter user for the delivery site has been received from the EC server 60 by the communication processing unit 721, the C2C carsharing management server 70 can specify the service login ID of the corresponding renter user for the C2C carsharing site.

Regarding information which is registered for cooperation between the delivery management server 50, the EC server 60, and the C2C carsharing management server 70, information registered in a certain server may be shared by the other servers. That is, for example, when service login IDs or the like for the delivery site and the EC site are registered by a renter user via the C2C carsharing site, the correlation between the service login IDs for the delivery site, the EC site, and the C2C carsharing site may be shared with the delivery management server 50 and the EC server 60 by the C2C carsharing management server 70. Accordingly, the renter user does not need to register information for cooperation therebetween in the sites, and thus it is possible to improve convenience for the renter user.

The reservation managing unit 723 manages a reservation for use of a vehicle 10A as described above.

For example, the reservation managing unit 723 (an example of a reservation receiving unit) receives a reservation for use of the vehicle 10A from a renter user within a range of the rental type and the rentable date and time of the vehicle 10A which are stored in the storage unit 720 in response to a reservation request from the renter user via the EC site which is received from the central server 30 by the communication processing unit 721. When the reservation for use of the vehicle 10A has been received from the renter user, the reservation managing unit 723 updates information on the rental schedule of the vehicle 10A (rental schedule information) stored in the storage unit 720. At this time, the reservation managing unit 723 transmits the updated rental schedule information to the central server 30 via the communication processing unit 721 as described above. Accordingly, the central server 30 can update the vehicle use schedule information of the vehicle 10A which is rented in the C2C carsharing service to a newest state.

For example, when a request for acquisition of an authentication key has been received from a mobile terminal 20Ad of a renter of a vehicle 10A by the communication processing unit 721, the reservation managing unit 723 (an example of a key information transmitting unit) determines whether it is a normal request for acquisition of an authentication key as described above. When it is a normal request for acquisition of an authentication key, the reservation managing unit 723 transmits a request for provision of an authentication key to the central server 30 via the communication processing unit 721.

The vehicle managing unit 724 manages vehicles 10A which are rented as described above.

The processing device 32 of the central server 30 (an example of an information processing device) that supports operation of the renter-user trunk delivery service (the interior delivery service) includes a communication processing unit 3201, a condition determining unit 3202, an authentication key issuing unit 3203, a position information managing unit 3204, a schedule managing unit 3205, and a storage unit 3200 as described above. The processing device 32 of the central server 30 includes, for example, a target vehicle extracting unit 3208, a target vehicle notifying unit 3209, a delivery destination vehicle reserving unit 3210, a delivery destination settlement notifying unit 3211, a non-reception and non-delivery notifying unit 3212, and a reward managing unit 3213 as functional units which are embodied by causing the CPU to execute, for example, one or more programs stored in the ROM or the auxiliary storage device.

When a request for provision of an authentication key has been received from the delivery management server 50 by the communication processing unit 3201 as described above, the condition determining unit 3202 determines whether the received request is a normal request for provision of an authentication key.

When a request for provision of an authentication key has been received from the C2C carsharing management server 70 by the communication processing unit 3201 as described above, the condition determining unit 3202 determines whether the received request is a normal request for provision of an authentication key.

When the condition determining unit 3202 determines that the request for provision of an authentication key received from the delivery management server 50 is a normal request for provision of an authentication key, the authentication key issuing unit 3203 (an example of a key information transmitting unit) issues an authentication key corresponding to the request for provision of an authentication key as described above and transmits the authentication key to a mobile terminal 20Ac of a deliverer.

When the condition determining unit 3202 determines that the request for provision of an authentication key received from the C2C carsharing management server 70 is a normal request for provision of an authentication key, the authentication key issuing unit 3203 issues an authentication key corresponding to the request for provision of an authentication key as described above and transmits the authentication key to a mobile terminal 20Ad of a renter of the vehicle 10A.

The position information managing unit 3204 acquires position information from the vehicle 10A in response to an inquiry about the current position of the vehicle 10A from the delivery management server 50 or the C2C carsharing management server 70 received by the communication processing unit 3201 as described above, and provides (transmits) the acquired position information to the delivery management server 50 or the C2C carsharing management server 70 via the communication processing unit 3201.

The schedule managing unit 3205 provides (returns) information (that is, corresponding to rental schedule information of the C2C carsharing management server 70) on a reservation state in the C2C carsharing service based on the newest vehicle use schedule information stored in the storage unit 3200 to the EC server 60 via the communication processing unit 3201, for example, in response to an inquiry which is received from the EC server 60 by the communication processing unit 3201.

When a delivery request of a product is issued by a renter user, the target vehicle extracting unit 3208 extracts a vehicle 10A (hereinafter referred to as a “target vehicle”) which can be used as a delivery destination of luggage (a product) corresponding to the delivery request from one or more vehicles 10A (hereinafter referred to as “candidate vehicles”) of which reservation is being received in the trunk sharing rental type in the C2C carsharing service. Specifically, the target vehicle extracting unit 3208 may extract the target vehicle when a variety of information on delivery of an ordered product is input by a renter user in an order input page of an EC site or on a screen (an order input screen) or a window (an order input window) corresponding to an order input page of a predetermined application (hereinafter referred to as an “EC application”) which is installed in a terminal of the renter user (for example, a mobile terminal 20Ad) and which cooperates with the EC site. Hereinafter, the EC site or the EC application is referred to as an “EC site or the like” for the purpose of convenience, and the order input page, the order input screen, or the order input window is referred to as an “order input screen or the like” for the purpose of convenience. The target vehicle extracting unit 3208 may extract the target vehicle when a product which is an order candidate is put into a virtual cart in a page (hereinafter referred to as a “product page”), a screen (hereinafter referred to as a “product screen”), or a window (hereinafter referred to as a “product window”) for inquiring about products in the EC site or the like.

At this time, the target vehicle extracting unit 3208 may ascertain that a delivery request of a product has been issued by the renter user based on a predetermined notification which is received from the EC server 60 corresponding to the EC site by the communication processing unit 3201. The target vehicle extracting unit 3208 may ascertain that a delivery request of a product has been issued by the renter user by using an API that calls the function of the central server 30 via the communication processing unit 3201, for example, based on an API link which is embedded in an input part of a variety of information on delivery in the order input page or the like such of the EC site or the like. The target vehicle extracting unit 3208 can ascertain one or more candidate vehicles of which reservation is being received in the trunk sharing rental type at that time based on newest rental schedule information which is received from the C2C carsharing management server 70 by the communication processing unit 3201.

For example, the target vehicle extracting unit 3208 extracts a target vehicle that satisfies conditions associated with a parking place corresponding to a request from the renter user or the like from a plurality of candidate vehicles. Specifically, the target vehicle extracting unit 3208 extracts target vehicles of which the parking place at the time of rental is within a predetermined range (for example, 500 meters or less) from a designated position designated by the renter user in the delivery request (that is, a delivery place which is desired by the renter user). Accordingly, the central server 30 can extract target vehicles of which a reservation for rental is being received and which are parked around the delivery place desired by the renter user. The target vehicle extracting unit 3208 may extract vehicles 10A within a predetermined range from the current position of the renter user which is specified by a position detecting function (for example, a GPS function built in a mobile terminal 20Ad) of a terminal (for example, a mobile terminal 20Ad) through which the renter user uses the EC site as target vehicles from a plurality of candidate vehicles. Accordingly, the central server 30 can extract target vehicles of which a reservation for rental is being received and which are parked around the current position of the renter user.

For example, the target vehicle extracting unit 3208 extracts target vehicles that satisfy conditions associated with a rentable period corresponding to a request from the renter user from a plurality of candidate vehicles. Specifically, the target vehicle extracting unit 3208 extracts target vehicles of which a designated delivery date and time designated by the renter user in the delivery request is included in the rentable period from a plurality of candidate vehicles. Accordingly, the target vehicle extracting unit 3208 can extract target vehicles of which a reservation for rental is being received and which is available as a delivery destination of a product at the designated delivery date and time.

For example, the target vehicle extracting unit 3208 extracts target vehicle which satisfy both of the conditions associated with the parking place and information associated with the rentable period.

The target vehicle notifying unit 3209 notifies the renter user who issues a delivery request of a product in the EC site or the like of the target vehicles extracted by the target vehicle extracting unit 3208.

For example, the target vehicle notifying unit 3209 may transmit a notification including the extracted target vehicles to a predetermined terminal of the renter user via the communication processing unit 3201 by a push notification method (for example, using a push notification function of a key application installed in the mobile terminal 20Ad). The target vehicle notifying unit 3209 may transmit a notification including the extracted target vehicles to an e-mail address or an account of a predetermined SNS of the renter user which is registered in the storage unit 3200. In the following description, the same is true of a specific destination of various notifications which are transmitted to the renter user which will be described later. The notifications may include link information based on a URL scheme for reserving target vehicles (for example, an API link for calling the function of the delivery destination vehicle reserving unit 3210 which will be described later or a URL link for displaying a C2C carsharing site in a predetermined browser). Accordingly, the renter user can select one vehicle 10A which is suitable for the renter user's desire from the notified target vehicles and reserve the selected vehicle 10A as a vehicle 10A corresponding to a delivery destination (hereinafter referred to as a “delivery destination vehicle”) using the link information corresponding to the selected vehicle 10A. Accordingly, the renter user can designate a trunk of the reserved delivery destination vehicle as a delivery destination in the EC site or the like and request delivery of a product.

For example, the target vehicle notifying unit 3209 may notify the renter user of the extracted target vehicles in the order input page or the like of the EC site or the like. Accordingly, the renter user can ascertain the target vehicles in the EC site or the EC application. Accordingly, the central server 30 can improve convenience for the renter user.

Specifically, the target vehicle notifying unit 3209 may transmit a display request including the extracted target vehicles to the EC server 60 via the communication processing unit 3201 and display information on the extracted target vehicles in the order input page or the like in which the renter user requests delivery via the EC site 60. The target vehicle notifying unit 3209 may directly display information on the extracted target vehicles in the order input page or the like via the API link. Accordingly, the central server 30 does not transmit the extracted target vehicles to the EC site but can directly display the extracted target vehicles in the EC site or the EC application. Accordingly, the central server 30 can prevent information on a vehicle 10A owned by an individual person and extracted as the target vehicle (specifically, information indicating that the vehicle 10A is rented in the trunk sharing rental type in the C2C carsharing service) from being unnecessarily disclosed to the EC server 60, and can consider the privacy of a regular user of the vehicle 10A.

When the extracted target vehicles are displayed in the EC site or the like, the target vehicle notifying unit 3209 may display a map image and overlap the extracted target vehicles on the map image to correspond to the parking places at the time of rental. Accordingly, the renter user can easily ascertain geometrical positions of the target vehicles and thus easily detect a vehicle 10A which is more suitable as a delivery destination. Accordingly, the central server 30 can improve convenience for the renter user.

As described above, a target of the delivery request may be luggage other than a product in the EC site. In this case, the central server 30 can display the extracted target vehicles in a web site, that is, a delivery site, in which delivery is requested or a screen or a window of a predetermined application which is installed in a terminal of the renter user. The same is true of a display destination such as a reservation screen or a popup window which will be described later.

The delivery destination vehicle reserving unit 3210 (an example of a vehicle reserving unit) reserves the vehicle 10A (a delivery destination vehicle) which is selected as the delivery destination vehicle by the renter user from the target vehicles notified to the renter user by the target vehicle notifying unit 3209.

For example, the delivery destination vehicle reserving unit 3210 reserves the delivery destination vehicle which is selected by the renter user in accordance with a call based on the API link included in the notification transmitted to a predetermined terminal or the like of the renter user. Specifically, the delivery destination vehicle reserving unit 3210 displays a reservation screen or a reservation window corresponding to the key application or the like which is installed in the mobile terminal 20Ad of the renter user on the display 24, for example, via the communication processing unit 3201. Then, the delivery destination vehicle reserving unit 3210 transmits a reservation request including information on a reserved date and time (for example, a use start time and a use end time) input through the reservation screen or the like to the C2C carsharing management server 70 via the communication processing unit 3201 in response to a predetermined operation by the renter user. Accordingly, the C2C carsharing management server 70 can reserve the vehicle 10A corresponding to the reservation request with a reserved date and time desired by the renter user designated.

For example, the delivery destination vehicle reserving unit 3210 reserves the delivery destination vehicle selected from the target vehicles displayed in the EC site or the like in response to the renter user's operation on a used terminal (for example, the mobile terminal 20Ad). Specifically, when one vehicle 10A is selected in response to the renter user's operation on the used terminal (for example, when a position on the display 24 corresponding to the one vehicle 10A among the target vehicles displayed to overlap the map image is touched), the delivery destination vehicle reserving unit 3210 displays a popup window or the like for inputting information on the reserved date and time via the API link of the order input page or the like. Then, the delivery destination vehicle reserving unit 3210 transmits a reservation request including information on the reserved date and time which has been input to the popup window or the like to the C2C carsharing management server 70 via the communication processing unit 3201 in response to the renter user's operation on the used terminal. Accordingly, similarly, the C2C carsharing management server 70 can reserve the vehicle 10A corresponding to the reservation request with the reserved date and time desired by the renter user designated.

When the reservation of the vehicle 10A (the delivery destination vehicle) has been completed based on the reservation request from the C2C carsharing management server 70 via the communication processing unit 3201, the delivery destination settlement notifying unit 3211 transmits a notification indicating that the reservation of the selected delivery destination vehicle has been completed and the delivery destination has been settled (a delivery destination settlement notification) to the renter user.

When the reservation of the vehicle 10A (the delivery destination vehicle) has been completed based on the reservation request from the C2C carsharing management server 70 via the communication processing unit 3201, the delivery destination settlement notifying unit 3211 transmit the same delivery destination settlement notification to the EC server 60.

As described above, a target of the delivery request may be luggage other than a product in the EC site. In this case, the central server 30 transmits the delivery destination settlement notification to the delivery management server 50.

When a predetermined time (for example, one hour) remains until the end of the rental period (the use end date and time) of the vehicle 10A (the delivery destination vehicle) rented to the renter user but delivered luggage has not been received from the trunk of the vehicle 10A by the renter user, the non-reception and non-delivery notifying unit 3212 (an example of a non-reception notifying unit) transmits a non-reception notification indicating that reception of luggage has not been completed to the renter user. Accordingly, the central server 30 can prompt the renter user to receive the delivered luggage. At this time, for example, when the trunk of the vehicle 10A is unlocked and locked in accordance with an unlocking request and a locking request transmitted from a mobile terminal 20Ac of a deliverer to the vehicle 10A, the central server 30 can ascertain completion of delivery of target luggage based on a notification acquired from the vehicle 10A. For example, when the trunk of the vehicle 10A is unlocked in accordance with an unlocking request transmitted from the mobile terminal 20Ad of the renter user to the vehicle 10A after the target luggage has been delivered, the central server 30 can ascertain completion of reception of the target luggage based on a notification acquired from the vehicle 10A.

When a predetermined time (for example, one hour) remains until the end of the rental period (the use end date and time) of the vehicle 10A (the delivery destination vehicle) rented to the renter user but delivery of luggage to the trunk of the vehicle 10A has not been completed, the non-reception and non-delivery notifying unit 3212 transmits a non-reception notification indicating that delivery of target luggage has not been completed to the delivery management server 50 via the communication processing unit 3201. Accordingly, the central server 30 can cause a delivery company to recognize that target luggage has not been delivered to the trunk of the vehicle 10A and to take measures (for example, causing a deliverer to move to the vehicle 10A in the rental period). At this time, for example, when the trunk of the vehicle 10A is unlocked and locked in accordance with an unlocking request and a locking request transmitted from a mobile terminal 20Ac of a deliverer to the vehicle 10A, the central server 30 can ascertain completion of delivery of target luggage based on a notification acquired from the vehicle 10A.

The non-reception and non-delivery notifying unit 3212 may transmit a non-reception notification or a non-delivery notification when the rental period of the delivery destination vehicle has expired, not before the rental period of the delivery destination vehicle has expired (that is, when a predetermined time remains up to the expiration).

When a vehicle 10A is rented in the trunk sharing rental type in the C2C carsharing service, the reward managing unit 3213 (an example of a reward giving unit) gives a predetermined reward to a lender (that is, a regular user of the vehicle 10A). The reward includes a predetermined article or cash which is provided to the lender later. The reward includes a point which can be exchanged with a predetermined article, cash, virtual currency, or another point and which is managed in a web or the like. The reward managing unit 3213 stores reward information corresponding to the reward given to regular users who are lenders of a plurality of vehicles 10A provided for the C2C carsharing service in the storage unit 3200 in correlation with identification information corresponding to the lenders.

Specifically, when a vehicle e 10A is rented to a renter user in the trunk sharing rental type, the reward managing unit 3213 may manage reward information of lenders such that the reward information, which is stored in the storage unit 320, corresponding to the provider (the lender) of the vehicle 10A is updated to reward information having new addition. When a vehicle e 10A is rented to a renter user in the trunk sharing rental type and is used as a delivery destination of luggage in the renter-user trunk delivery service, the reward managing unit 3213 may manage reward information of lenders such that the reward information, which is stored in the storage unit 3200, corresponding to the provider of the vehicle 10A is updated to reward information having new addition. Accordingly, since a regular user of the vehicle 10A acquires an incentive for rental of the vehicle 10A as a delivery destination in the renter-user trunk delivery service in the trunk sharing rental type, it is possible to increase the number of vehicles 10A which are rented in the trunk sharing rental type. Accordingly, a renter user can easily select a vehicle 10A as a delivery destination and thus the central server 30 can promote use of the renter-user trunk delivery service.

A provider (a regular user) of a vehicle 10A can check reward information or perform a procedure of exchanging with a predetermined article or the like, for example, by accessing a predetermined web site using a browser of a predetermined terminal and performing login based on a login ID and a password which are defined in advance.

Some or all of various functions of the central server 30 associated with the renter-user trunk delivery service, that is, the functions of the condition determining unit 3202, the authentication key issuing unit 3203, the position information managing unit 3204, the schedule managing unit 3205, the target vehicle extracting unit 3208, the target vehicle notifying unit 3209, the delivery destination vehicle reserving unit 3210, the delivery destination settlement notifying unit 3211, the non-reception and non-delivery notifying unit 3212, and the reward managing unit 3213, may be transferred to the delivery management server 50 corresponding to an actual delivery operation, the EC server 60 corresponding to an EC site or the like in which delivery is requested by a renter user, or a C2C carsharing management server 70 that supports rental of a vehicle 10A in the trunk sharing rental type.

For example, some or all of the functions of the target vehicle extracting unit 3208, the target vehicle notifying unit 3209, the delivery destination vehicle reserving unit 3210, the delivery destination settlement notifying unit 3211, the non-reception and non-delivery notifying unit 3212, and the reward managing unit 3213 may be transferred to the EC server 60 (an example of an information processing device).

For example, in the case of the renter-user trunk delivery service in which luggage other than a product which is ordered on the EC site is a delivery target, some or all of the functions of the target vehicle extracting unit 3208, the target vehicle notifying unit 3209, the delivery destination vehicle reserving unit 3210, the delivery destination settlement notifying unit 3211, the non-reception and non-delivery notifying unit 3212, and the reward managing unit 3213 may be transferred to the delivery management server 50 (an example of an information processing device).

For example, some or all of the functions of the condition determining unit 3202, the authentication key issuing unit 3203, the position information managing unit 3204, the schedule managing unit 3205, the target vehicle extracting unit 3208, the target vehicle notifying unit 3209, the delivery destination vehicle reserving unit 3210, the delivery destination settlement notifying unit 3211, the non-reception and non-delivery notifying unit 3212, and the reward managing unit 3213 may be transferred to the C2C carsharing management server 70 (an example of an information processing device).

The processing device 23 of a mobile terminal 20Ac of a deliverer includes the communication processing unit 2301, the communication processing unit 2302, the authentication key acquiring unit 2303, the authentication requesting unit 2304, and the locking/unlocking requesting unit 2305 as described above.

The authentication key acquiring unit 2303 transmits a request for acquisition of an authentication key to the delivery management server 50 via the communication processing unit 2302 in response to a predetermined operation by a deliverer as described above. The authentication key acquiring unit 2303 acquires an authentication key from the central server 30 via the communication processing unit 2302. Accordingly, a mobile terminal 20Ac can lock and unlock a trunk lid of a vehicle 10A based on the functions of the communication processing unit 2301, the authentication requesting unit 2304, and the locking/unlocking requesting unit 2305. Accordingly, the deliverer can deliver the requested luggage to the trunk of the vehicle 10A, lock the trunk of the vehicle 10A to the original state, and then go back.

The processing device 23 of a mobile terminal 20Ad of a renter of a vehicle 10A (a delivery destination vehicle) includes the communication processing unit 2301, the communication processing unit 2302, the authentication key acquiring unit 2303, the authentication requesting unit 2304, the locking/unlocking requesting unit 2305, and the storage unit 2300 as described above.

The authentication key acquiring unit 2303 transmits a request for acquisition of an authentication key to the C2C carsharing management server 70 via the communication processing unit 2302 in response to a predetermined operation by a renter as described above. The authentication key acquiring unit 2303 acquires an authentication key, specifically, an authentication key with an authority to lock and unlock only a door for accessing the trunk, from the central server 30 via the communication processing unit 2301. Accordingly, a mobile terminal 20Ad can lock and unlock a trunk lid of the vehicle 10A based on the functions of the communication processing unit 2301, the authentication requesting unit 2304, and the locking/unlocking requesting unit 2305. Accordingly, the renter user who has designated the trunk of the vehicle 10A in the trunk sharing rental type as a delivery destination of luggage ordered on the EC site can unlock the trunk of the vehicle 10A using the mobile terminal 20Ad having received the authentication key and receive the luggage delivered to the trunk.

[Details of Operation of Authentication Key Management System Associated with Renter-User Trunk Delivery Service]

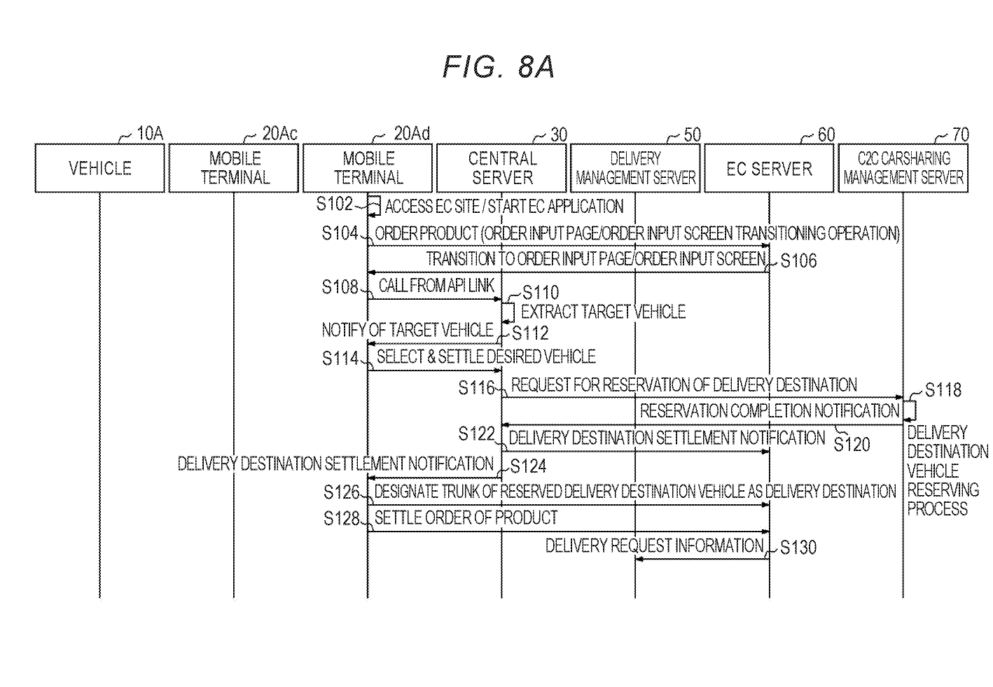

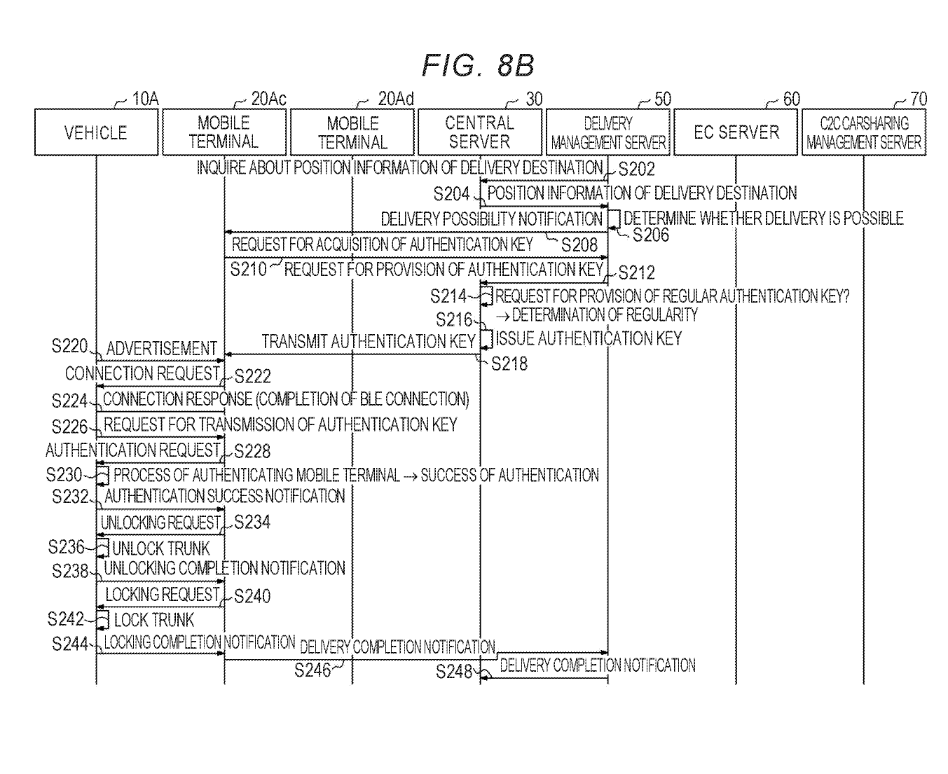

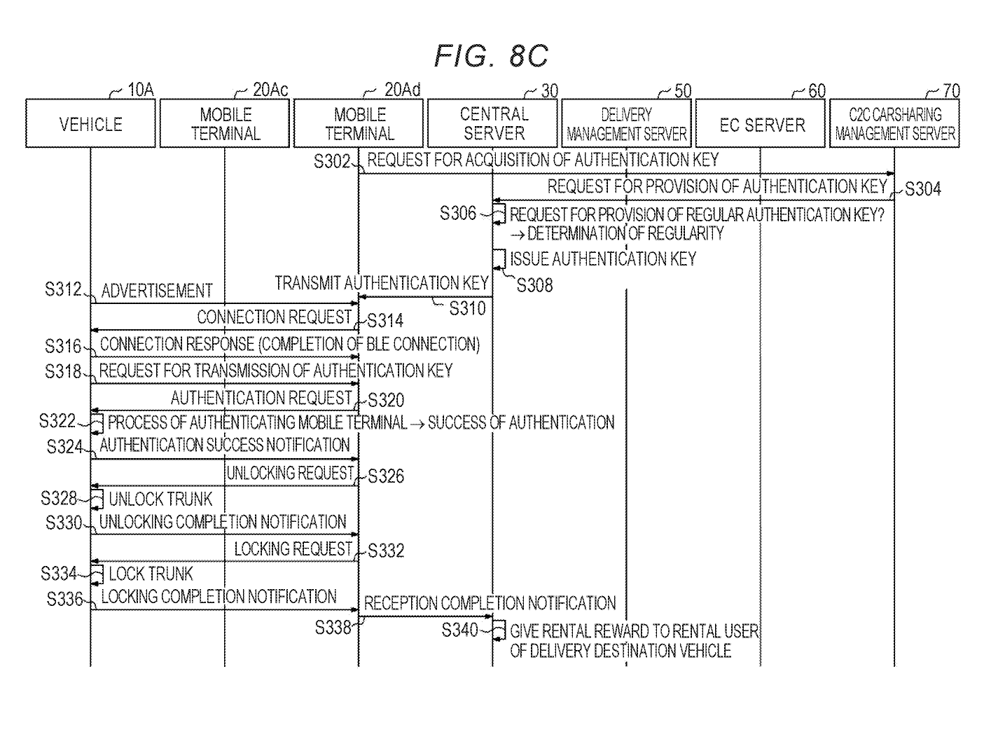

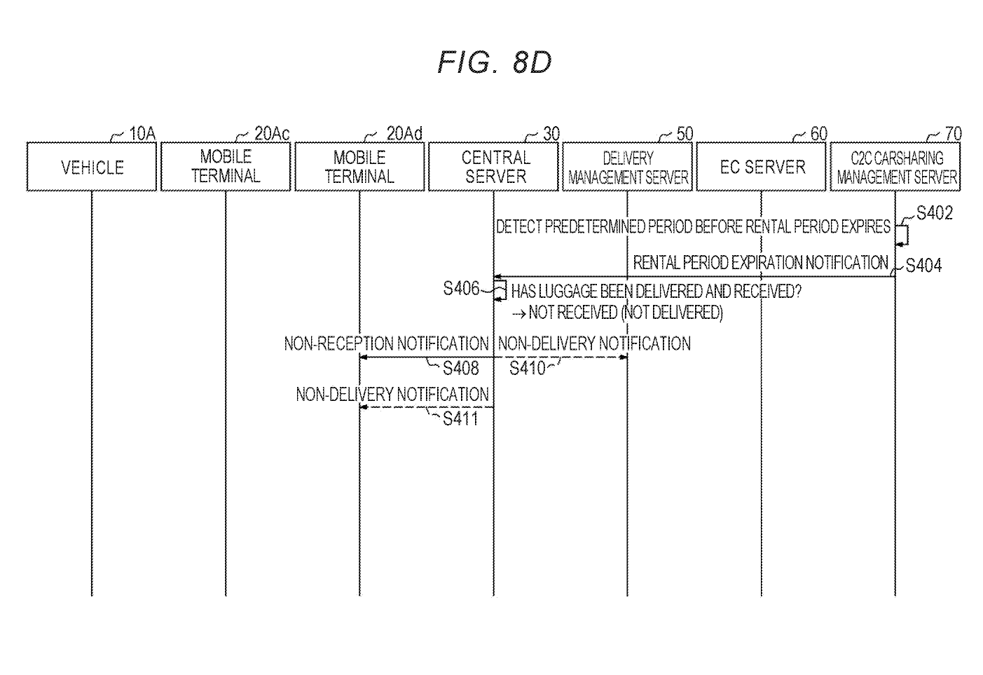

Details of the operation of the authentication key management system 1 associated with the renter-user trunk delivery service will be described below with reference to FIG. 8.

FIGS. 8A to 8D are sequence diagrams illustrating an example of the operation of the authentication key management system 1 associated with the renter-user trunk delivery service. Specifically, FIG. 8A is a sequence diagram illustrating an example of the operation of the authentication key management system 1 associated with a flow from ordering of a product by a renter user in an EC site or the like to completion of a delivery request in which a trunk of a vehicle 10A which is rented in the trunk sharing rental type is designated as a delivery destination. FIG. 8B is a sequence diagram illustrating an example of the operation of the authentication key management system 1 associated with a flow of delivery of luggage to the trunk of the vehicle 10A which is rented in the trunk sharing rental type. FIG. 8C is a sequence diagram illustrating an example of the operation of the authentication key management system 1 associated with a flow of receiving luggage delivered to the trunk of the vehicle 10A by a renter user of the vehicle 10A which is rented in the trunk sharing rental type. FIG. 8D is a sequence diagram illustrating an example of the operation of the authentication key management system 1 associated with a flow of operations when a rental period of the vehicle 10A which is rented in the trunk sharing rental type expires.

In this example, it is assumed that a renter user orders a product in an EC site using a mobile terminal 20Ad.

<Flow from Ordering of Product to Completion of Delivery Request>

In Step S102, the mobile terminal 20Ad accesses an EC site through a predetermined browser or starts an EC application interlinking with the EC site in response to a predetermined operation by the renter user.

In Step S104, the mobile terminal 20Ad receives an operation of transitioning to an order input page or an order input screen for ordering a product selected by the renter user (for example, put into a virtual cart in the EC site) and transmits a notification thereof to the EC server 60.

In Step S106, the web resource transmitting unit 622 of the EC server 60 causes a page of a browser of the mobile terminal 20Ad to transition to the order input page or causes a screen of the EC application to transition to the order input screen in response to an operation on the mobile terminal 20Ad.

In Step S108, the mobile terminal 20Ad calls the function of the central server 30 from an API link which is embedded in advance in input parts of a variety of information associated with a delivery request in the order input page or the order input screen to correspond to display of the input parts.

In Step S110, the target vehicle extracting unit 3208 of the central server 30 extracts target vehicles from a plurality of candidate vehicles in response to the call based on the API link of the mobile terminal 20Ad.

In Step S112, the target vehicle notifying unit 3209 of the central server 30 notifies of the extracted target vehicles via the API link embedded in the order input page or the order input screen displayed on the display 24 of the mobile terminal 20Ad.

In Step S114, the mobile terminal 20Ad selects a vehicle 10A which the renter user wants to rent from the target vehicles in response to the renter user's operation. Then, the mobile terminal 20Ad inputs information on a reserved date and time or the like in response to the renter user's operation, settles the selected vehicle 10A and transmits the selected and settled vehicle 10A to the central server 30.

In Step S116, the delivery destination vehicle reserving unit 3210 of the central server 30 transmits a reservation request of the vehicle 10A (a delivery destination vehicle) selected and settled by the renter user to the C2C carsharing management server 70 via the communication processing unit 3201.

In Step S118, the reservation managing unit 723 of the C2C carsharing management server 70 reserves the delivery destination vehicle (the vehicle 10A) which is specified in the reservation request in response to the reservation request received from the central server 30.

In Step S120, the reservation managing unit 723 of the C2C carsharing management server 70 transmits a reservation completion notification to the central server 30 via the communication processing unit 721.

In Step S122, the delivery destination settlement notifying unit 3211 of the central server 30 transmits a delivery destination settlement notification to the EC server 60 via the communication processing unit 3201 in response to reception of the reservation completion notification from the C2C carsharing management server 70. Accordingly, the EC server 60 can settle the trunk of the vehicle 10A specified in the delivery destination settlement notification as a designative delivery destination.

In Step S124, the delivery destination settlement notifying unit 3211 of the central server 30 transmits a delivery destination settlement notification to the mobile terminal 20Ad of the renter user via the communication processing unit 3201 in response to reception of the reservation completion notification from the C2C carsharing management server 70. Accordingly, the mobile terminal 20Ad can display a notification indicating that the delivery destination has been settled in the EC site or the like displayed on the display 24 and show the renter user that the trunk of the vehicle 10A (the delivery destination vehicle) is settled as a designative delivery destination.

In Step S126, the mobile terminal 20Ad designates the trunk of the reserved delivery destination vehicle as a delivery destination of luggage (a product) in the EC site or the like in response to the renter user's operation.

In Step S128, the mobile terminal 20Ad settles the order of a product in the EC site or the like in response to the renter user's operation.

In Step S130, the EC server 60 transmits delivery request information for the product in response to settlement of the order of the product in the EC site or the like. Accordingly, the delivery management server 50 can receive a delivery request in which the trunk of the vehicle 10A rented to the renter user is designated as a delivery destination.

<Flow of Delivery of Luggage to Vehicle 10A Rented in Trunk Sharing Rental Type>

In Step S202, the delivery managing unit 524 of the delivery management server 50 inquires of the renter user of the delivery destination vehicle about position information of the vehicle 10A rented in the trunk sharing rental type via the communication processing unit 521.

In Step S204, the position information managing unit 3204 of the central server 30 acquires position information of the delivery destination vehicle via the communication processing unit 3201 in response to an inquiry about the position information of the delivery destination vehicle received from the delivery management server 50 via the communication processing unit 3201 and returns a response to the delivery management server 50.

In Step S206, the delivery managing unit 524 of the delivery management server 50 determines whether delivery is possible based on the position information of the delivery destination vehicle received from the central server 30 via the communication processing unit 521.

In Step S208, when it is determined that delivery is possible, the delivery managing unit 524 of the delivery management server 50 transmits a delivery possibility notification to a mobile terminal 20Ac of a deliverer via the communication processing unit 521. Accordingly, the deliverer can see details of the delivery possibility notification displayed on the display 24 of the mobile terminal 20Ac in the form of push notification and ascertain that target luggage can be delivered in response to reception of the delivery possibility notification.

In Step S210, the mobile terminal 20Ac transmits a request for acquisition of an authentication key to the delivery management server 50 in response to a predetermined operation which is performed by the deliverer who has ascertained that delivery is possible.

The deliverer may perform an operation for transmitting the request for acquisition of an authentication key from the mobile terminal 20A to the delivery management server 50 at an arbitrary time after it has been ascertained that delivery is possible (for example, at a time immediately after the ascertainment, a time at which delivery of target luggage is going to be carried out, or a time immediately before the deliverer arrives at the vehicle 10A).

In Step S212, when a normal request for acquisition of an authentication key has been received from the mobile terminal 20Ac of the deliverer by the communication processing unit 521, the delivery managing unit 524 of the delivery management server 50 transmits a request for provision of an authentication key to the central server 30.

In Step S214, when the request for provision of an authentication key has been received from the delivery management server 50 by the communication processing unit 3201, the condition determining unit 3202 of the central server 30 determines whether the received request is a normal request for provision of an authentication key.

In Step S216, when the condition determining unit 3202 determines that the received request is a normal request for provision of an authentication key, the authentication key issuing unit 3203 of the central server 30 issues an authentication key corresponding to the request for provision of an authentication key.

In Step S218, the authentication key issuing unit 3203 of the central server 30 transmits the issued authentication key to the mobile terminal 20Ad of the deliverer via the communication processing unit 3201.

In Step S220, the key unit 12 of the delivery destination vehicle (the vehicle 10A) periodically emits an advertising packet to the surroundings of the vehicle 10A.

In Step S222, when the deliverer enters a communication area for BLE communication of the key unit 12 of the delivery destination vehicle (the vehicle 10A), the communication processing unit 2301 of the mobile terminal 20Ac receives the advertising packet. Then, the communication processing unit 2301 of the mobile terminal 20Ac transmits a connection request to the key unit 12 of the vehicle 10A by BLE communication in response to reception of the advertising packet.

In Step S224, the key unit 12 of the vehicle 10A sets up BLE connection in response to the connection request and transmits a connection response indicating that a communicable state by BLE communication has been set up to the mobile terminal 20Ac.

In Step S226, the key unit 12 of the vehicle 10A transmits a request for acquisition of an authentication key to the mobile terminal 20Ac when the communicable state by BLE communication with the mobile terminal 20Ac has been set up.

In Step S228, when the request for transmission of an authentication key has been received from the key unit 12 of the vehicle 10A via the communication processing unit 2301, the authentication requesting unit 2304 of the mobile terminal 20Ac transmits an authentication request including an authentication key.

In Step S230, when the authentication request including the authentication key has been received from the mobile terminal 20Ac, the key unit 12 of the vehicle 10A performs a process of authenticating the mobile terminal 20Ac which is a transmission source.

In Step S232, when authentication of the mobile terminal 20Ac has succeeded, the key unit 12 of the vehicle 10A transmits an authentication success notification to the mobile terminal 20Ac.

In Step S234, the locking/unlocking requesting unit 2305 of the mobile terminal 20Ac transmits an unlocking request to the key unit 12 of the vehicle 10A in response to the deliverer's predetermined operation.

In Step S236, when the unlocking request has been received from the authentication mobile terminal 20Ac, the key unit 12 of the vehicle 10A transmits an unlocking signal to the locking/unlocking and starting device 11 to unlock a door for accessing the trunk of the vehicle 10A.

In Step S238, when a notification indicating that the door for accessing the trunk of the vehicle 10A has been unlocked from the locking/unlocking and starting device 11, the key unit 12 of the vehicle 10A transmits a notification indicating that the door for accessing the trunk of the vehicle 10A has been unlocked to the mobile terminal 20Ac.

In Step S240, the deliverer delivers (accommodates) luggage in the trunk of the vehicle 10A and then performs a predetermined operation on the mobile terminal 20Ac, and the locking/unlocking requesting unit 2305 of the mobile terminal 20Ac transmits a locking request to the key unit 12 of the vehicle 10A in response to the predetermined operation.

In Step S242, when the locking request has been received from the authenticated mobile terminal 20Ac, the key unit 12 of the vehicle 10A transmits a locking signal to the locking/unlocking and starting device 11 to lock the door for accessing the trunk of the vehicle 10A.

In Step S244, when a notification indicating that the door for accessing the trunk of the vehicle 10A has been locked has been received from the locking/unlocking and starting device 11, the key unit 12 of the vehicle 10A transmits a notification indicating that the door for accessing the trunk of the vehicle 10A has been locked to the mobile terminal 20Ac.

In Step S246, the mobile terminal 20Ac transmits a delivery completion notification to the delivery management server 50 in response to the deliverer's predetermined operation.

In Step S248, when the delivery completion notification has been received from the mobile terminal 20Ac of the deliverer by the communication processing unit 521, the delivery managing unit 524 of the delivery management server 50 transmits a delivery completion notification indicating that delivery of target luggage with the trunk of the vehicle 10A rented in the trunk sharing rental target designated as a delivery destination has been completed to the central server 30 via the communication processing unit 521.

<Flow of Allowing Renter of Vehicle 10A Rented in Trunk Sharing Rental Type to Receive Luggage>

In Step S302, the authentication key acquiring unit 2303 of a mobile terminal 20Ad of a renter transmits a request for acquisition of an authentication key to the C2C carsharing management server 70 via the communication processing unit 2302 in response to the renter's predetermined operation.

In Step S304, when a normal request for acquisition of an authentication key has been received from the mobile terminal 20Ad of the renter by the communication processing unit 721, the reservation managing unit 723 of the C2C carsharing management server 70 transmits a request for provision of an authentication key corresponding to the request for acquisition of an authentication key to the central server 30 via the communication processing unit 721.

In Step S306, when the request for provision of an authentication key has been received from the C2C carsharing management server 70 by the communication processing unit 3201, the condition determining unit 3202 of the central server 30 determines whether the received request is a normal request for provision of an authentication key.

In Step S308, when the condition determining unit 3202 determines that the received request is a normal request for provision of an authentication key, the authentication key issuing unit 3203 of the central server 30 issues an authentication key corresponding to the request for provision of an authentication key.

In Step S310, the authentication key issuing unit 3203 of the central server 30 transmits the issued authentication key to the mobile terminal 20Ad of the renter of the vehicle 10A via the communication processing unit 3201.

Steps S312 to S336 are the same as Steps S220 to S244 in FIG. 8B except that a target communicating with the vehicle 10A (the key unit 12) by BLE communication is changed from the mobile terminal 20Ac of the deliverer to the mobile terminal 20Ad of the renter of the vehicle 10A, and thus description thereof will not be repeated.

In Step S338, the mobile terminal 20Ad of the renter determines that reception of luggage by the renter has been completed in response to reception of the unlocking completion notification and the locking completion notification from the vehicle 10A (the key unit 12) and transmits a reception completion notification to the central server 30. Accordingly, the central server 30 can ascertain that reception of a delivered product has been completed.

The reception completion notification may be transmitted from the DCM 14 of the vehicle 10A to the central server 30 in response to reception of the unlocking notification and the locking notification from the locking/unlocking and starting device 11 by the key unit 12 of the vehicle 10A.

In Step S340, the reward managing unit 3213 of the central server 30 updates reward information corresponding to the identification information of a lender of the delivery destination vehicle (the vehicle 10A) and stored in the storage unit 320 to reward information having new addition of a reward.

<Flow at the Time of Expiration of Rental Period of Vehicle 10A Rented in Trunk Sharing Rental Type>

In Step S402, the reservation managing unit 723 of the C2C carsharing management server 70 detects that a predetermined time remains until the rental period of the vehicle 10A rented in the trunk sharing rental type has expired.

In Step S404, the reservation managing unit 723 of the C2C carsharing management server 70 transmits a rental period expiration notification indicating that a predetermined time remains until the rental period of the vehicle 10A has expired to the central server 30 via the communication processing unit 721.

In Step S406, the non-reception and non-delivery notifying unit 3212 of the central server 30 determines whether luggage has been delivered and reception of the luggage has been completed. Specifically, the non-reception and non-delivery notifying unit 3212 of the central server 30 determines whether a delivery completion notification has been received from the delivery management server 50 by the communication processing unit 3201 and a reception completion notification has been received from the mobile terminal 20Ad.

In Step S408, when the delivery completion notification has been received from the delivery management server 50 but the reception completion notification has not been received from the mobile terminal 20Ad of the renter of the vehicle 10A, the non-reception and non-delivery notifying unit 3212 of the central server 30 determines that delivered luggage has not been received and transmits a non-reception notification to the mobile terminal 20Ad of the renter.

On the other hand, in Step S410, when the delivery completion notification has not been received from the delivery management server 50, the non-reception and non-delivery notifying unit 3212 of the central server 30 transmits a non-delivery notification to the delivery management server 50 via the communication processing unit 3201.

In Step S412, the non-reception and non-delivery notifying unit 3212 of the central server 30 also transmits the non-delivery notification to the mobile terminal 20Ad via the communication processing unit 3201. Accordingly, the renter of the vehicle 10A can understand that luggage has not been yet delivered to the trunk of the vehicle 10A.

[Operation]

In this embodiment, when a user of a delivery service (a renter-user interior delivery service) in which an interior space including a trunk of a vehicle 10 which is rented as an accommodation place of an object can be designated as a delivery destination of luggage requests a delivery company, which provides the renter-user interior delivery service, delivery of luggage, the target vehicle extracting unit 3208 extracts vehicles 10 (target vehicles) which are available as a delivery destination of luggage corresponding to the delivery request from a plurality of vehicles 10 (candidate vehicles). Then, the target vehicle notifying unit 3209 notifies the user of the vehicles 10 (target vehicles) extracted by the target vehicle extracting unit 3208.

Accordingly, when a user requests delivery of luggage, the central server 30, the delivery management server 50, the EC server 60, or the C2C carsharing management server 70 (hereinafter referred to as the “central server 30 or the like” for the purpose of convenience) can notify the user of the vehicles 10 which are rented in the trunk sharing rental type and which can be used as a delivery destination of luggage corresponding to a delivery request, for example, by push-transmitting information thereof to a mobile terminal 20Ad carried by the user. Accordingly, by performing a reservation procedure for renting a vehicle as an accommodation place of an object via a C2C carsharing site or the like, the user can rent a vehicle 10 which is rented in the trunk sharing rental type and which can be used as a delivery destination of luggage and designate the interior space of the rented vehicle 10 as a delivery destination of luggage. Accordingly, the central server 30 or the like can allow a user, who may not be able to use a vehicle owned by the user, a near relative, or the like, to use the interior delivery service.

In this embodiment, when a user requests a delivery company to deliver luggage, the target vehicle extracting unit 3208 extracts vehicles 10 (target vehicles) of which a parking place at the time of rental as an accommodation place of an object is within a predetermined range from the current position of the user or a designated position designated by the user from a plurality of vehicles 10 (candidate vehicles).

Accordingly, the central server 30 or the like can notify the user of only the vehicles 10 of which a parking place at the time of rental as an accommodation place of an object is within a predetermined range from the position of the user or the designated position as target vehicles. Accordingly, the user can easily detect the vehicles 10 rented in the trunk sharing rental type around the current position of the user or a designated position such as home or a work place, that is, the vehicles 10 which are rented in the trunk sharing rental type and which the user actual wants to use. The vehicles 10 which are rented in the trunk sharing rental type and which are disclosed to the user are limited to a predetermined range. Accordingly, when a vehicle 10 is owned by an individual person, it is possible to prevent information on the vehicle 10 which is rented in the trunk sharing rental type from being unnecessarily disclosed to users and thus to consider the privacy of the owner of the vehicle 10 or the like. Accordingly, the central server 30 or the like can notify a user of vehicles 10 which are rented in the trunk sharing rental type and which are available as a delivery destination of luggage in consideration of convenience for the user and the privacy of an owner of a vehicle 10 which is rented in the trunk sharing rental type.

In this embodiment, when a user requests a delivery company to deliver luggage, the target vehicle extracting unit 3208 extracts vehicles 10 (target vehicles) of which a designated delivery date and time designated in a delivery request is included in a period in which the vehicles are rentable as an accommodation place of an object from a plurality of vehicles 10 (candidate vehicles).

Accordingly, the central server 30 or the like can notify users of only the vehicles 10 of which the designated delivery date and time designated by the user is included in the rentable period, that is, vehicles 10 which are rented in the trunk sharing rental type and which are available as a delivery destination of luggage. Accordingly, the user can easily detect the vehicles 10 which are rented in the trunk sharing rental type and which are available at the designated delivery date and time. The vehicles 10 which are rented in the trunk sharing rental type and which are disclosed to the user are limited to vehicles which are available at the designated delivery date and time. Accordingly, when a vehicle 10 is owned by an individual person, it is possible to prevent information on the vehicle 10 which is rented in the trunk sharing rental type from being unnecessarily disclosed to users and thus to consider the privacy of the owner of the vehicle 10 or the like which is rented in the trunk sharing rental type. Accordingly, the central server 30 or the like can notify a user of vehicles 10 which are rented in the trunk sharing rental type and which are available as a delivery destination of luggage in consideration of convenience for the user and the privacy of an owner of a vehicle 10 which is rented in the trunk sharing rental type.

In this embodiment, when delivery of luggage has been requested using a terminal carried by a user (for example, a mobile terminal 20Ad), the target vehicle notifying unit 3209 displays the vehicles 10 (the target vehicles) extracted by the target vehicle extracting unit 3208 on a display device (the display 24) of the terminal.

The central server 30 or the like can notify the user of the vehicles 10 which are rented in the trunk sharing rental type and which are available as a delivery destination of luggage such that the vehicles 10 are displayed on the display device of the terminal which is used for the user to request delivery of luggage (for example, on the front display 24 of the mobile terminal 20Ad), for example, using a predetermined API or the like.

In this embodiment, when a user requests delivery of luggage using a web site corresponding to a delivery service or an application program installed in a terminal used by the user and interlocking with the web site through the terminal used by the user (for example, the mobile terminal 20Ad), the target vehicle notifying unit 3209 displays the vehicles 10 (target vehicles) extracted by the target vehicle extracting unit 3208 on a predetermined web page of a web site or a window corresponding to an application program, which is displayed on the display device of the used terminal (the display 24).

Accordingly, for example, when the user accesses the web site corresponding to the interior delivery service using a predetermined browser of the terminal and requests delivery of luggage, the central server 30 or the like can display the vehicles 10 which are rented in the trunk sharing rental type and which are available as a delivery destination of luggage on a predetermined web page of the web site. For example, when the user starts an application cooperating with the web site installed in the terminal and requests delivery of luggage, the central server 30 or the like can display the vehicles 10 which are rented in the trunk sharing rental type and which are available as a delivery destination of luggage on a predetermined window of the application (which includes a screen of an application displayed on a display of a mobile terminal such as a smartphone).

In this embodiment, the target vehicle notifying unit 3209 displays a map image on the display device of the used terminal (for example, the display 24 of the mobile terminal 20Ad) and displays the vehicles 10 (target vehicles) extracted by the target vehicle extracting unit 3208 on the map image to correspond to the parking place at the time of rental as an accommodation place of an object to overlap the map image.

Accordingly, the central server 30 or the like can display the vehicles 10 which are rented in the trunk sharing rental type and which are available as a delivery destination of luggage such that the vehicles 10 which are rented in the trunk sharing rental type are arranged at positions corresponding to the parking places at the time of rental on the map image. Accordingly, the user can easily understand geometrical positions of the vehicles 10 which are rented in the trunk sharing rental type and which are available as a delivery destination of luggage. Accordingly, the central server 30 or the like can improve convenience for a user when detecting the vehicles 10 which are rented in the trunk sharing rental type and which are available as a delivery destination of luggage.

In this embodiment, the delivery destination vehicle reserving unit 3210 receives a reservation of a vehicle 10 which is selected by a predetermined operation on a terminal used by a user (for example, a mobile terminal 20Ad) from the vehicles 10 (target vehicles) extracted by the target vehicle extracting unit 3208 as an accommodation place of an object or requests a predetermined external device (the C2C carsharing management server 70 or the B2C carsharing management server 80) to make a reservation.

Accordingly, the central server 30 or the like can cause a user to select a vehicle 10 which is used as a delivery destination of luggage from vehicles 10 which are rented in the trunk sharing rental type and which are available as a delivery destination of luggage, which are displayed on a terminal used by the user for a delivery request, and to reserve the selected vehicle 10. Accordingly, the user can also reserve the vehicle 10 which is rented in the trunk sharing rental type at the time of delivery request of luggage. Accordingly, the central server 30 or the like can improve convenience for a user when delivery of luggage is requested with an interior space of a vehicle 10 which is rented in the trunk sharing rental type designated as a delivery destination of luggage.

In this embodiment, the authentication key issuing unit 3203 transmits an authentication key which is used to unlock a door for accessing the interior space of the vehicle 10A rented to a user to both the user (specifically the mobile terminal 20Ad) and a delivery company providing the delivery service (specifically, the mobile terminal 20Ac of a deliverer).

Accordingly, the central server 30 or the like can transmit the authentication key for unlocking the door for accessing the interior space of the vehicle 10 which is rented to the user in the trunk sharing rental type to the delivery company and cause a deliverer to deliver luggage to the vehicle 10 which is rented in the trunk sharing rental type. The central server 30 or the like can transmit the authentication key for unlocking the door for accessing the interior space of the vehicle 10 which is rented to the user in the trunk sharing rental type to the mobile terminal 20Ad of the user and cause the user to receive luggage which is delivered to the vehicle 10 which is rented in the trunk sharing rental type. Accordingly, the central server 30 or the like can construct a system for the interior delivery service in which luggage can be delivered to the interior space of the vehicle 10 which is rented in the trunk sharing rental type and a renter of the vehicle 10 which is rented in the trunk sharing rental type receives the luggage.

In this embodiment, an authentication key is directly transmitted from the central server 30 to a mobile terminal 20Ac of a deliverer, but the authentication key may be transmitted from the central server 30 to the delivery management server 50 and then transmitted from the delivery management server 50 to the mobile terminal 20Ac.

In this embodiment, when delivery of luggage to a vehicle 10 rented to a user has been completed and when a period in which the vehicle 10 is rented as an accommodation place of an object has expired or a predetermined time remains until the rental period has expired but luggage has not been received from the vehicle 10 by the user, the non-reception and non-delivery notifying unit 3212 notifies the user that reception of luggage from the vehicle 10 has not been completed.

Accordingly, the central server 30 or the like can prompt a user to receive luggage when a rental period of a vehicle 10 which is rented in the trunk sharing rental type has expired or expiration of the rental period is impending but luggage delivered to the vehicle 10 has not been received. Accordingly, the central server 30 or the like can prevent a user from forgetting to receive luggage when an available period of the vehicle 10 which is rented in the trunk sharing rental type as a delivery destination of luggage.

In this embodiment, reward information corresponding to a predetermined reward which is given to providers of a plurality of vehicles 10 (candidate vehicles) which are rented in the trunk sharing rental type is stored in the storage unit 3200. When a vehicle 10 is rented as a delivery destination of luggage of a user, the reward managing unit 3213 updates the reward information corresponding to a provider (a lender) of the rented vehicle 10 to details including new addition of a reward.

Accordingly, by giving a reward, that is, an incentive, to a provider (a person or a corporation) of a vehicle 10 which is rented in the trunk sharing rental type, the central server 30 or the like can promote a vehicle 10 owned by an individual person or a corporation to be rented in the trunk sharing rental type. Accordingly, the number of vehicles 10 which are rented in the trunk sharing rental type and which are available as a delivery destination of luggage can increase and a user can easily use the interior delivery service. Accordingly, the central server 30 or the like can allow a user who may not be able to use a vehicle owned by the user, a near relative, or the like to more conveniently use the interior delivery service.

In the above-mentioned embodiment, a vehicle 10 (a vehicle 10A or 10B) is temporarily rented to a user as an accommodation place of an object by a predetermined vehicle rental service (for example, a C2C carsharing service, a B2C carsharing service, or a rental car service).

Accordingly, the central server 30 or the like can specifically cooperate with a vehicle rental service such as a carsharing service or a car rental service and realize an interior delivery service in which an interior space of a rented vehicle 10 can be designated as an accommodation place of an object using such a service.

In this embodiment, the reservation managing unit 723 or reservation managing unit 822 receives a reservation of a vehicle 10 which is temporarily rented as an accommodation place of an object. Then, based on details of the received reservation, the reservation managing unit 723 or reservation managing unit 822 transmits an authentication key which is used to unlock a door for accessing an interior space of the vehicle 10 to a mobile terminal 20Ad of a user or causes a predetermined external device (the central server 30) to transmit the authentication key.

Accordingly, the C2C carsharing management server 70 or the B2C carsharing management server 80 can receive a reservation of a vehicle 10 which is rented in the trunk sharing rental type, for example, which is received from a terminal of a user or input from a terminal of a business office of a carsharing provider or the like, and allow the user (specifically, a mobile terminal 20Ad carried by the user) to acquire an authentication key for unlocking a door for accessing an interior space of the reserved vehicle 10 which is rented in the trunk sharing rental type. That is, the C2C carsharing management server 70 or the B2C carsharing management server 80 can construct a system for temporarily renting a vehicle 10 as an accommodation place of an object. Accordingly, a user can have luggage delivered to an interior space of a vehicle 10 which is rented in the trunk sharing rental type using the interior delivery service by designating the interior space of the vehicle 10 which is rented in the trunk sharing rental type as a delivery destination, designating a designated delivery date and time which is included in a rental period, and the like. Accordingly, the C2C carsharing management server 70 or the B2C carsharing management server 80 can allow a user who may not be able to use a vehicle owned by the user, a near relative, or the like to use the interior delivery service.

While an embodiment of the disclosure has been described above in detail, the disclosure is not limited to such a specific embodiment and can be modified and changed in various forms within the scope of the gist of the disclosure described in the appended claims.

For example, in the above-mentioned embodiment, the mobile terminal 20 transmits an authentication request including an authentication key to the key unit 12, the key unit 12 exchanges a signal with the locking/unlocking and starting device 11 based on an authentication result using the authentication key, and locking/unlocking of the door of the vehicle 10A and starting of the vehicle 10A are implemented by the locking/unlocking and starting device 11, but the disclosure is not limited to the embodiment.

Specifically, a configuration in which locking/unlocking of the door of the vehicle 10A and starting of the vehicle 10A by the locking/unlocking and starting device 11 are implemented by transferring the function of the key unit 12 to the mobile terminal 20 and causing the mobile terminal 20 to exchange a signal based on the key information (internal key information) with the vehicle 10 (the locking/unlocking and starting device 11) using LF radio waves and RF radio waves may be employed. In this case, the “authentication key in the above-mentioned embodiment can be replaced with “key information.” That is, the central server 30 may issue key information instead of the authentication key using the same method as the authentication key in the above-mentioned embodiment and transmit the issued key information to the mobile terminal 20. Accordingly, the same operations and advantages as in the above-mentioned embodiment can be achieved.

The function of the key unit 12 may be incorporated into the locking/unlocking and starting device 11, and the configurations for communication between the locking/unlocking and starting device 11 and the key unit 12 and authentication associated with the corresponding communication (the LF radio wave transmitter 111, an RF radio wave receiver 112, the comparison ECU 113, the LF radio wave receiver 121, and the RF radio wave transmitter 122) may be omitted. In this case, when authentication of a mobile terminal 20 based on an authentication key has succeeded, instead of the comparison ECU 113, the key ECU 124 may directly output an unlocking command or a locking command and a starting command to the body ECU 114 and the engine ECU 116 and perform locking/unlocking of a door of a vehicle 10 and starting of the vehicle 10. Accordingly, the same operations and advantages as in the above-mentioned embodiment can be achieved.

What is claimed is:

1. An information processing device comprising:
a target vehicle extracting unit configured to extract an available vehicle which is available as a delivery destination of luggage from a plurality of vehicles, the vehicles being rented as an accommodation place of an object, when a user of a delivery service in which an interior space including a trunk of the vehicles is able to be designated as the delivery destination of the luggage issues a delivery request of the luggage to a provider of the delivery service; and
a target vehicle notifying unit configured to notify the user of the available vehicle.

2. The information processing device according to claim 1, wherein the target vehicle extracting unit is configured to extract, from the vehicles, the available vehicle of which a parking place when the available vehicle is rented as the accommodation place of the object is within a predetermined range from a current position of the user or a designated position designated by the user, when the user issues the delivery request of the luggage to the provider.

3. The information processing device according to claim 1, wherein the target vehicle extracting unit is configured to extract the available vehicle from the vehicles when the user issues the delivery request of the luggage to the provider, the available vehicle being a vehicle for which a designated delivery date and time, the designated date and time being designated by the delivery request, is included in a period in which the available vehicle is able to be rented as the accommodation place of the object.

4. The information processing device according to claim 1, wherein the target vehicle notifying unit is configured to display, when the delivery request of the luggage is transmitted through a terminal carried by the user, the available vehicle, on a display device of the terminal.

5. The information processing device according to claim 4, wherein the target vehicle notifying unit is configured to display the available vehicle on a predetermined web page of a web site corresponding to the delivery service or a window corresponding to an application program installed in the terminal to cooperate with the web site, when the user issues the delivery request of the luggage from the terminal by using the web site or the application program.

6. The information processing device according to claim 4, wherein the target vehicle notifying unit is configured to
display a map image on the display device, and
display a vehicle image corresponding to the available vehicle at a position on the map image, the position corresponding to a parking place when the available vehicle is rented as the accommodation place of the object, such that the vehicle image overlaps the map image at the position.

7. The information processing device according to claim 4, further comprising a vehicle reserving unit configured to
receive a reservation for the available vehicle, when the available vehicle is selected by a predetermined operation of the user in the terminal, as the accommodation place of the object, or
make a request for the reservation to a predetermined external device.

8. The information processing device according to claim 1, further comprising a key information transmitting unit configured to transmit key information, the key information being used to unlock a door for accessing the interior space of the available vehicle rented to the user, to both the user and the provider of the delivery service.

9. The information processing device according to claim 1, further comprising a non-reception notifying unit configured to notify, when delivery of the luggage to the interior space of the available vehicle rented to the user has been completed, the user that reception of the luggage from the available vehicle has not been completed, when (i) a rental period in which the available vehicle is rented as the accommodation place of the object has expired or a time to expiration of the rental period is shorter than a predetermined time and (ii) the user has not received the luggage from the available vehicle.

10. The information processing device according to claim 1, further comprising:
a storage unit configured to store reward information corresponding to a predetermined reward, the predetermined reward being given to providers of the vehicles; and
a reward giving unit configured to update the reward information corresponding to a provider of a rented vehicle to information including addition of a new reward when the rented vehicle included in the vehicles is rented as the delivery destination of the luggage.

11. The information processing device according to claim 1, wherein the vehicles are temporarily rented as the accommodation place of the object to the user through a predetermined vehicle rental service.

12. An information processing method which is performed by an information processing device, the information processing method comprising:
extracting available vehicle which is available as a delivery destination of luggage from a plurality of vehicles, the vehicles being temporarily rented as an accommodation place of an object, when a user of a delivery service in which an interior space including a trunk of the vehicles is able to be designated as the delivery destination of the luggage issues a delivery request of the luggage to a provider of the delivery service; and
notifying the user of the available vehicle.

13. A non-transitory storage medium storing an information processing program, the information processing program causing an information processing device to execute the information processing method according to claim 12.
